(19) United States
(12) Patent Application Publication
(10) Pub. No.: US 2009/0260531 A1
(43) Pub. Date: Oct. 22, 2009

(54) ALUMINUM ALLOY PLATE FOR LITHOGRAPHIC PRINTING PLATE, LITHOGRAPHIC PRINTING PLATE SUPPORT, PRESENSITIZED PLATE, METHOD OF MANUFACTURING ALUMINUM ALLOY PLATE FOR LITHOGRAPHIC PRINTING PLATE AND METHOD OF MANUFACTURING LITHOGRAPHIC PRINTING PLATE SUPPORT

(75) Inventors: Shinya KUROKAWA, Haibara-gun (JP); Takanori Mori, Haibara-gun (JP); Hirokazu Sawada, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/425,836

(22) Filed: Apr. 17, 2009

(30) Foreign Application Priority Data
Apr. 18, 2008 (JP) 2008-108720
Sep. 2, 2008 (JP) 2008-224638

(51) Int. Cl. B41N 1/08; C22C 21/06; C22F 1/04; C25D 5/44; C25D 7/00; C22C 21/00

(52) U.S. Cl. 101/459; 420/532; 148/549; 148/551; 205/205; 205/50

(57) ABSTRACT

An aluminum alloy plate for a lithographic printing plate capable of obtaining a lithographic printing plate having an excellent resistance to spotting, a method of manufacturing such aluminum alloy plate, a lithographic printing plate support obtained by using such aluminum alloy plate, and a presensitized plate and in particular an on-machine developable presensitized plate are provided. The aluminum alloy plate contains 0.08 to 0.45 wt % of iron and to 0.20 wt % of silicon, with the balance being inadvertent impurities and aluminum, and the content of aluminum-iron intermetallic compounds is not more than 0.05 wt %.

### TECHNICAL FIELD OF THE INVENTION

The present invention relates to an aluminum alloy plate for a lithographic printing plate, a lithographic printing plate support, a presensitized plate, a method of manufacturing the aluminum alloy plate for a lithographic printing plate and a method of manufacturing the lithographic printing plate support.

A large number of researches have been made for the computer-to-plate (CTP) system on which significant progress has been made recently. Among others, in order to solve the problem of wastewater treatment while achieving further step rationalization, researches have been made on a presensitized plate that can be directly mounted on a printing press without any development process after light exposure and be used in printing, and various methods have been proposed therefor.

One of the methods for eliminating a treatment step is a method called “on-machine development” in which an exposed presensitized plate is mounted on a plate cylinder of a printing press and fountain solution and ink are supplied as the plate cylinder is rotated to thereby remove non-image areas of the presensitized plate. In other words, this is a system in which the presensitized plate following exposure is mounted on the printing press without any further treatment so that development completes in the usual printing process. The presensitized plate suitable for use in such on-machine development is required to have an image recording layer which is soluble in fountain solution or an ink solvent and to have a light-room handling property capable of development on a printing press placed in a light room.

For instance, JP 2938397 B describes a presensitized plate having a hydrophilic support provided thereon a photosensitive layer containing fine particles of a thermoplastic hydrophobic polymer dispersed in a hydrophilic binder polymer. JP 2938397 B describes that the plate can be mounted on a plate cylinder of a printing press to remove unexposed areas using fountain solution and/or ink (on-machine development can be made) after an image has been formed by exposing the presensitized plate with a laser beam to coalesce together the thermoplastic hydrophobic polymer particles in the image recording layer by heat. The presensitized plate is photosensitive to the infrared region and therefore also has a light-room handling property.

JP 2001-293971 A describes that a presensitized plate having an image recording layer which contains a thermoplastic particulate polymer and at least one of a particulate polymer having a heat-reactive group and a microcapsule containing a compound having a heat-reactive group has a good on-machine developability, a high sensitivity and a long press life.

However, in cases where the presensitized plates described in JP 2938397 B and JP 2001-293971 A were stored for a long period of time, ink was prone to adhere to part of the non-image area surface, causing dot- or ring-shaped stains on printed paper. This defect is also hereinafter referred to as “spotting”.

### SUMMARY OF THE INVENTION

The inventors of the invention have made an intensive study on why such spotting occurred and focused attention on the fact that the image recording layer provided in the so-called on-machine development type presensitized plates described in JP 2938397 B and JP 2001-293971 A can be removed by printing ink and/or fountain solution and therefore contains a large amount of hydrophilic components, as a result of which the image recording layer is likely to be receptive to moisture under the influence of ambient air. It has been revealed that, in the so-called on-machine development type presensitized plates described in JP 2938397 B and JP 2001-293971 A, the image recording layer contains moisture under the influence of ambient air and also hydrophilic components anionized by the moisture (hereinafter referred to simply as “anions”) to cause corrosion and therefore spotting on an aluminum alloy plate.

The inventors also revealed that, of those anions, presence of anions comprising halide ions and/or PF₆⁻ is prone to cause corrosion of the aluminum alloy plate.

On the other hand, in connection with the intermetallic compounds of the aluminum alloy plate, for example, JP 2005-330588 A, JP 2005-232596 A, and JP 11-151870 A each describe intermetallic compounds contained in an aluminum alloy plate for a lithographic printing plate.

More specifically, it is described that aluminum-iron intermetallic compounds more easily become starting points of pits during electrolytic graining than aluminum-iron-silicon intermetallic compounds and that, of those aluminum-iron intermetallic compounds, aluminum-iron metastable phase intermetallic compounds more easily become starting points of pits. JP 2005-330588 A describes that uniform graining is achieved at a ratio between the number of metastable phase particles having a content ratio of iron to aluminum of 0.6 or less and the total number of intermetallic compound particles of at least 0.35. In addition, JP 2005-232596 A describes an aluminum alloy plate containing on average 0.5 to 2.0% of aluminum-iron crystals. JP 11-151870 A describes that the ratio of the number of aluminum-iron intermetallic compound particles to the number of aluminum-iron-silicon intermetallic compound particles is at least 0.7.

However, these patent documents do not mention any intermetallic compounds for suppressing the corrosion of the aluminum substrate due to the image recording layer.

In connection with the method of manufacturing a lithographic printing plate support, commonly assigned JP 7-81260 A proposes a lithographic printing plate support manufacturing method which involves melting an aluminum material containing at least 99.7% of aluminum to prepare an ingot, scalping the ingot, subjecting the scalped ingot to cold rolling to reduce the thickness to 0.5 to 0.1 mm, correcting the rolled plate to obtain an aluminum support, and graining the aluminum support.

In addition, commonly assigned JP 8-209313 A proposes a method of manufacturing an aluminum alloy support for a lithographic printing plate characterized in that an aluminum alloy melt containing 0.05 to 1.0 wt % of iron, up to 1.0 wt % of silicon, and up to 0.2 wt % of cupper, with the balance being aluminum and inadvertent impurities is continuously cast and rolled to obtain a strip-shaped cast plate with a thickness of 25 mm or less, which is then subjected to at least one cold rolling treatment to obtain a rolled plate having a desired thickness with the final cold rolling treatment being carried out at a draft of at least 30%, and in the cold rolling process is carried out at least one annealing treatment that involves heating the rolled plate to a temperature range of 350 to 620° C. at a temperature rise rate of at least 50° C./min, maintaining it in the temperature range for not more than 10 minutes, and cooling it to a temperature range of 150° C. or less at a temperature falling rate of at least 50° C./min.

However, these patent documents do not mention application to the CTP system or an on-machine development type presensitized plate.

A first object of the invention is to provide an aluminum alloy plate for a lithographic printing plate capable of obtaining a lithographic printing plate having an excellent resistance to spotting. A second object of the invention is to provide a method of manufacturing such aluminum alloy plate. A third object of the invention is to provide a lithographic printing plate support obtained by using such aluminum alloy plate. A fourth object of the invention is to provide a presensitized plate and in particular an on-machine developable presensitized plate obtained by using such lithographic printing plate support.

The inventors of the invention have made intensive studies to achieve the above-described objects and as a result found that a lithographic printing plate having an excellent resistance to spotting can be obtained by using an aluminum alloy plate for a lithographic printing plate which contains specific amounts of silicon and iron with aluminum-iron intermetallic compounds contained in a specific amount, and by using a lithographic printing plate support obtained by subjecting an aluminum alloy melt containing specific amounts of silicon and iron to respective treatments including semicontinuous casting and cold rolling so as to satisfy specific parameters. The invention has been completed based on these findings.

Specifically, the invention provides the following (1) to (15).
(1) An aluminum alloy plate for a lithographic printing plate comprising 0.08 to 0.45 wt % of iron and 0.05 to 0.20 wt % of silicon, with the balance being inadvertent impurities and aluminum,

wherein aluminum-iron intermetallic compounds are contained in an amount of not more than 0.05 wt %.
(2) The aluminum alloy plate for a lithographic printing plate according to (1) above, wherein a main component of intermetallic compounds present in the aluminum alloy plate is α-AlFeSi.
(3) The aluminum alloy plate for a lithographic printing plate according to (1) or (2) above, wherein a ratio of iron content to silicon content (Fe/Si) in the aluminum alloy plate is from 0.5 to 2.2.
(4) The aluminum alloy plate for a lithographic printing plate according to any one of (1) to (3) above, wherein zinc is contained in an amount of not more than 0.01 wt %.
(5) The aluminum alloy plate for a lithographic printing plate according to any one of (1) to (4) above, wherein magnesium is contained in an amount of not more than 0.20 wt %.
(6) A method of manufacturing the aluminum alloy plate for a lithographic printing plate according to any one of (1) to (5) above, the method comprising:

a semicontinuous casting step for forming an ingot from an aluminum alloy melt;

a scalping step for scalping the ingot obtained in the semicontinuous casting step; and

a soaking step for carrying out a soaking treatment after the scalping step in a temperature range of 500 to 550° C.
(7) A method of manufacturing the aluminum alloy plate for a lithographic printing plate according to any one of (1) to (5) above, the method comprising:

a continuous casting step for rolling an aluminum alloy melt as it is solidified, to thereby form an aluminum alloy plate;

a cold rolling step for reducing a thickness of the aluminum alloy plate obtained in the continuous casting step;

an intermediate annealing step for heating at a temperature of not more than 500° C. following the cold rolling step; and

a finish cold rolling step for reducing a thickness of the aluminum alloy plate following the intermediate annealing step.
(8) A lithographic printing plate support obtained by subjecting a surface of the aluminum alloy plate for a lithographic printing plate according to any one of (1) to (5) above to a surface roughening treatment including an electrochemical graining treatment and an anodizing treatment in this order.
(9) The lithographic printing plate support according to (8) above, wherein the lithographic printing plate support is obtained by further subjecting the aluminum alloy plate following the anodizing treatment to a hydrophilizing treatment which is a treatment using an alkali metal silicate so that silicon is adsorbed in an amount of 1.0 to 30 mg/m².
(10) A method of manufacturing a lithographic printing plate support, the method comprising the steps of:

a semicontinuous casting step for forming an ingot from an aluminum alloy melt containing 0.08 to 0.45 wt % of iron and 0.05 to 0.20 wt % of silicon with the balance being inadvertent impurities and aluminum;

a scalping step for scalping the ingot obtained in the semicontinuous casting step;

a hot rolling step for rolling the scalped ingot to obtain a rolled plate;

a cold rolling step for reducing a thickness of the rolled plate following the hot rolling step to obtain an aluminum alloy plate; and

a surface treatment step in which a surface of the aluminum alloy plate following the cold rolling step is subjected to a surface roughening treatment including an electrochemical graining treatment and an anodizing treatment in this order to obtain the lithographic printing plate,

wherein a thickness (X) of the ingot following the semicontinuous casting step, a plate thickness (Y) following the cold rolling step, an amount (A) of material removed by the scalping step, an amount (B) of material removed by the surface roughening treatment and a thickness (C) of an anodized film satisfy the following expression (i):

$$4 ≦ Z = \frac{X - A}{Y} \times ( B + C ) \times {10}^{- 3} + A ≦ 20. \qquad ( i )$$

(11) The method according to (10) above, wherein the thickness (X) of the ingot following the semicontinuous casting step is from 300 to 800 mm, the plate thickness (Y) following the cold rolling step is from 0.1 to 0.5 mm, the amount (A) of material removed by the scalping step is from 1 to 15 mm, the amount (B) of material removed by the surface roughening treatment is from 1 to 10 μm, and the thickness (C) of the anodized film is from 0.1 to 2.5 μm.
(12) A lithographic printing plate support obtained by the method according to (10) or (11) above.
(13) A presensitized plate having an image recording layer formed on the lithographic printing plate support according to any one of (8), (9) and (12) above.
(14) The presensitized plate according to (13) above, wherein the image recording layer contains anions comprising halide ions and/or PF₆⁻.
(15) The presensitized plate according to (13) or (14) above, wherein the image recording layer is one in which an image is formed by light exposure and unexposed portions are removable with printing ink and/or fountain solution.

As will be described later, the invention can provide an aluminum alloy plate for a lithographic printing plate capable of obtaining a lithographic printing plate having an excellent resistance to spotting, a method of manufacturing such aluminum alloy plate, a lithographic printing plate support obtained by using such aluminum alloy plate, a presensitized plate and in particular an on-machine developable presensitized plate obtained by using such lithographic printing plate support.

The invention can provide a lithographic printing plate having an excellent resistance to spotting irrespective of the anion concentration (halide ion concentration, PF₆⁻ concentration) of the image recording layer and is therefore useful.

### BRIEF DESCRIPTION OF THE DRAWINGS

FIG. 1 is a schematic view showing an example of a cold rolling mill that may be used in cold rolling.

FIG. 2 is a graph showing an example of an alternating current waveform that may be used to carry out electrochemical graining treatment in a method of manufacturing a lithographic printing plate support of the invention.

FIG. 3 is a side view of a radial electrolytic cell that may be used in electrochemical graining treatment with alternating current in the method of manufacturing the lithographic printing plate support of the invention.

FIG. 4 is a side view illustrating the concept of a brush graining step that may be used to carry out mechanical graining treatment in the manufacture of the lithographic printing plate support of the invention.

FIG. 5 is a schematic view of an anodizing apparatus that may be used to carry out anodizing treatment in the manufacture of the lithographic printing plate support of the invention.

### DETAILED DESCRIPTION OF THE INVENTION

The invention is described in detail below.

### [Lithographic Printing Plate Support]

### [Aluminum Alloy Plate (Rolled Aluminum)]

The aluminum alloy plate for a lithographic printing plate of the invention to be described later (hereinafter also referred to as the “aluminum alloy plate of the invention”) is used for the lithographic printing plate support of the invention.

The aluminum alloy plate of the invention contains aluminum, iron and silicon as essential alloying ingredients.

Iron increases the mechanical strength of the aluminum alloy, exerting a large influence on the strength of the lithographic printing plate support. When the iron content is too low, the support will have too low a mechanical strength. As a result, when the lithographic printing plate is mounted onto the plate cylinder of a printing press, the edges thereof may be readily broken. Such breakage readily occurs also when a large number of impressions are made at high speed. On the other hand, when the iron content is too high, the support will have a higher strength than necessary. As a result, when mounted onto the plate cylinder of a printing press, the lithographic printing plate may not fit well on the cylinder and the edges thereof may be readily broken during printing.

In the invention, the iron content is in a range of 0.08 to 0.45 wt % and preferably 0.08 to 0.35 wt %.

If the iron content falls within the above range, the lithographic printing plate will not have a higher strength than necessary. As a result, the lithographic printing plate may fit well on the plate cylinder when mounted onto the plate cylinder of a printing press, and the edges thereof may be prevented from being broken during printing.

Iron forms aluminum-iron intermetallic compounds and aluminum-iron-silicon intermetallic compounds.

As described above, the aluminum-iron intermetallic compounds have a higher electrochemical solubility than the aluminum-iron-silicon intermetallic compounds and strongly act as the starting points for pit formation. The aluminum-iron intermetallic compounds more readily become the starting points of pits than the aluminum-iron-silicon intermetallic compounds, and the aluminum-iron intermetallic compounds more readily become the starting points of pits in the metastable phase than in the stable phase.

In the practice of the invention, the content of the aluminum-iron intermetallic compounds is preferably not more than 0.05 wt %, more preferably not more than 0.02 wt % and even more preferably not more than 0.015 wt %.

When the content of the aluminum-iron intermetallic compounds falls within the above-defined range, a lithographic printing plate obtained by using the inventive aluminum alloy plate obtained has an excellent resistance to spotting. As described above, this is based on the novel finding that the aluminum-iron intermetallic compounds form the starting points for corrosion of the aluminum alloy plate in cases where a large amount of hydrophilic components are incorporated in the image recording layer.

In the invention, the content of the aluminum-iron intermetallic compounds is calculated by the following expression:

Content of aluminum-iron intermetallic compounds (wt %)={iron content (wt %)−iron content in solid solution (wt %)}×{(sum of integral diffraction intensities in aluminum-iron intermetallic compound phase peaks as detected by XRD)/(sum of integral diffraction intensities in iron phase peaks as detected by XRD)}.

The aluminum-iron intermetallic compounds include Al₃Fe and Al₆Fe, and the iron phases include Al₃Fe, Al₆Fe and α-AlFeSi phases.

The integral diffraction intensity as measured by XRD is a value obtained by setting an aluminum alloy plate on an X-ray diffractometer RAD-rR (12 kW rotating anode type manufactured by Rigaku Corporation), carrying out measurement under the following conditions, and calculating the peak integral diffraction intensity values (unit: Kcounts) representing the iron intermetallic compound phases (Al₃Fe, A1₆Fe, α-AlFeSi) detected by the measurement. In cases where no peak appeared, the integral diffraction intensity was calculated as 0.1.
Set tube voltage: 50 kV;
Set tube current: 200 mA;
Sampling interval: 0.01°;
Scanning rate: 1°/min;
20 Scan range: 10° to 70°;
A graphite monochromator is used.

The iron content in solid solution is a value obtained by the following procedure: An aluminum alloy plate is dissolved in hot phenol, and the dissolved matrix and the intermetallic compounds as the dissolution residues are filtered off. The fine intermetallic compounds in the filtrate are further separated by extraction using a 10% citric acid solution. The iron content in the filtrate following the separation is measured by an inductively coupled plasma emission spectrometer.

Silicon is in the state of solid solution in aluminum or is present in the form of deposits of an aluminum-iron-silicon intermetallic compound or elemental silicon.

The silicon in the state of solid solution in aluminum has the effect of making the electrochemically grained surface uniform and the effect of mainly making the pits formed by electrochemical graining treatment deep and uniform.

Silicon is an element which is contained as an inadvertent impurity in the aluminum ingot serving as the starting material. A very small amount of silicon is often intentionally added to prevent variations due to starting material differences. The silicon content of less than 0.05 wt % is not practical, because the above-described effects are not achieved and a high-purity aluminum ingot which is expensive is required. A silicon content exceeding 0.20 wt % causes an inconvenience such as poor resistance to spotting when printing is carried out. On the other hand, in some cases, the starting material may already contain at least 0.03 wt % of silicon and a numeric value of less than 0.03 wt % is therefore not practical.

In the invention, the silicon content is in a range of 0.05 to 0.20 wt % and preferably 0.07 to 0.15 wt %.

When the silicon content falls within the above-defined range, the uniformity of electrochemical graining treatment to be described later is not impaired and a lithographic printing plate obtained by using the inventive aluminum alloy plate obtained has an excellent resistance to spotting.

As described above, the inventors of the invention have found that the aluminum-iron intermetallic compounds form the starting points for corrosion of the aluminum alloy plate and that the aluminum-iron-silicon intermetallic compound deposits and elemental silicon deposits less readily form the starting points for corrosion of the aluminum alloy plate than in the aluminum-iron intermetallic compounds.

Therefore, the main component of the intermetallic compounds in the aluminum alloy plate according to the invention is preferably α-AlFeSi which is an aluminum-iron-silicon intermetallic compound. The “main component” as used herein refers to one of the intermetallic compounds whose content is the largest, and its content is preferably more than 50 wt %.

Thus, in order to increase the amount of deposited aluminum-iron-silicon intermetallic compounds, as will be also described in connection with the inventive method of manufacturing the aluminum alloy plate, it is preferable to carry out soaking treatment in a temperature range of 500 to 550° C. after an ingot formed from an aluminum alloy melt has been scalped.

In the invention, the weight ratio of the iron content to the silicon content (Fe/Si) is from 0.5 to 2.2, preferably from 0.5 to 1.4 and more preferably from 1.0 to 1.4.

When the ratio of the iron content to the silicon content (Fe/Si) in the aluminum alloy plate falls within the above-defined range, the amount of the aluminum-iron-silicon intermetallic compounds increases to reduce the starting points for corrosion in the inventive aluminum alloy plate obtained, as a result of which a lithographic printing plate obtained therefrom has a more improved resistance to spotting.

Zinc has the effect of reducing the diameter of the pits formed by electrochemical graining treatment and can be therefore added to design a desired pit shape. Addition of a large amount of zinc enables the pit diameter to be reduced.

In the invention, the zinc content is preferably not more than 0.01 wt %.

Magnesium has the effect of refining the recrystallized aluminum structure and the effect of improving the tensile strength, proof stress, fatigue strength, bending strength, thermosoftening resistance and other mechanical strength.

In addition, when added in an appropriate amount, magnesium also has the effect of uniformly dispersing the pits during electrolytic graining treatment.

In the invention, the magnesium content is preferably not more than 0.20 wt %.

Copper is an element which comparatively readily enters into solid solution in aluminum and greatly influences the electrochemical graining properties on a lithographic printing plate support.

In the invention, copper may be appropriately contained in an amount of 0.001 to 0.040 wt %.

The aluminum alloy plate contains aluminum and inadvertent impurities as the balance.

Examples of the inadvertent impurities include magnesium, chromium, zinc, vanadium, and beryllium. These may be contained in amounts of not more than 0.05 wt %, respectively.

Most of the inadvertent impurities will originate from the aluminum ingot. If the inadvertent impurities are what is present in an ingot having an aluminum purity of 99.5 wt %, they will not compromise the intended effects of the invention.

The inadvertent impurities may be, for example, impurities included in the amounts mentioned in Aluminum Alloys: Structure and Properties, by L. F. Mondolfo (1976).

### [Method of Manufacturing Aluminum Alloy Plate]

The aluminum alloy plate of the invention may be manufactured, for example, by carrying out the respective treatments described below.

<Cleaning Treatment>

First, an aluminum alloy melt that has been adjusted to a given alloying ingredient content is optionally subjected to cleaning treatment by an ordinary method.

Cleaning treatment is carried out, for example, by degassing treatment for removing hydrogen and other unwanted gases from the melt (e.g., flux treatment using argon gas, chlorine gas or the like); filtering treatment using, for example, what is referred to as a rigid media filter (e.g., ceramic tube filter, ceramic foam filter), a filter that employs alumina flakes, alumina balls or the like as the filter medium, or a glass cloth filter; or a combination of degassing treatment and filtering treatment.

The aluminum alloy melt used is a melt containing the alloying ingredients described for the aluminum alloy plate of the invention, in other words, a melt containing 0.08 to 0.45 wt % of iron and 0.05 to 0.20 wt % of silicon with the balance being inadvertent impurities and aluminum.

<Casting Treatment>

Then, the aluminum alloy melt having optionally undergone cleaning treatment is used to carry out casting.

Exemplary casting processes include a casting process using a stationary mold as typified by a semicontinuous casting process and a casting process using a moving mold typified by a continuous casting process.

In the semicontinuous casting process, for example, a stationary mold may be used to prepare an ingot having a desired thickness (X).

The ingot preferably has a thickness (X) of 300 to 800 mm, more preferably 350 to 700 mm and even more preferably 400 to 650 mm.

Thereafter, the resulting ingot can be subjected to scalping according to an ordinary method.

The amount (A) in terms of thickness of the surface layer removed by scalping is preferably from 1 to 30 mm, more preferably from 1 to 15 mm, and even more preferably from 3 to 10 mm. When the amount (A) of the surface layer removed falls within the above-defined range, a nonuniform portion can be removed from the surface layer to obtain an aluminum alloy plate with a desired plate thickness.

On the other hand, in the continuous casting process, an aluminum alloy melt can be passed through a twin belt to obtain an aluminum alloy plate with a desired plate thickness.

<Heating Treatment>

In the practice of the invention, the aluminum alloy plate obtained by casting treatment is preferably heated to a hot rolling temperature so that it may be subsequently subjected to hot rolling to be described below.

<Soaking Treatment>

In cases where casting treatment is carried out by a semicontinuous casting process in the invention, it is preferable to further carry out soaking treatment for keeping the aluminum alloy plate at a predetermined temperature for a predetermined period of time between the heating treatment carried out as desired and hot rolling treatment to be described later.

In terms of preventing intermetallic compounds from coarsening and of depositing aluminum-iron-silicon intermetallic compounds, soaking treatment is preferably carried out to keep the aluminum alloy plate at a temperature ranging from 500 to 550° C., more preferably from 500 to 540° C. and even more preferably from 510 to 540° C. When the temperature in soaking treatment falls within the above-defined range, deposition of the aluminum-iron intermetallic compounds such as Al₃Fe is suppressed.

Soaking treatment is preferably carried out by keeping the aluminum alloy plate within the above-defined temperature range for 1 to 48 hours.

In cases where casting treatment is carried out by a continuous casting process, the solidification rate in casting is high to increase the deposits of the aluminum-iron-silicon intermetallic compounds, and therefore soaking is not necessary to carry out.

<Rolling Treatment>

The aluminum alloy plate following casting treatment or following soaking treatment when it is carried out as desired is optionally subjected to hot rolling or cold rolling to be described later to finally obtain a finished plate with a predetermined thickness, for example a thickness of 0.1 to 0.5 mm.

In cases where casting is carried out by a continuous casting process, continuous casting is preferably followed by cold rolling and intermediate annealing at a temperature of not more than 500° C., which will be described later. At an intermediate annealing temperature of not more than 500° C., deposition of the aluminum-iron intermetallic compounds such as Al₃Fe is suppressed.

(Hot Rolling Treatment)

Hot rolling treatment is a step in which the aluminum alloy plate following casting treatment or following soaking treatment when it is carried out as desired is rolled to obtain a rolled plate with a reduced thickness.

No particular limitation is imposed on the rolling conditions in hot rolling treatment, but the aluminum alloy plate is preferably rolled to a plate thickness of not more than 10 mm, more preferably from 2.6 to 7.0 mm and even more preferably from 3.0 to 5.0 mm by passing it through a pair of rolls. The starting temperature is preferably from 350 to 500° C.

(Annealing (Intermediate Annealing))

In the practice of the invention, intermediate annealing may be carried out before or after cold rolling, or even during cold rolling to be described later.

The intermediate annealing conditions may consist of 2 to 20 hours of heating at 280 to 600° C., and preferably 2 to 10 hours of heating at 350 to 500° C., in a batch-type annealing furnace, or of continuous heating for several tens of seconds to several minutes at 450° C. or more, in a continuous annealing furnace.

(Cold Rolling Treatment)

Cold rolling treatment is a step in which the thickness of the rolled plate following hot rolling treatment is further reduced to obtain an aluminum alloy plate.

In the practice of the invention, cold rolling treatment may be carried out by any method known in the art. More specifically, use may be made of the methods described in JP 6-220593 A, JP 6-210308 A, JP 7-54111 A, and JP 8-92709 A.

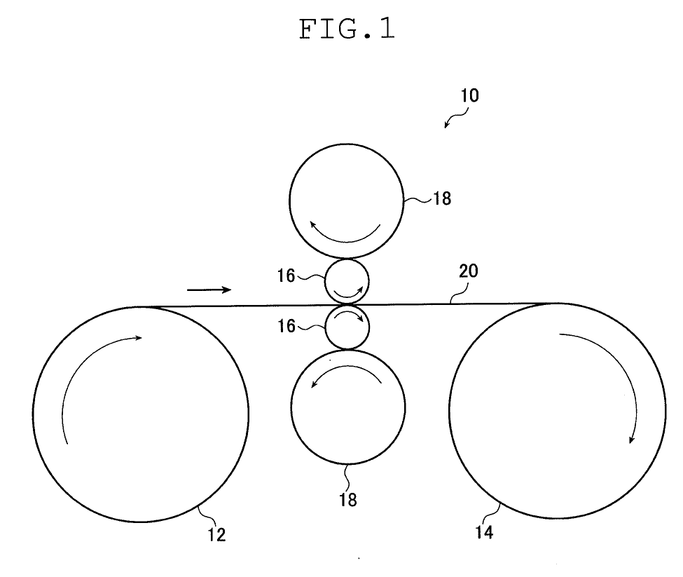

FIG. 1 is a schematic view showing an example of the cold rolling mill that may be used in cold rolling. A cold rolling mill 10 shown in FIG. 1 carries out cold rolling by applying pressure from a pair of rolling rollers 16 rotated by their support rollers 18 to an aluminum alloy plate 20 travelling between a feed coil 12 and a take-up coil 14.

In the invention, the aluminum alloy plate following cold rolling treatment preferably has a plate thickness (Y) of about 0.1 to about 0.5 mm and more preferably 0.15 to 0.4 mm. At a plate thickness (Y) within the above-defined range, a lithographic printing plate obtained by using the resulting lithographic printing plate support has excellent handling properties.

The aluminum alloy plate finished into the given thickness as in the range of 0.1 to 0.5 mm by the above-described treatments may be further treated by a leveling apparatus such as a roller leveler or a tension leveler to improve the flatness.

The flatness may be improved after the aluminum alloy plate has been cut into discrete sheets. However, to enhance productivity, it is preferable to improve the flatness of the aluminum alloy plate in the state of a continuous coil.

It is also possible to feed the aluminum alloy plate into a slitter line so as to form it into a given plate width.

A thin film of oil may be provided on the aluminum alloy plate surface to prevent scuffing due to friction between adjoining aluminum alloy plates. Suitable use may be made of either a volatile or non-volatile oil film, as needed.

The method of manufacturing the aluminum alloy plate for a lithographic printing plate of the invention with which the aluminum alloy plate of the invention is manufactured (hereinafter also referred to as the “inventive method of manufacturing the aluminum alloy plate”) is preferably a method which includes, of the above-described treatments, a semicontinuous casting step for forming an ingot from an aluminum alloy melt;

a scalping step for scalping the ingot obtained in the semicontinuous casting step; and

a soaking step for carrying out soaking treatment after the scalping step in a temperature range of 500 to 550° C.

On the other hand, the inventive method of manufacturing the aluminum alloy plate is preferably a method which includes, of the above-described treatments,

a continuous casting step for rolling an aluminum alloy melt as it is solidified, to thereby form an aluminum alloy plate;

A cold rolling step for reducing the thickness of the aluminum alloy plate obtained in the continuous casting step;

an intermediate annealing step for heating at a temperature of not more than 500° C. following the cold rolling step; and

a finish cold rolling step for reducing the thickness of the aluminum alloy plate following the intermediate annealing step.

### [Surface Roughening Treatment]

The lithographic printing plate support of the invention is obtained by subjecting the surface of the aluminum alloy plate to the surface roughening treatment including electrochemical graining treatment.

The surface roughening treatment may include solely electrochemical graining treatment, or electrochemical graining treatment, mechanical graining treatment and/or chemical graining treatment in combination.

In cases where mechanical graining treatment is combined with electrochemical graining treatment, mechanical graining treatment is preferably followed by electrochemical graining treatment.

In the practice of the invention, electrochemical graining treatment is preferably carried out in an aqueous solution of nitric acid or hydrochloric acid.

Mechanical graining treatment is carried out as desired in order that the surface of the aluminum alloy plate may generally have a surface roughness Rₐ of 0.35 to 1.0 μm.

In the invention, mechanical graining treatment is not particularly limited for its conditions but can be carried out according to the method described in JP 50-40047 B. Mechanical graining treatment can be carried out by brush graining using a suspension of pumice or a transfer system.

Chemical graining treatment is also not particularly limited but may be carried out by any known method.

Mechanical graining treatment is preferably followed by chemical etching treatment described below.

The purpose of chemical etching treatment following mechanical graining treatment is to smooth edges of irregularities at the surface of the aluminum alloy plate to prevent ink from catching on the edges during printing, to improve the scumming resistance of the lithographic printing plate, and to remove abrasive particles or other unnecessary substances remaining on the surface.

Chemical etching processes including etching using an acid and etching using an alkali are known in the art, and an exemplary method which is particularly excellent in terms of etching efficiency includes chemical etching treatment using an aqueous alkali solution. This treatment is hereinafter referred to as “alkali etching treatment.”

Alkaline agents that may be used in the alkali solution are not particularly limited and illustrative examples of suitable alkaline agents include sodium hydroxide, potassium hydroxide, sodium metasilicate, sodium carbonate, sodium aluminate, and sodium gluconate.

The alkaline agents may contain aluminum ions. The alkali solution has a concentration of preferably at least 0.01 wt % and more preferably at least 3 wt %, but preferably not more than 30 wt % and more preferably not more than 25 wt %.

The alkali solution has a temperature of preferably room temperature or higher and more preferably at least 30° C., but preferably not more than 80° C. and more preferably not more than 75° C.

The amount of material removed from the aluminum alloy plate (also referred to below as the “etching amount”) is preferably at least 0.1 g/m² and more preferably at least 1 g/m², but preferably not more than 20 g/m² and more preferably not more than 10 g/m².

The treatment time is preferably from 2 seconds to 5 minutes depending on the etching amount and more preferably from 2 to 10 seconds in terms of improving the productivity.

In cases where mechanical graining treatment is followed by alkali etching treatment in the invention, chemical etching treatment using an acid solution at a low temperature (hereinafter also referred to as “desmutting treatment”) is preferably carried out to remove substances produced by alkali etching treatment.

Acids that may be used in the acid solution are not particularly limited and illustrative examples thereof include sulfuric acid, nitric acid and hydrochloric acid. The acid solution preferably has a concentration of 1 to 50 wt %. The acid solution preferably has a temperature of 20 to 80° C. When the concentration and temperature of the acid solution fall within the above-defined ranges, a lithographic printing plate obtained by using the inventive lithographic printing plate support obtained has a more improved resistance to spotting.

In the practice of the invention, the surface roughening treatment is a treatment in which electrochemical graining treatment is carried out after mechanical graining treatment and chemical etching treatment are carried out as desired, but also in cases where electrochemical graining treatment is carried out without performing mechanical graining treatment, electrochemical graining treatment may be preceded by chemical etching treatment using an aqueous alkali solution such as sodium hydroxide. In this way, impurities which are present in the vicinity of the surface of the aluminum alloy plate can be removed.

Electrochemical graining treatment easily forms fine pits at the surface of the aluminum alloy plate and is therefore suitable to prepare a lithographic printing plate having excellent printability.

Electrochemical graining treatment is carried out in an aqueous solution containing nitric acid or hydrochloric acid as its main ingredient using direct or alternating current.

Electrochemical graining treatment enables craterlike or honeycomb pits having an average diameter of about 0.5 to 20 μm to be produced at the surface of the aluminum alloy plate at a surface area ratio of 30 to 100%. Pits having appropriate properties have the effect of improving the resistance to severe scumming and press life of the lithographic printing plate. Electrochemical graining treatment is not particularly limited for its conditions but may be carried out on the lithographic printing plate support of the invention under general conditions.

Electrochemical graining treatment is preferably followed by chemical etching treatment described below. Smut and intermetallic compounds are present at the surface of the aluminum alloy plate having undergone electrochemical graining treatment. In chemical etching treatment following electrochemical graining treatment, it is preferable for chemical etching treatment using an alkali solution (alkali etching treatment) to be first carried out in order to particularly remove smut with high efficiency. The conditions in chemical etching treatment using an alkali solution preferably include a treatment temperature of 20 to 80° C. and a treatment time of 1 to 60 seconds. It is desirable for the alkali solution to contain aluminum ions.

In order to remove substances generated by chemical etching treatment using an alkali solution following electrochemical graining treatment, it is further preferable to carry out chemical etching treatment using an acid solution at a low temperature (desmutting treatment).

The conditions in desmutting treatment preferably include a treatment temperature of 20 to 80° C. and a treatment time of 1 to 60 seconds. Exemplary acid solutions that may be used include solutions containing nitric acid, hydrochloric acid, or sulfuric acid as their main ingredient.

Even in cases where electrochemical graining treatment is not followed by alkali etching treatment, desmutting treatment is preferably carried out to remove smut efficiently.

The conditions in desmutting treatment preferably include a treatment temperature of 20 to 80° C. and a treatment time of 1 to 60 seconds. Exemplary acid solutions that may be used include solutions containing nitric acid, hydrochloric acid or sulfuric acid as their main ingredient. Of these, solutions containing hydrochloric acid as the main ingredient are preferably used.

In the practice of the invention, chemical etching treatment is not particularly limited but may be carried out by immersion, showering, coating or other process.

In the invention, the amount (B) of material removed by the surface roughening treatment is preferably from 1 to 10 μm, more preferably from 2 to 8 μm, and even more preferably from 3 to 6 μm. At an amount (B) within the above-defined range, the surface is sufficiently roughened to achieve excellent performance (e.g., press life) and the expression (i) to be described later is readily satisfied.

The amount (B) of material removed by the surface roughening treatment refers to the difference between the thickness of the aluminum alloy plate to be subjected to the surface roughening treatment and that of the aluminum alloy plate having undergone the surface roughening treatment, in other words, the sum of the thicknesses reduced by the surface roughening treatment including mechanical graining treatment, electrochemical graining treatment, etching treatment, and desmutting treatment.

### [Anodizing Treatment]

The lithographic printing plate support of the invention is obtained by anodizing the aluminum alloy plate having undergone the surface roughening treatment.

No particular limitation is imposed on the electrolyte that may be used in anodizing treatment as long as a porous oxide film can be formed. In general, use may be made of sulfuric acid, phosphoric acid, oxalic acid, chromic acid or a mixture thereof.

The concentration of the electrolyte is determined as appropriate for the type of the electrolyte used.

In addition, the anodizing treatment conditions considerably vary depending on the electrolyte used and are therefore not particularly limited, although it is generally suitable for the solution to have an electrolyte concentration of 1 to 80 wt % and a temperature of 5 to 70° C., and for the current density to be 1 to 60 A/dm², the voltage to be 1 to 100 V, and the electrolysis time to be 10 seconds to 300 seconds.

The anodized film formed by anodizing treatment in the invention preferably has a film thickness (C) of 0.1 to 2.5 μm and more preferably 0.3 to 1.5 μm. At an anodized film thickness within the above-defined range, the lithographic printing plate obtained by using the resulting aluminum alloy plate has an excellent scratch resistance and the expression (i) to be described later is readily satisfied.

### [Hydrophilizing Treatment]

The lithographic printing plate support of the invention is preferably one obtained by carrying out hydrophilizing treatment following anodizing treatment.

Illustrative examples of suitable hydrophilizing treatments include the potassium hexafluorozirconate treatment described in U.S. Pat. No. 2,946,638, the phosphomolybdate treatment described in U.S. Pat. No. 3,201,247, the alkyl titanate treatment described in GB 1,108,559 B, the polyacrylic acid treatment described in DE 1,091,433 B, the polyvinylphosphonic acid treatments described in DE 1,134,093 B and GB 1,230,447 B, the phosphonic acid treatment described in JP 44-6409 B, the phytic acid treatment described in U.S. Pat. No. 3,307,951, the treatments involving the divalent metal salts of lipophilic organic polymeric compounds described in JP 58-16893 A and JP 58-18291 A, a treatment like that described in U.S. Pat. No. 3,860,426 in which an aqueous metal salt (e.g., zinc acetate)-containing hydrophilic cellulose (e.g., carboxymethyl cellulose) undercoat is provided, and an undercoating treatment like that described in JP 59-101651 A in which a sulfo group-bearing water-soluble polymer is applied.

Additional examples of suitable hydrophilizing treatments include those which involve undercoating the aluminum alloy plate with the phosphates mentioned in JP 62-19494 A, the water-soluble epoxy compounds mentioned in JP 62-33692 A, the phosphoric acid-modified starches mentioned in JP 62-97892 A, the diamine compounds mentioned in JP 63-56498 A, the inorganic or organic salts of amino acids mentioned in JP 63-130391 A, the carboxy or hydroxy group-bearing organic phosphonic acids mentioned in JP 63-145092 A, the amino group- and phosphonate group-bearing compounds mentioned in JP 63-165183 A, the specific carboxylic acid derivatives mentioned in JP 2-316290 A, the phosphate esters mentioned in JP 3-215095 A, the compounds having one amino group and one phosphorus oxo acid group mentioned in JP 3-261592 A, the phosphate esters mentioned in JP 3-215095 A, the aliphatic or aromatic phosphonic acids (e.g., phenylphosphonic acid) mentioned in JP 5-246171 A, the sulfur atom-containing compounds (e.g., thiosalicylic acid) mentioned in JP 1-307745 A, and the phosphorus oxo acid group-bearing compounds mentioned in JP 4-282637 A.

Coloration with an acid dye as mentioned in JP 60-64352 A may also be carried out.

It is preferable to carry out hydrophilizing treatment by a method in which the aluminum alloy plate is immersed in an aqueous solution of an alkali metal silicate such as sodium silicate or potassium silicate, or is coated with a hydrophilic vinyl polymer or a hydrophilic compound so as to form a hydrophilic undercoat.

Hydrophilizing treatment with an aqueous solution of an alkali metal silicate such as sodium silicate or potassium silicate can be carried out according to the processes and procedures described in U.S. Pat. No. 2,714,066 and U.S. Pat. No. 3,181,461.

Illustrative examples of suitable alkali metal silicates include sodium silicate, potassium silicate and lithium silicate. The aqueous solution of an alkali metal silicate may include also a suitable amount of, for example, sodium hydroxide, potassium hydroxide or lithium hydroxide.

The aqueous solution of an alkali metal silicate may include also an alkaline earth metal salt or a Group 4 (Group IVA) metal salt. Examples of suitable alkaline earth metal salts include nitrates such as calcium nitrate, strontium nitrate, magnesium nitrate and barium nitrate; and also sulfates, hydrochlorides, phosphates, acetates, oxalates, and borates. Exemplary Group 4 (Group IVA) metal salts include titanium tetrachloride, titanium trichloride, titanium potassium fluoride, titanium potassium oxalate, titanium sulfate, titanium tetraiodide, zirconyl chloride, zirconium dioxide and zirconium tetrachloride. These alkaline earth metal salts and Group 4 (Group IVA) metal salts may be used singly or in combinations of two or more thereof.

The amount of silicon adsorbed as a result of alkali metal silicate treatment can be measured with a fluorescent x-ray analyzer, and is preferably 1.0 to 30 mg/m².

The alkali metal silicate treatment has the effect of enhancing the resistance at the surface of the lithographic printing plate support to dissolution in an alkali developer, suppressing the leaching of aluminum components into the developer, and reducing the generation of development scum arising from developer fatigue.

Hydrophilizing treatment for forming a hydrophilic undercoat may also be carried out according to the conditions and procedures described in JP 59-101651 A and JP 60-149491 A.

Hydrophilic vinyl polymers that may be used in such a method include copolymers of a sulfo group-bearing vinyl polymerizable compound such as polyvinylsulfonic acid or sulfo group-bearing p-styrenesulfonic acid with a conventional vinyl polymerizable compound such as an alkyl (meth)acrylate. Examples of hydrophilic compounds that may be used in this method include compounds having at least one group selected from among —NH₂ group, —COOH group and sulfo group.

On the other hand, in the practice of the invention, the lithographic printing plate support is preferably obtained by subjecting the aluminum alloy plate to the respective treatments described in Aspects A to C in the orders shown below. Rinsing with water is desirably carried out between the respective treatments. However, in cases where a solution of the same composition is used in the consecutively carried out two steps (treatments), rinsing with water may be omitted.

(Aspect A)

(1) Mechanical graining treatment;

(2) Chemical etching treatment in an aqueous alkali solution (first alkali etching treatment);

(3) Chemical etching treatment in an aqueous acid solution (first desmutting treatment);

(4) Electrochemical graining treatment in a nitric acid-based aqueous solution (first electrochemical graining treatment);

(5) Chemical etching treatment in an aqueous alkali solution (second alkali etching treatment);

(6) Chemical etching treatment in an aqueous acid solution (second desmutting treatment);

(7) Electrochemical graining treatment in a hydrochloric acid-based aqueous solution (second electrochemical graining treatment);

(8) Chemical etching treatment in an aqueous alkali solution (third alkali etching treatment);

(9) Chemical etching treatment in an aqueous acid solution (third desmutting treatment);

(10) Anodizing treatment; and

(11) Hydrophilizing treatment.

(Aspect B)

(2) Chemical etching treatment in an aqueous alkali solution (first alkali etching treatment);

(3) Chemical etching treatment in an aqueous acid solution (first desmutting treatment);

(12) Electrochemical graining treatment in a hydrochloric acid-based aqueous solution;

(5) Chemical etching treatment in an aqueous alkali solution (second alkali etching treatment);

(6) Chemical etching treatment in an aqueous acid solution (second desmutting treatment);

(10) Anodizing treatment; and

(11) Hydrophilizing treatment.

(Aspect C)

(2) Chemical etching treatment in an aqueous alkali solution (first alkali etching treatment);

(3) Chemical etching treatment in an aqueous acid solution (first desmutting treatment);

(4) Electrochemical graining treatment in a nitric acid-based aqueous solution (first electrochemical graining treatment);

(5) Chemical etching treatment in an aqueous alkali solution (second alkali etching treatment);

(6) Chemical etching treatment in an aqueous acid solution (second desmutting treatment);

(7) Electrochemical graining treatment in a hydrochloric acid-based aqueous solution (second electrochemical graining treatment);

(8) Chemical etching treatment in an aqueous alkali solution (third alkali etching treatment);

(9) Chemical etching treatment in an aqueous acid solution (third desmutting treatment);

(10) Anodizing treatment; and

(11) Hydrophilizing treatment.

Mechanical graining treatment, electrochemical graining treatment, chemical etching treatment, anodizing treatment and hydrophilizing treatment in (1) to (12) described above may be carried out by the same treatment methods and conditions as those described above, but the treatment methods and conditions to be described below are preferably used to carry out such treatments.

In order to form pits having shapes specific to the lithographic printing plate support of the invention, it is necessary to carry out electrochemical graining treatment in an aqueous hydrochloric acid solution following electrochemical graining treatment in an aqueous nitric acid solution to be described later.

Mechanical graining treatment is preferably carried out by using a rotating nylon brush roll having a bristle diameter of 0.2 to 1.61 mm and a slurry supplied to the surface of the aluminum alloy plate.

Known abrasives may be used and illustrative examples that may be preferably used include silica sand, quartz, aluminum hydroxide and a mixture thereof. A detailed description is given in JP 6-135175 A and JP 50-40047 B.

The slurry preferably has a specific gravity of 1.05 to 1.3. Use may be made of a technique that involves spraying of the slurry, a technique that involves the use of a wire brush, or a technique in which the surface shape of a textured mill roll is transferred to the aluminum alloy plate. Other techniques are described in JP 55-074898 A, JP 61-162351 A and JP 63-104889 A.

The aqueous alkali solution that may be used in chemical etching treatment in the aqueous alkali solution has a concentration of preferably 1 to 30 wt % and may contain aluminum and also alloying ingredients present in the aluminum alloy in an amount of 0 to 10 wt %.

An aqueous solution composed mainly of sodium hydroxide is preferably used for the aqueous alkali solution. Chemical etching treatment is preferably carried out at a solution temperature of room temperature to 95° C. for a period of 1 to 120 seconds.

After the end of etching treatment, removal of the treatment solution with nip rollers and rinsing by spraying with water are preferably carried out in order to prevent the treatment solution from being carried into the subsequent step.

In the first alkali etching treatment, the aluminum alloy plate is dissolved in an amount of preferably 0.5 to 30 g/m², more preferably 1.0 to 20 g/m², and even more preferably 3.0 to 15 g/m².

In the second alkali etching treatment, the aluminum alloy plate is dissolved in an amount of preferably 0.001 to 30 g/m², more preferably 0.1 to 4 g/m², and even more preferably 0.2 to 1.5 g/m².

In the third alkali etching treatment, the aluminum alloy plate is dissolved in an amount of preferably 0.001 to 30 g/m², more preferably 0.01 to 0.8 g/m², and even more preferably 0.02 to 0.3 g/m².

In chemical etching treatment in an aqueous acid solution (first to third desmutting treatments), phosphoric acid, nitric acid, sulfuric acid, chromic acid, hydrochloric acid or a mixed acid containing two or more thereof may be advantageously used.

The aqueous acid solution preferably has a concentration of 0.5 to 60 wt %.

Aluminum and also alloying ingredients present in the aluminum alloy may dissolve in the aqueous acid solution in an amount of 0 to 5 wt %.

Chemical etching treatment is preferably carried out at a solution temperature of room temperature to 95° C. for a treatment time of 1 to 120 seconds. After the end of desmutting treatment, removal of the treatment solution with nip rollers and rinsing by spraying with water are preferably carried out in order to prevent the treatment solution from being carried into the subsequent step.

The aqueous solution that may be used in electrochemical graining treatment is now described.

An aqueous solution which is used in conventional electrochemical graining treatment involving the use of direct current or alternating current may be employed for the nitric acid-based aqueous solution used in the first electrochemical graining treatment. The aqueous solution to be used may be prepared by adding to an aqueous solution having a nitric acid concentration of 1 to 100 g/L at least one nitrate compound containing nitrate ions, such as aluminum nitrate, sodium nitrate or ammonium nitrate, or at least one chloride compound containing chloride ions, such as aluminum chloride, sodium chloride or ammonium chloride in a range of 1 g/L to saturation.

Metals which are present in the aluminum alloy, such as iron, copper, manganese, nickel, titanium, magnesium and silicon may also be dissolved in the nitric acid-based aqueous solution.

More specifically, use is preferably made of a solution to which aluminum chloride or aluminum nitrate is added so that a 0.5 to 2 wt % aqueous solution of nitric acid may contain 3 to 50 g/L of aluminum ions.

The temperature is preferably from 10 to 90° C. and more preferably from 40 to 80° C.

An aqueous solution which is used in conventional electrochemical graining treatment involving the use of direct current or alternating current may be employed for the hydrochloric acid-based aqueous solution used in the second electrochemical graining treatment. The aqueous solution to be used may be prepared by adding to an aqueous solution having a hydrochloric acid concentration of 1 to 100 g/L at least one nitrate compound containing nitrate ions, such as aluminum nitrate, sodium nitrate or ammonium nitrate, or at least one chloride compound containing chloride ions, such as aluminum chloride, sodium chloride or ammonium chloride in a range of 1 g/L to saturation.

Metals which are present in the aluminum alloy, such as iron, copper, manganese, nickel, titanium, magnesium and silicon may also be dissolved in the hydrochloric acid-based aqueous solution.

More specifically, use is preferably made of a solution to which aluminum chloride or aluminum nitrate is added so that a 0.5 to 2 wt % aqueous solution of nitric acid may contain 3 to 50 g/L of aluminum ions.

The temperature is preferably from 10 to 60° C. and more preferably from 20 to 50° C. Hypochlorous acid may be added to the aqueous solution.

On the other hand, an aqueous solution which is used in conventional electrochemical graining treatment involving the use of direct current or alternating current may be employed for the hydrochloric acid-based aqueous solution used in electrochemical graining treatment in the aqueous hydrochloric acid solution. The aqueous solution to be used may be prepared by adding 0 to 30 g/L of sulfuric acid to an aqueous solution having a hydrochloric acid concentration of 1 to 100 g/L. The aqueous solution may be prepared by adding to this aqueous solution at least one nitrate compound containing nitrate ions, such as aluminum nitrate, sodium nitrate or ammonium nitrate, or at least one chloride compound containing chloride ions, such as aluminum chloride, sodium chloride or ammonium chloride in a range of 1 g/L to saturation.

Metals which are present in the aluminum alloy, such as iron, copper, manganese, nickel, titanium, magnesium and silicon may also be dissolved in the hydrochloric acid-based aqueous solution.

More specifically, use is preferably made of a solution to which aluminum chloride or aluminum nitrate is added so that a 0.5 to 2 wt % aqueous solution of nitric acid may contain 3 to 50 g/L of aluminum ions.

The temperature is preferably from 10 to 60° C. and more preferably from 20 to 50° C. Hypochlorous acid may be added to the aqueous solution.

A sinusoidal, square, trapezoidal or triangular waveform may be used as the waveform of the alternating current in electrochemical graining treatment. The frequency is preferably from 0.1 to 250 Hz.

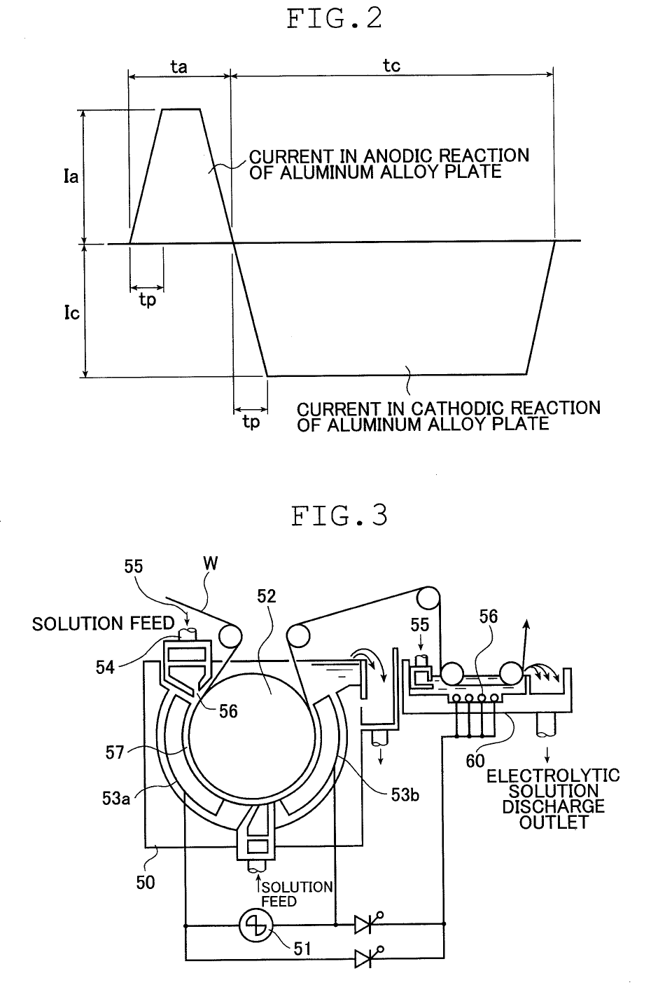

FIG. 2 is a graph showing an example of an alternating current waveform that may be used to carry out electrochemical graining treatment in the method of manufacturing a lithographic printing plate support of the invention.

In FIG. 2, “ta” represents the anodic reaction time, “tc” the cathodic reaction time, “tp” the time required for the current to reach a peak from zero, “Ia” the peak current on the anode cycle side, and “Ic” the peak current on the cathode cycle side. In the trapezoidal waveform, it is preferable for the time tp until the current reaches a peak from zero to be from 1 to 10 ms. At a time tp of less than 1 ms under the influence of impedance in the power supply circuit, a large power supply voltage is required at the leading edge of the current pulse, thus increasing the power supply equipment costs. At a time tp of more than 10 ms, the aluminum alloy plate tends to be affected by trace ingredients in the electrolytic solution, making it difficult to carry out uniform graining. One cycle of alternating current that may be used in electrochemical graining treatment preferably satisfies the following conditions: the ratio of the cathodic reaction time to to the anodic reaction time ta in the aluminum alloy plate (tc/ta) is from 1 to 20; the ratio of the amount of electricity Qc when the aluminum alloy plate serves as a cathode to the amount of electricity Qa when it serves as an anode (Qc/Qa) is from 0.3 to 20; and the anodic reaction time ta is from 5 to 1,000 ms. The ratio tc/ta is more preferably from 2.5 to 15. The ratio Qc/Qa is more preferably from 2.5 to 15. The current density at the current peak in the trapezoidal waveform is preferably from 10 to 200 A/dm² on both of the anode cycle side (Ia) and the cathode cycle side (Ic). The ratio Ic/Ia is preferably in a range of 0.3 to 20. The total amount of electricity furnished for the anodic reaction on the aluminum alloy plate up until completion of electrochemical graining treatment is preferably from 25 to 1,000 C/dm².

In the practice of the invention, any known electrolytic cell employed for surface treatment, including vertical, flat and radial type electrolytic cells, may be used to carry out electrochemical graining treatment using alternating current. Radial-type electrolytic cells such as those described in JP 5-195300 A are especially preferred. The electrolytic solution is passed through the electrolytic cell either parallel or counter to the direction in which the aluminum alloy plate (aluminum web) advances. One or more AC power supplies may be connected to one electrolytic cell. Two or more electrolytic cells may also be used.

An apparatus shown in FIG. 3 may be used for electrochemical graining treatment using alternating current.

FIG. 3 is a side view of a radial electrolytic cell that may be used in electrochemical graining treatment with alternating current in the method of manufacturing the lithographic printing plate support of the invention.

FIG. 3 shows a main electrolytic cell 50, an AC power supply 51, a radial drum roller 52, main electrodes 53a and 53b, a solution feed inlet 54, an electrolytic solution 55, auxiliary anodes 56, an auxiliary anode cell 60 and an aluminum alloy plate W. When two or more electrolytic cells are used, electrolysis may be carried out under the same or different conditions.

The aluminum alloy plate W is wound around the radial drum roller 52 disposed so as to be immersed in the electrolytic solution within the main electrolytic cell 50 and is electrolyzed by the main electrodes 53a and 53b connected to the AC power supply 51 as it is transported. The electrolytic solution 55 is fed from the solution feed inlet 54 through a slit to a solution channel 57 between the radial drum roller 52 and the main electrodes 53a and 53b. The aluminum alloy plate W treated in the main electrolytic cell 50 is then electrolyzed in the auxiliary anode cell 60. In the auxiliary anode cell 60, the auxiliary anodes 56 are disposed in a face-to-face relationship with the aluminum alloy plate W so that the electrolytic solution 55 flows through the space between the auxiliary anodes 56 and the aluminum alloy plate W.

On the other hand, electrochemical graining treatment (first and second electrochemical graining treatments) may be carried out by a method in which the aluminum alloy plate is electrochemically grained by applying direct current between the aluminum alloy plate and the electrodes opposed thereto.

An electrolytic solution which is used in known electrochemical graining treatment involving the use of direct current or alternating current may be used. The temperature is preferably from 10 to 80° C. A known treatment apparatus using direct current can be employed for electrochemical graining treatment involving the use of direct current, but an apparatus as described in JP 1-141094 A is preferably used in which one or more pairs of anodes and cathodes are disposed alternately. Exemplary known apparatuses are described in, for example, Japanese Patent Application No. 5-68204, Japanese Patent Application No. 6-205657, Japanese Patent Application No. 6-21050, JP 61-19115 A, and JP 57-44760 B. Direct current may be applied between the conductor roll in contact with the aluminum alloy plate and the cathode opposed thereto to carry out electrochemical graining treatment on the aluminum alloy plate serving as the anode. After the end of electrolytic treatment, removal of the treatment solution with nip rollers and rinsing by spraying with water are preferably carried out in order to prevent the treatment solution from being carried into the subsequent step. The direct current used for electrochemical graining preferably has a ripple ratio of not more than 20%. The current density is preferably from 10 to 200 A/dm² and the amount of electricity when the aluminum alloy plate serves as the anode is preferably from 25 to 1,000 C/dm². The anode to be used may be selected from known electrodes for generating oxygen including ones formed by cladding or plating valve metals such as titanium, niobium and zirconium with ferrite, iridium oxide, and platinum. The cathode to be used may be selected from among carbon, platinum, titanium, niobium, zirconium, stainless steel and other materials for use in fuel cell cathodes. The lithographic printing plate support-manufacturing method of the invention with which the lithographic printing plate support of the invention is manufactured (hereinafter also referred to as the “method of manufacturing the lithographic printing plate support of the invention”) is preferably a method which includes, of the above-described treatments,

a semicontinuous casting step for forming an ingot from an aluminum alloy melt containing 0.08 to 0.45 wt % of iron and 0.05 to 0.20 wt % of silicon with the balance being inadvertent impurities and aluminum;

a scalping step for scalping the ingot formed in the semicontinuous casting step;

a hot rolling step for rolling the scalped ingot to obtain a rolled plate;

a cold rolling step for reducing the thickness of the rolled plate following the hot rolling step to obtain an aluminum alloy plate; and

a surface treatment step in which the surface of the aluminum alloy plate following the cold rolling step is subjected to surface roughening treatment including electrochemical graining treatment and anodizing treatment in this order to obtain a lithographic printing plate.

It is preferable to use the manufacturing method in which the thickness (X) of the ingot following the semicontinuous casting step, the plate thickness (Y) following the cold rolling step, the amount (A) of material removed by the scalping step, the amount (B) of material removed by the surface roughening treatment and the thickness (C) of the anodized film satisfy the following expression (i):

$$4 ≦ Z = \frac{X - A}{Y} \times ( B + C ) \times {10}^{- 3} + A ≦ 20 \qquad ( i )$$

wherein X represents the thickness (mm) of the ingot following semicontinuous casting step, Y the thickness (mm) of the plate following the cold rolling step, A the amount (mm) of material removed by the scalping step, B the amount (μm) of material removed by the surface roughening treatment and C the thickness (μm) of the anodized film. Note that B is a value calculated from the difference between the thicknesses of the aluminum alloy plate before and after the surface roughening treatment.

In the expression (i), “(X−A)/Y” represents the draft at which rolling was carried out in the hot rolling step and the cold rolling step, and the product of “(X−A)/Y” and “(B+C)×10⁻³” represents the value corresponding to the amount of material removed by the treatments following the cold rolling step and the thickness of the anodized film before rolling.

Therefore, Z represented by [(X−A)/Y]×[(B+C)×10⁻³]+A corresponds to the distance from the interface between the anodized film and the aluminum alloy plate (base plate) to the surface of the ingot following the semicontinuous casting step.

By having the treatments in the above-described treatment steps satisfy the expression (i), a lithographic printing plate obtained by using the resulting lithographic printing plate support of the invention has an excellent resistance to spotting.

This is presumably because intermetallic compound particles are small in size at a distance of 4 to 20 mm from the ingot surface following the semicontinuous casting step so that aluminum-iron intermetallic compounds existing at the interface between the anodized film and the aluminum alloy plate in the inventive lithographic printing plate support obtained have a density as low as 3,000 particles/mm² or less, thus reducing the starting points for corrosion of the aluminum alloy plate.

### [Presensitized Plate]

The presensitized plate of the invention can be obtained by forming an image recording layer on the lithographic printing plate support of the invention.

### [Image Recording Layer]

The image recording layer that may be used in the presensitized plate of the invention can be removed by printing ink and/or fountain solution. More specifically, the image recording layer is preferably one which has an infrared absorber, a polymerization initiator and a polymerizable compound and is capable of recording by exposure to infrared light.

In the presensitized plate of the invention, irradiation with infrared light cures exposed portions of the image recording layer to form hydrophobic (lipophilic) regions, while at the start of printing, unexposed portions are promptly removed from the support by fountain solution, ink, or an emulsion of ink and fountain solution.

The constituents of the image recording layer are described below.

(Infrared Absorber)

In cases where an image is formed on the presensitized plate of the invention using a laser emitting infrared light at 760 to 1200 nm as a light source, an infrared absorber is usually used.

The infrared absorber has the function of converting absorbed infrared light into heat and the function of transferring electrons and energy to the polymerization initiator (radical generator) to be described below by excitation with infrared light.

The infrared absorber that may be used in the invention is a dye or pigment having an absorption maximum in a wavelength range of 760 to 1200 nm.

Dyes which may be used include commercial dyes and known dyes that are mentioned in the technical literature, such as Senryo Binran [Handbook of Dyes] (The Society of Synthetic Organic Chemistry, Japan, 1970).

Illustrative examples of suitable dyes include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts and metal-thiolate complexes.

Preferred dyes include the cyanine dyes mentioned in JP 58-125246 A, JP 59-84356 A, JP 60-78787 A and GB 434,875 B; the methine dyes mentioned in JP 58-173696 A, JP 58-181690 A and JP 58-194595 A; the naphthoquinone dyes mentioned in JP 58-112793 A, JP 58-224793 A, JP 59-48187 A, JP 59-73996 A, JP 60-52940 A and JP 60-63744 A; and the squarylium dyes mentioned in JP 58-112792 A.

Other exemplary dyes that may be preferably used include the near-infrared absorbing dyes mentioned in U.S. Pat. No. 4,756,993 as represented by the formulas (I) and (II).

Still other examples of the dyes that may be advantageously used include the near-infrared absorbers/sensitizers mentioned in U.S. Pat. No. 5,156,938. Other compounds that are suitable for use in this way include the substituted arylbenzo(thio)pyrylium salts mentioned in U.S. Pat. No. 3,881,924; the trimethinethiapyrylium salts mentioned in JP 57-142645 A (U.S. Pat. No. 4,327,169), the pyrylium compounds mentioned in JP 58-181051 A, JP 58-220143 A, JP 59-41363 A, JP 59-84248 A, JP 59-84249 A, JP 59-146063 A and JP 59-146061 A; the cyanine dyes mentioned in JP 59-216146 A; the pentamethinethiopyrylium salts mentioned in U.S. Pat. No. 4,283,475; and the pyrylium compounds mentioned in JP 5-13514 B and JP 5-19702 B.

Additional preferable examples of the dyes include the infrared absorbing dyes and more specifically specific indolenine cyanine dyes mentioned in JP 2002-278057 A which are illustrated below.

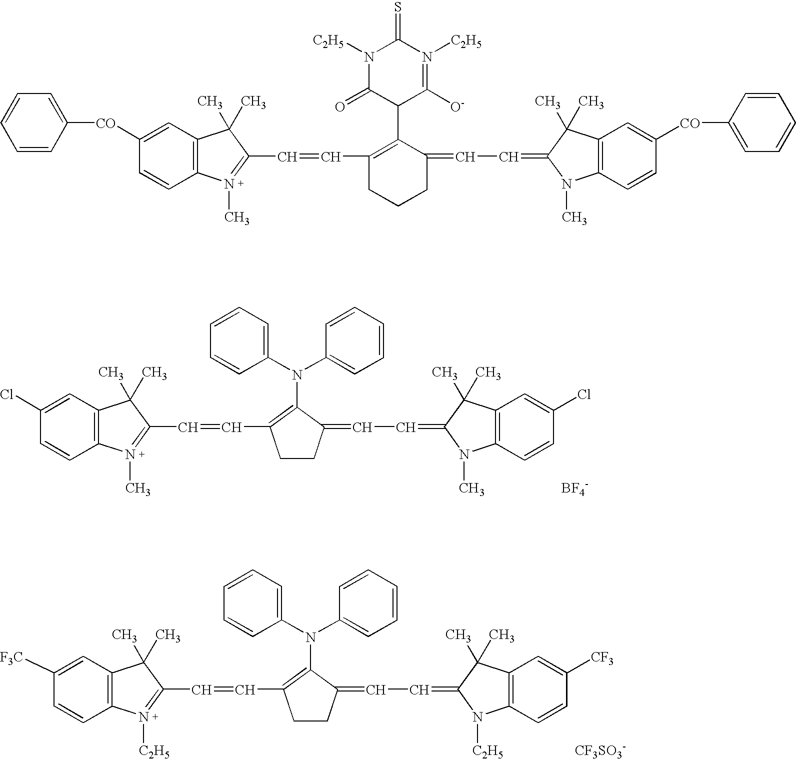

Of the illustrated dyes, cyanine dyes, squarylium dyes, pyrylium salts, nickel-thiolate complexes and indolenine cyanine dyes are particularly preferred. In addition, cyanine dyes and indolenine cyanine dyes are more preferred, and cyanine dyes of the general formula (i) below are most preferred.

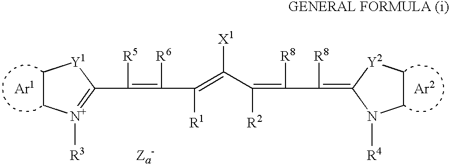

In the general formula (i), X¹ is a hydrogen atom, a halogen atom, —NPh₂ (where “Ph” represents a phenyl group), —X²-L¹, or a group of the following formula.

In the above formula, X² is an oxygen atom, a nitrogen atom or a sulfur atom; L¹ is a hydrocarbon group of 1 to 12 carbon atoms, an aromatic ring having a heteroatom, or a hydrocarbon group of 1 to 12 carbon atoms having a heteroatom. “Heteroatom,” as used herein, refers to a nitrogen, sulfur, oxygen, halogen or selenium atom. Xₐ⁻ is defined in the same way as Zₐ⁻ described below; and R^{a} is a substituent selected from among hydrogen atom, alkyl groups, aryl groups, substituted or unsubstituted amino groups and halogen atoms.

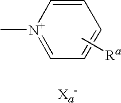

R¹ and R² are each independently a hydrocarbon group of 1 to 12 carbon atoms. For good storage stability of the image recording layer-forming coating fluid, it is preferable for R¹ and R² each to be a hydrocarbon group having at least two carbon atoms. It is especially preferable for R¹ and R² to be bonded together so as to form a 5- or 6-membered ring.

Ar¹ and Ar² are each independently an aromatic hydrocarbon group that may be substituted. Preferred aromatic hydrocarbon groups include benzene and naphthalene rings. Preferred substituents include hydrocarbon groups of up to 12 carbon atoms, halogen atoms, and alkoxy groups of up to 12 carbon atoms, with hydrocarbon groups of up to 12 carbon atoms and alkoxy groups of up to 12 carbon atoms being most preferred.

Y¹ and Y² are each independently a sulfur atom or a dialkylmethylene group of up to 12 carbon atoms.

R³ and R⁴ are each independently a hydrocarbon group of up to 20 carbon atoms which may be substituted. Preferred substituents include alkoxy groups of up to 12 carbon atoms, carboxy group and sulfo group, with alkoxy groups of up to 12 carbon atoms being most preferred.

R⁵, R⁶, R⁷ and R⁸ are each independently a hydrogen atom or a hydrocarbon group of up to 12 carbon atoms. In consideration of the availability of the starting materials, it is preferable for each of R⁵ to R⁸ to be a hydrogen atom.

Zₐ⁻ represents a counteranion. In cases where the cyanine dye of the general formula (i) has an anionic substituent in the structure and there is no need for charge neutralization, Zₐ⁻ is unnecessary. For good storage stability of the image recording layer-forming coating fluid, preferred examples of Zₐ⁻ include halide ions (e.g., Cl⁻ and Br⁻), perchlorate ions (ClO₄⁻), tetrafluoroborate ions (BF₄⁻), hexafluorophosphate ions (PF₆⁻) and sulfonate ions. Of these, perchlorate ions, tetrafluoroborate ions, hexafluorophosphate ions and arylsulfonate ions are more preferred.

Specific examples of cyanine dyes of the general formula (i) that may be preferably used in the invention include those described in Paragraphs [0017] to [0019] of JP 2001-133969 A.

Other preferred examples of the cyanine dyes include the specific indolenine cyanine dyes mentioned in JP 2002-278057 A.

Pigments which may be used include commercial pigments and pigments mentioned in the technical literature, such as the Colour Index (C.I.), Saishin Ganryo Binran [Latest Handbook of Pigments] (Japan Association of Pigment Technology, 1977), Saishin Ganryo Oyo Gijutsu [Recent Pigment Applications Technology] (CMC Publishing Co., Ltd., 1986), and Insatsu Inki Gijutsu [Printing Ink Technology] (CMC Publishing Co., Ltd., 1984).

Suitable pigments include black pigments, yellow pigments, orange pigments, brown pigments, red pigments, violet pigments, blue pigments, green pigments, fluorescent pigments, metal powder pigments and polymer-bonded dyes.

Specific examples of such pigments include insoluble azo pigments, azo lake pigments, condensed azo pigments, chelate azo pigments, phthalocyanine pigments, anthraquinone pigments, perylene and perinone pigments, thioindigo pigments, quinacridone pigments, dioxazine pigments, isoindolinone pigments, quinophthalone pigments, lake pigments, azine pigments, nitroso pigments, nitro pigments, natural pigments, fluorescent pigments, inorganic pigments and carbon black.

Of these, carbon black is preferred.

The pigments may be used without being surface treated or may be used after surface treatment.

Examples of surface treatment methods include surface coating with a resin or wax, surfactant deposition, and bonding a reactive substance (e.g., a silane coupling agent, an epoxy compound or a polyisocyanate) to the pigment surface.

Surface treatment methods that may be used include those described in Kinzoku Sekken no Seishitsu to Oyo [Properties and Applications of Metallic Soaps] (Saiwai Shobo), Insatsu Inki Gijutsu [Printing Ink Technology] (CMC Publishing Co., Ltd., 1984), and Saishin Ganryo Oyo Gijutsu [Recent Pigment Applications Technology] (CMC Publishing Co., Ltd., 1986).

The pigment has a particle size which is in a range of preferably 0.01 to 10 μm, more preferably 0.05 to 1 μm, and even more preferably 0.1 to 1 μm. When the particle size of the pigment is within the above range, the pigment dispersion has a good stability in the image recording layer-forming coating fluid, and an image recording layer obtained has a good uniformity.

Known dispersion techniques, such as those which can be used in ink production or toner production, may be employed as the method for dispersing the pigment. Illustrative examples of equipment that may be used for this purpose include an ultrasonic disperser, a sand mill, an attritor, a pearl mill, a super mill, a ball mill, an impeller, a disperser, a KD mill, a colloid mill, a dynatron, a three-roll mill and a pressure kneader. These methods of dispersion and dispersion apparatuses are described in Saishin Ganryo Oyo Gijutsu [Recent Pigment Applications Technology] (CMC Publishing Co., Ltd., 1986).

Although these infrared absorbers may be added to the layer that includes the other ingredients or may be added to a separately provided layer, they are added so that the image recording layer may have an absorbance, as measured by reflectrometry at a maximum absorption wavelength in a wavelength range of 760 nm to 1,200 nm, of 0.3 to 1.2 when a negative-type presensitized plate is prepared. The absorbance is preferably in a range of 0.4 to 1.1. Within this range, a uniform polymerization reaction proceeds in the depth direction of the image recording layer to achieve high film strength in image areas and good adhesion to the lithographic printing plate support.

The absorbance of the image recording layer can be adjusted by the amount of infrared absorber added to the image recording layer and the thickness of the image recording layer. The absorbance may be measured by an ordinary method. Exemplary measurement methods include one which involves forming on a reflective support made of aluminum or the like, an image recording layer having a thickness appropriately determined so that the coating weight after drying falls within the necessary range for the lithographic printing plate, and measuring the reflection density with an optical densitometer, and one which involves measuring the absorbance with a spectrophotometer by a reflection method using an integrating sphere.

(Polymerization Initiator)

Exemplary polymerization initiators which may be used are compounds that generate a radical under light or heat energy or both, and initiate or promote the polymerization of a compound having a polymerizable unsaturated group. In the invention, compounds that generate a radical under the action of heat (thermal radical generator) are preferably used.

Known thermal polymerization initiators, compounds having a small bond dissociation energy and photopolymerization initiators may be used as the polymerization initiator.

Compounds which generate a radical include organic halogen compounds, carbonyl compounds, organic peroxides, azo polymerization initiators, azide compounds, metallocene compounds, hexaarylbiimidazole compounds, organic borate compounds, disulfone compounds, oxime ester compounds and onium salt compounds.

Organic halogen compounds that may be used include those mentioned in, for example, Wakabayashi et al.: Bull. Chem. Soc. Japan 42, 2924 (1969), U.S. Pat. No. 3,905,815, JP 46-4605 B, JP 48-36281 A, JP 55-32070 A, JP 60-239736 A, JP 61-169835 A, JP 61-169837 A, JP 62-58241 A, JP 62-212401 A, JP 63-70243 A, JP 63-298339 A, and M. P. Hutt: Journal of Heterocyclic Chemistry 1, No. 3 (1970). Specifically, the use of oxazole compounds and s-triazine compounds substituted with a trihalomethyl group is preferred.

The use of s-triazine derivatives having at least one mono-, di- or trihalogenated methyl group attached to the s-triazine ring is more preferred. Compounds that may be used include, more specifically, 2,4,6-tris(monochloromethyl)-s-triazine, 2,4,6-tris(dichloromethyl)-s-triazine, 2,4,6-tris(trichloromethyl)-s-triazine, 2-methyl-4,6-bis(trichloromethyl)-s-triazine, 2-n-propyl-4,6-bis(trichloromethyl)-s-triazine, 2-(α,α,β-trichloroethyl)-4,6-bis(trichloromethyl)-s-triazine, 2-phenyl-4,6-bis(trichloromethyl)-s-triazine, 2-(p-methoxyphenyl)-4,6-bis(trichloromethyl)-s-triazine, 2-(3,4-epoxyphenyl)-4,6-bis(trichloromethyl)-s-triazine, 2-(p-chlorophenyl)-4,6-bis(trichloromethyl)-s-triazine, 2-[1-(p-methoxyphenyl)-2,4-butadienyl]-4,6-bis(trichloromethyl)-s-triazine, 2-styryl-4,6-bis(trichloromethyl)-s-triazine, 2-(p-methoxystyryl)-4,6-bis(trichloromethyl)-s-triazine, 2-(p-i-propyloxystyryl)-4,6-bis(trichloromethyl)-s-triazine, 2-(p-tolyl)-4,6-bis(trichloromethyl)-s-triazine, 2-(4-methoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine, and 2-methoxy-4,6-bis(tribromomethyl)-s-triazine.

Specific examples of carbonyl compounds that may be used include benzophenone and benzophenone derivatives such as Michler's ketone, 2-methylbenzophenone, 3-methylbenzophenone, 4-methylbenzophenone, 2-chlorobenzophenone, 4-bromobenzophenone and 2-carboxybenzophenone; acetophenone derivatives such as 2,2-dimethoxy-2-phenylacetophenone, 2,2-diethoxyacetophenone, 1-hydroxycyclohexyl phenyl ketone, α-hydroxy-2-methyl phenyl propanone, 1-hydroxy-1-methylethyl-(p-isopropylphenyl)ketone, 1-hydroxy-1-(p-dodecylphenyl)ketone, 2-methyl-(4′-(methylthio)phenyl)-2-morpholino-1-propanone and 1,1,1-trichloromethyl-(p-butylphenyl)ketone; thioxanthone and thioxanthone derivatives such as 2-ethylthioxanthone, 2-isopropylthioxanthone, 2-chlorothioxanthone, 2,4-dimethylthioxanthone, 2,4-diethylthioxanthone and 2,4-diisopropylthioxanthone; and benzoic acid ester derivatives such as ethyl p-dimethylaminobenzoate and ethyl p-diethylaminobenzoate.

Examples of azo polymerization initiators that may be used include the azo compounds mentioned in JP 8-108621 A.

Specific examples of organic peroxides that may be used include trimethylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis(tert-butylperoxy)butane, tert-butyl hydroperoxide, cumene hydroperoxide, diisopropylbenzene hydroperoxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)hexane, 2,5-oxanoyl peroxide, succinic acid peroxide, benzoyl peroxide, 2,4-dichlorobenzoyl peroxide, diisopropyl peroxydicarbonate, di-2-ethylhexyl peroxydicarbonate, di-2-ethoxyethyl peroxydicarbonate, dimethoxyisopropyl peroxycarbonate, di(3-methyl-3-methoxybutyl)peroxydicarbonate, tert-butyl peroxyacetate, tert-butyl peroxypivalate, tert-butyl peroxyneodecanoate, tert-butyl peroxyoctanoate, tert-butyl peroxylaurate, 3,3′,4,4′-tetra-(t-butylperoxycarbonyl)benzophenone, 3,3′,4,4′-tetra-(t-hexyl peroxycarbonyl)benzophenone, 3,3′,4,4′-tetra-(p-isopropylcumyl peroxycarbonyl)benzophenone, carbonyl di(t-butyl peroxydihydrogendiphthalate) and carbonyl di(t-hexyl peroxydihydrogendiphthalate).

Metallocene compounds that may be used include various titanocene compounds mentioned in, for example, JP 59-152396 A, JP 61-151197 A, JP 63-41484 A, JP 2-249 A, JP 2-4705 A and JP 5-83588 A, such as dicyclopentadienyltitanium bisphenyl, dicyclopentadienyltitanium bis-2,6-difluorophen-1-yl, dicyclopentadienyltitanium bis-2,4-difluorophen-1-yl, dicyclopentadienyltitanium bis-2,4,6-trifluorophen-1-yl, dicyclopentadienyltitanium bis-2,3,5,6-tetrafluorophen-1-yl, dicyclopentadienyltitanium bis-2,3,4,5,6-pentafluorophen-1-yl, dimethylcyclopentadienyltitanium bis-2,6-difluorophen-1-yl, dimethylcyclopentadienyltitanium bis-2,4,6-trifluorophen-1-yl, dimethylcyclopentadienyltitanium bis-2,3,5,6-tetrafluorophen-1-yl and dimethylcyclopentadienyltitanium bis-2,3,4,5,6-pentafluorophen-1-yl; and the iron-arene complexes mentioned in, for example, JP 1-304453 A and JP 1-152109 A.

Hexaarylbiimidazole compounds that may be used include various compounds mentioned in, for example, JP 6-29285 B, U.S. Pat. No. 3,479,185, U.S. Pat. No. 4,311,783 and U.S. Pat. No. 4,622,286. Specific examples include 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole and 2,2′-bis(o-trifluorophenyl)-4,4′,5,5′-tetraphenylbiimidazole.

Examples of organic borate compounds that may be used include the organic borates mentioned in, for example, JP 62-143044 A, JP 62-150242 A, JP 9-188685 A, JP 9-188686 A, JP 9-188710 A, JP 2000-131837 A, JP 2002-107916 A, JP 2764769 B, JP 2002-116539 A and by Martin Kunz in Rad Tech' 98. Proceedings (Apr. 19-22, 1998, Chicago); the organic boron sulfonium complexes and organic boron oxosulfonium complexes mentioned in JP 6-157623 A, JP 6-175564 A and JP 6-175561 A; the organic boron iodonium complexes mentioned in JP 6-175554 A and JP 6-175553 A; the organic boron phosphonium complexes mentioned in JP 9-188710 A; and the organic boron transition metal coordination complexes mentioned in JP 6-348011 A, JP 7-128785 A, JP 7-140589 A, JP 7-306527 A and JP 7-292014 A.

Examples of disulfone compounds that may be used include the compounds mentioned in, for example, JP 61-166544 A and JP 2003-328465 A.

Examples of oxime ester compounds that may be used include the compounds mentioned in, for example, JCS Perkin II (1979) 1653-1660, JCS Perkin II (1979) 156-162, Journal of Photopolymer Science and Technology (1995) 202-232, JP 2000-66385 A and JP 2000-80068 A. Specific examples include the compounds having the following structural formulas.

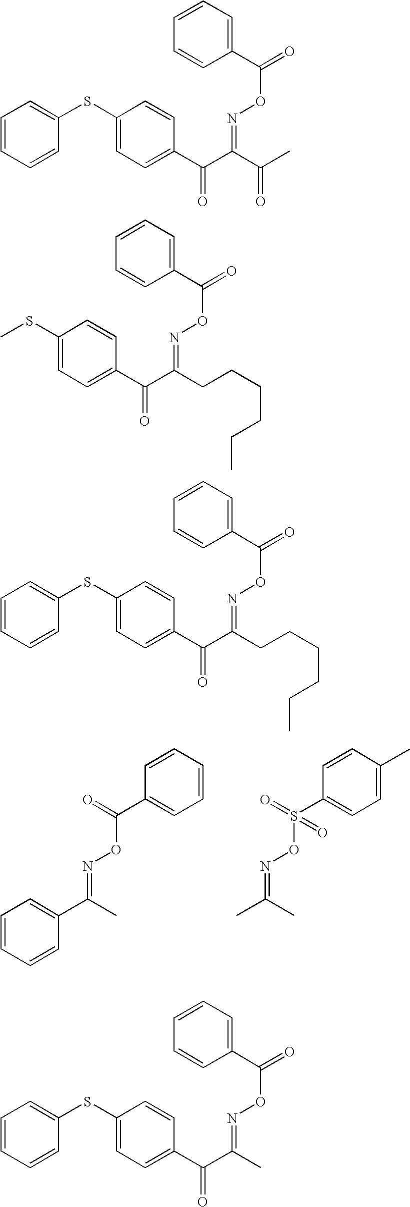

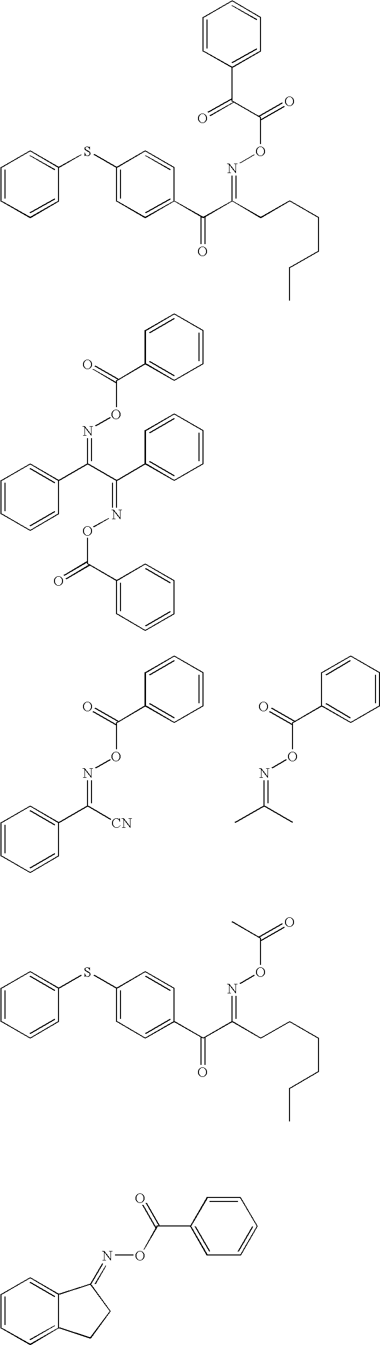

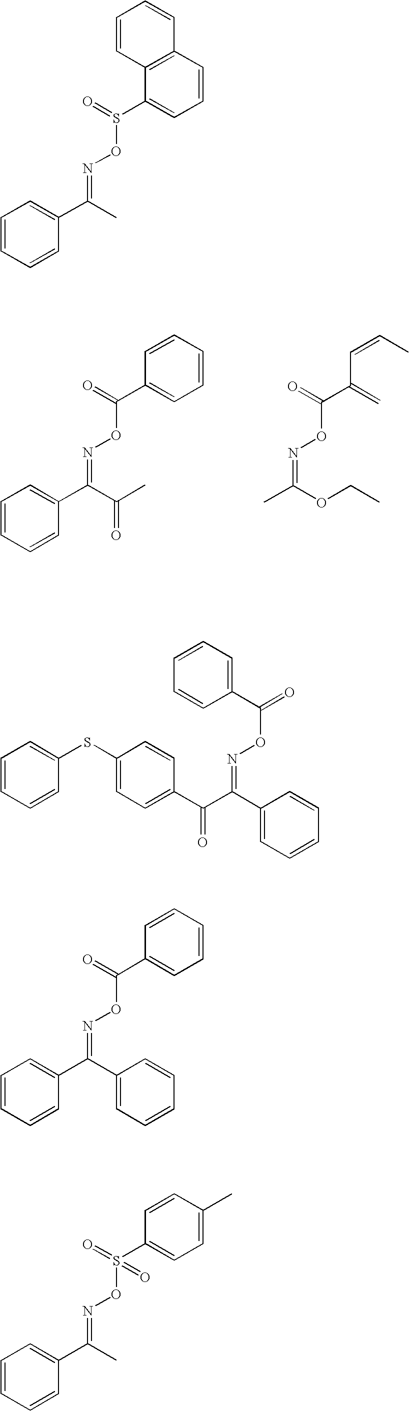

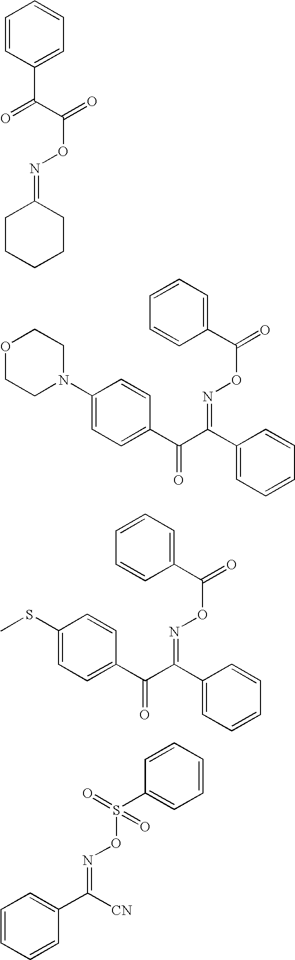

Specific examples of onium salt compounds that may be used include the diazonium salts mentioned by S. I. Schlesinger in Photogr. Sci. Eng. 18, 387 (1974) and by T. S. Bal et al. in Polymer 21, 423 (1980); the ammonium salts mentioned in U.S. Pat. No. 4,069,055 and JP 4-365049 A; the phosphonium salts mentioned in U.S. Pat. No. 4,069,055 and U.S. Pat. No. 4,069,056; the iodonium salts mentioned in EP 104,143 B, JP 2-150848 A and JP 2-296514 A; the sulfonium salts mentioned in EP 370,693 B, EP 390,214B, EP 233,567 B, EP 297,443 B, EP 297,442 B, U.S. Pat. No. 4,933,377, U.S. Pat. No. 410,201, U.S. Pat. No. 339,049, U.S. Pat. No. 4,760,013, U.S. Pat. No. 4,734,444, U.S. Pat. No. 2,833,827, DE 2,904,626, DE 3,604,580 and DE 3,604,581; the selenonium salts mentioned by J. V. Crivello et al. in Macromolecules 10 (6), 1307 (1977) and by J. V. Crivello et al. in J. Polymer Sci., Polymer Chem. Ed. 17, 1047 (1979); and the arsonium salts mentioned by C. S. Wen at al. in Teh, Proc. Conf. Rad. Curing ASIA, p. 478 (October 1988, Tokyo).

Of these onium salts, the oxime ester compounds, diazonium salts, iodonium salts and sulfonium salts are preferred in terms of reactivity and stability.

In the practice of the invention, these onium salts function not as acid generators but as ionic radical polymerization initiators.

The onium salts that may be preferably used are those represented by the following general formulas (RI-I) to (RI-III).

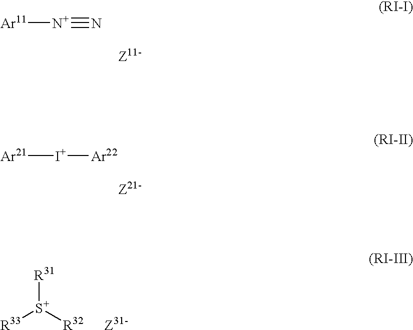

In the formula (RI-I), Ar¹¹ is an aryl group of up to 20 carbon atoms which may have 1 to 6 substituents. Preferred substituents include alkyl groups of 1 to 12 carbon atoms, alkenyl groups of 1 to 12 carbon atoms, alkynyl groups of 1 to 12 carbon atoms, aryl groups of 1 to 12 carbon atoms, alkoxy groups of 1 to 12 carbon atoms, aryloxy groups of 1 to 12 carbon atoms, halogen atoms, alkylamino groups of 1 to 12 carbon atoms, dialkylamino groups of 1 to 12 carbon atoms, alkylamide or arylamide groups of 1 to 12 carbon atoms, carbonyl group, carboxy group, cyano group, sulfonyl group, thioalkyl groups of 1 to 12 carbon atoms and thioaryl groups of 1 to 12 carbon atoms.

Z¹¹⁻ is a monovalent anion, specific examples of which include halide ions (e.g., Cl⁻ and Br⁻), perchlorate ion (ClO₄⁻), hexafluorophosphate ion (PF₆⁻), tetrafluoroborate ion (BF₄⁻), sulfonate ion, sulfinate ion, thiosulfonate ion and sulfate ion. Of these, perchlorate ion, hexafluorophosphate ion, tetrafluoroborate ion, sulfonate ion and sulfinate ion are preferred for good stability.

In the formula (RI-II), Ar²¹ and Ar²² are each independently an aryl group of up to 20 carbon atoms which may have 1 to 6 substituents. Preferred substituents include alkyl groups of 1 to 12 carbon atoms, alkenyl groups of 1 to 12 carbon atoms, alkynyl groups of 1 to 12 carbon atoms, aryl groups of 1 to 12 carbon atoms, alkoxy groups of 1 to 12 carbon atoms, aryloxy groups of 1 to 12 carbon atoms, halogen atoms, alkylamino groups of 1 to 12 carbon atoms, dialkylamino groups of 1 to 12 carbon atoms, alkylamide or arylamide groups of 1 to 12 carbon atoms, carbonyl group, carboxy group, cyano group, sulfonyl group, thioalkyl groups of 1 to 12 carbon atoms and thioaryl groups of 1 to 12 carbon atoms.

Z²¹⁻ is a monovalent anion, specific examples of which include halide ions (e.g., Cl⁻ and Br⁻), perchlorate ion (ClO₄⁻), hexafluorophosphate ion (PF₆⁻), tetrafluoroborate ion (BF₄⁻), sulfonate ion, sulfinate ion, thiosulfonate ion and sulfate ion. Of these, perchlorate ion, hexafluorophosphate ion, tetrafluoroborate ion, sulfonate ion, sulfinate ion and carboxylate ion are preferred for good stability and reactivity.

In the formula (RI-III), R³¹ , R³² and R³³ are each independently an aryl, alkyl, alkenyl or alkynyl group of up to 20 carbon atoms which may have 1 to 6 substituents. Of these, aryl groups are preferred for good reactivity and stability. Preferred substituents include alkyl groups of 1 to 12 carbon atoms, alkenyl groups of 1 to 12 carbon atoms, alkynyl groups of 1 to 12 carbon atoms, aryl groups of 1 to 12 carbon atoms, alkoxy groups of 1 to 12 carbon atoms, aryloxy groups of 1 to 12 carbon atoms, halogen atoms, alkylamino groups of 1 to 12 carbon atoms, dialkylamino groups of 1 to 12 carbon atoms, alkylamide or arylamide groups of 1 to 12 carbon atoms, carbonyl group, carboxy group, cyano group, sulfonyl group, thioalkyl groups of 1 to 12 carbon atoms and thioaryl groups of 1 to 12 carbon atoms.

Z³¹⁻ is a monovalent anion, specific examples of which include halide ions (e.g., Cl⁻ and Br⁻), perchlorate ion (ClO₄⁻), hexafluorophosphate ion (PF₆⁻), tetrafluoroborate ion (BF₄⁻), sulfonate ion, sulfinate ion, thiosulfonate ion and sulfate ion. Of these, perchlorate ion, hexafluorophosphate ion, tetrafluoroborate ion, sulfonate ion, sulfinate ion and carboxylate ion are preferred for good stability and reactivity. The carboxylate ion mentioned in JP 2001-343742 A is more preferred, and the carboxylate ion mentioned in JP 2002-148790 A is most preferred.

Examples of the onium salts that may be advantageously used for the polymerization initiator are shown below but the invention is not limited to these compounds.

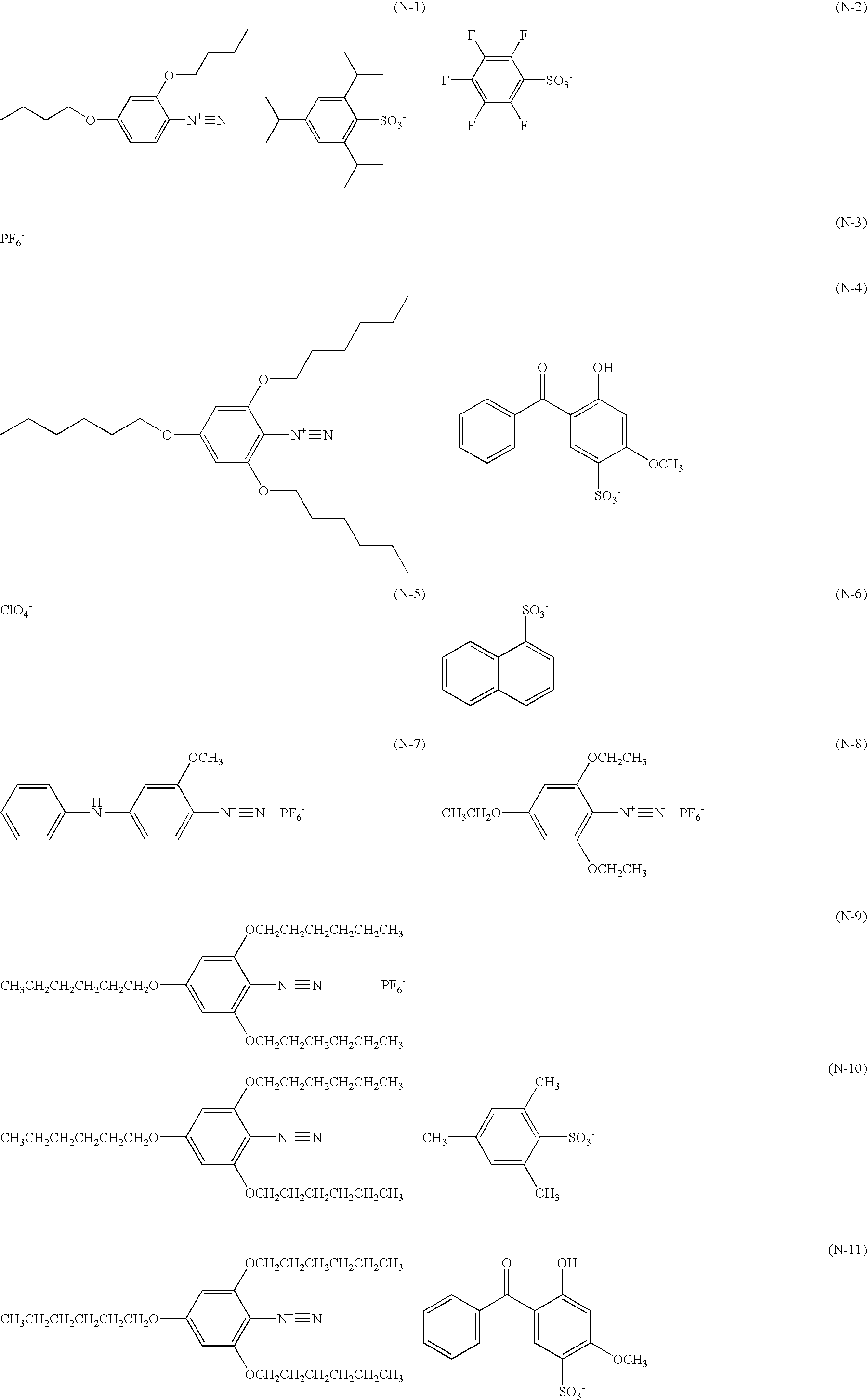

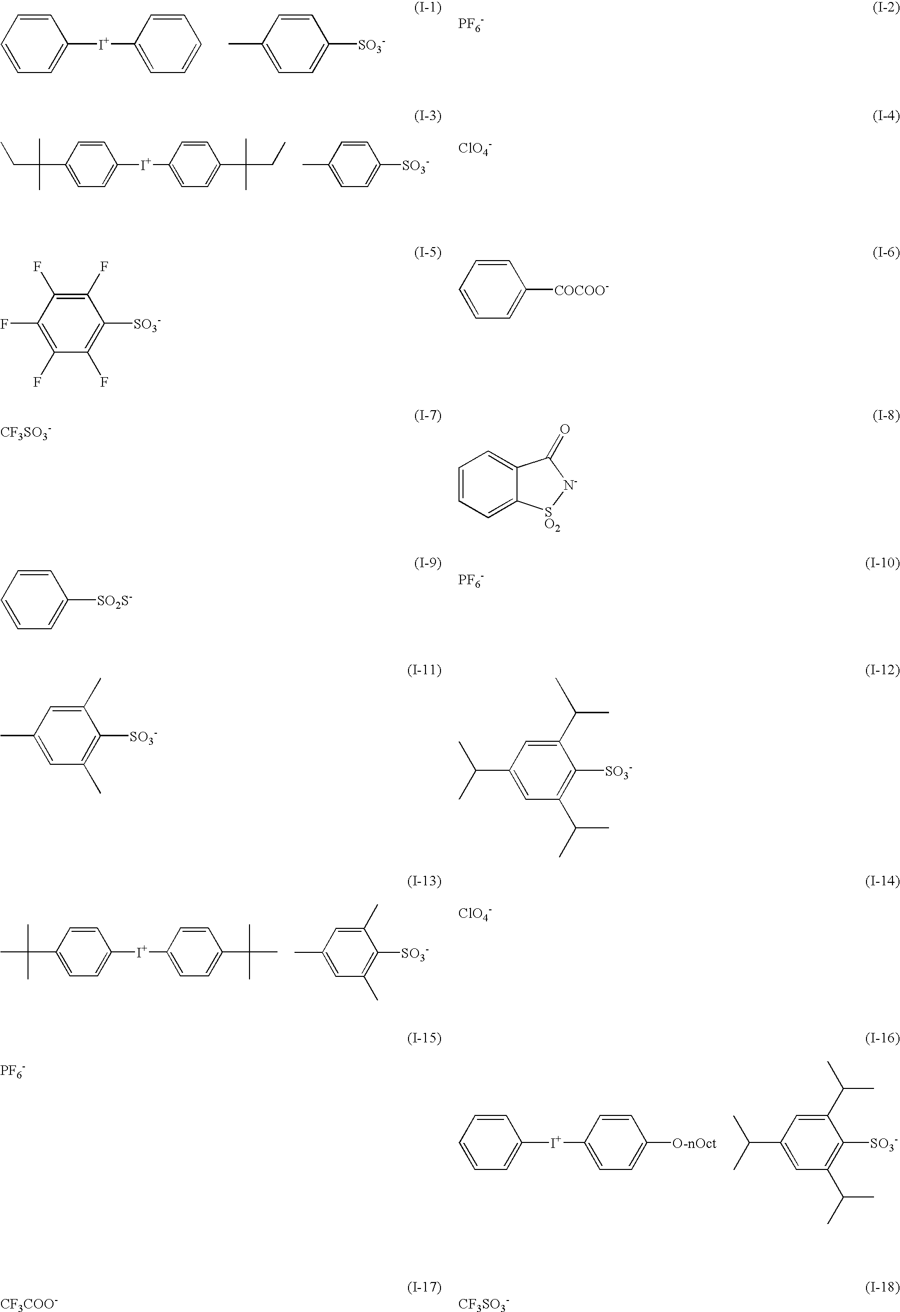

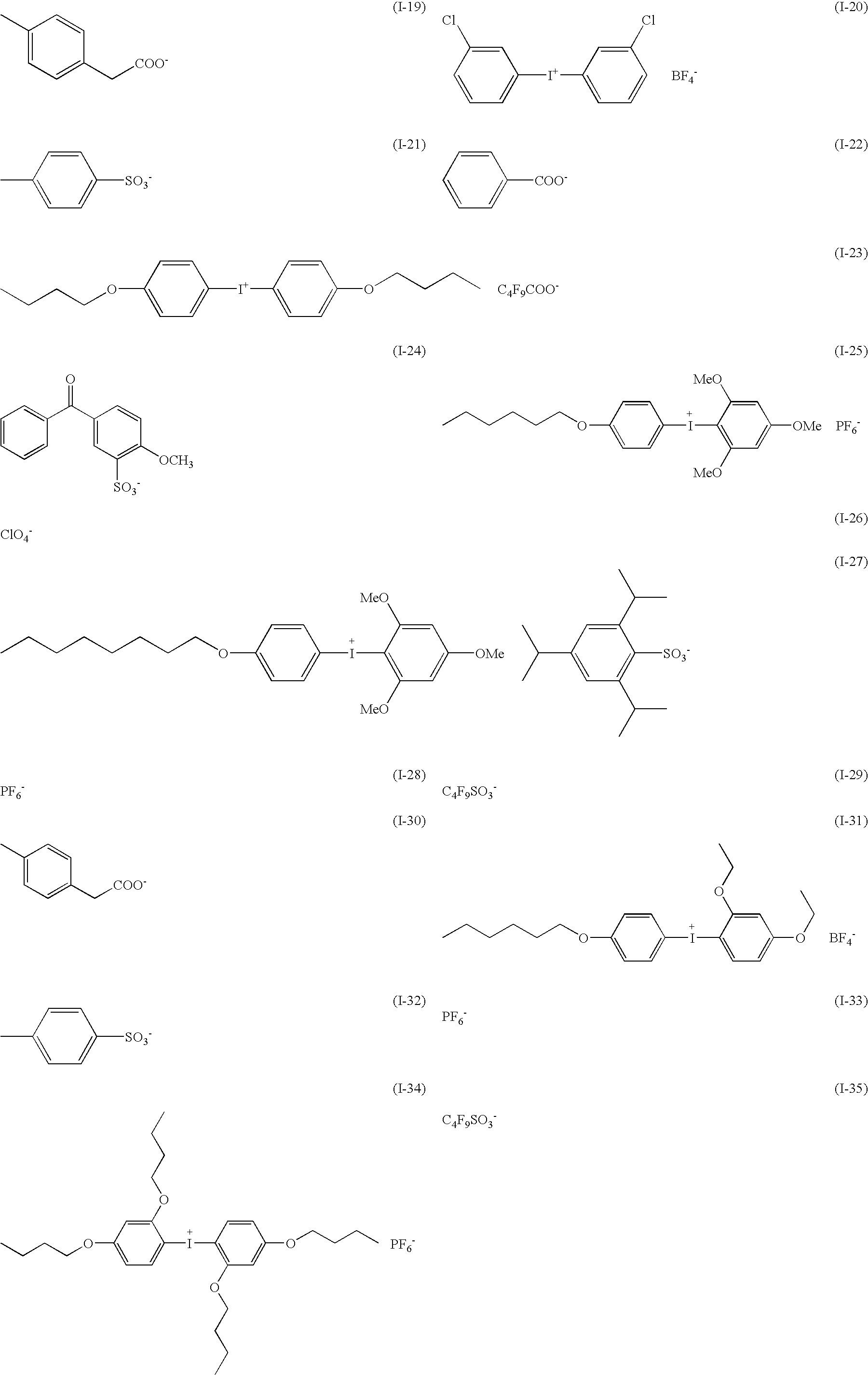

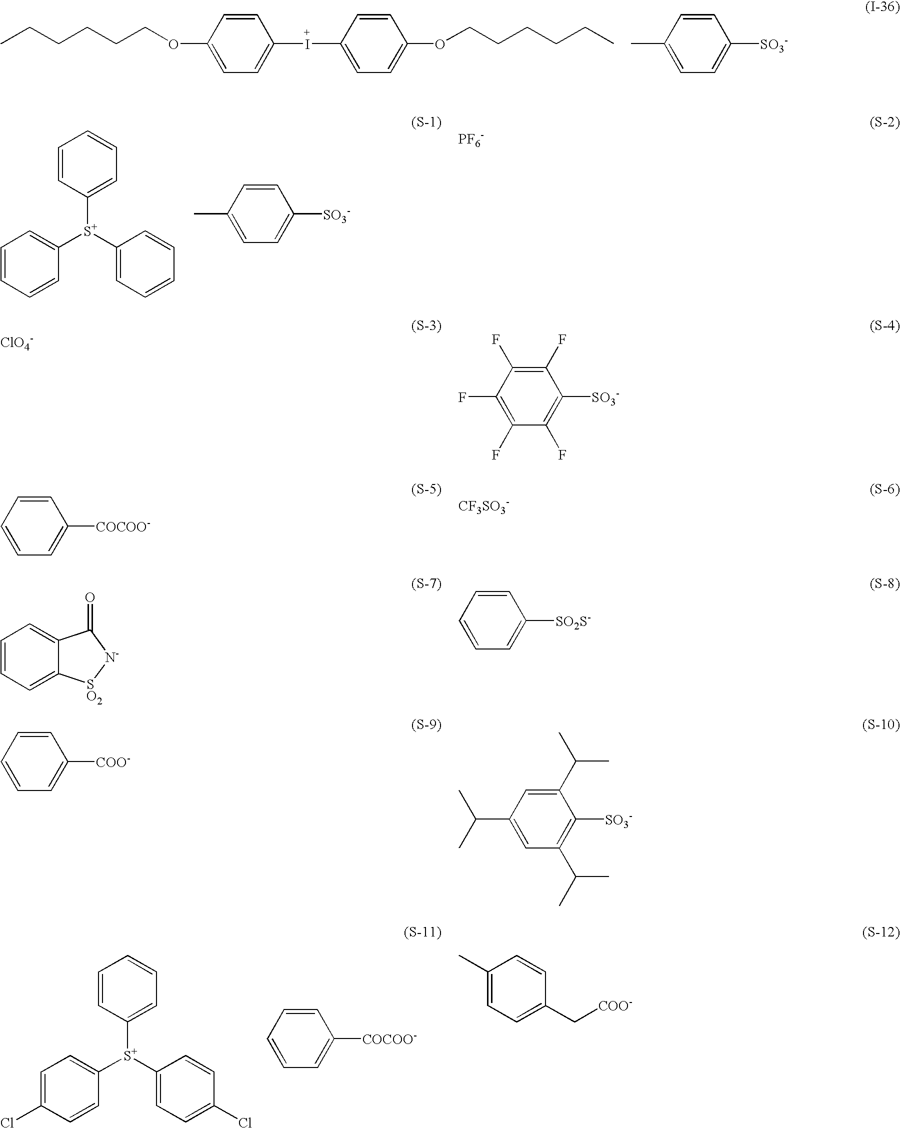

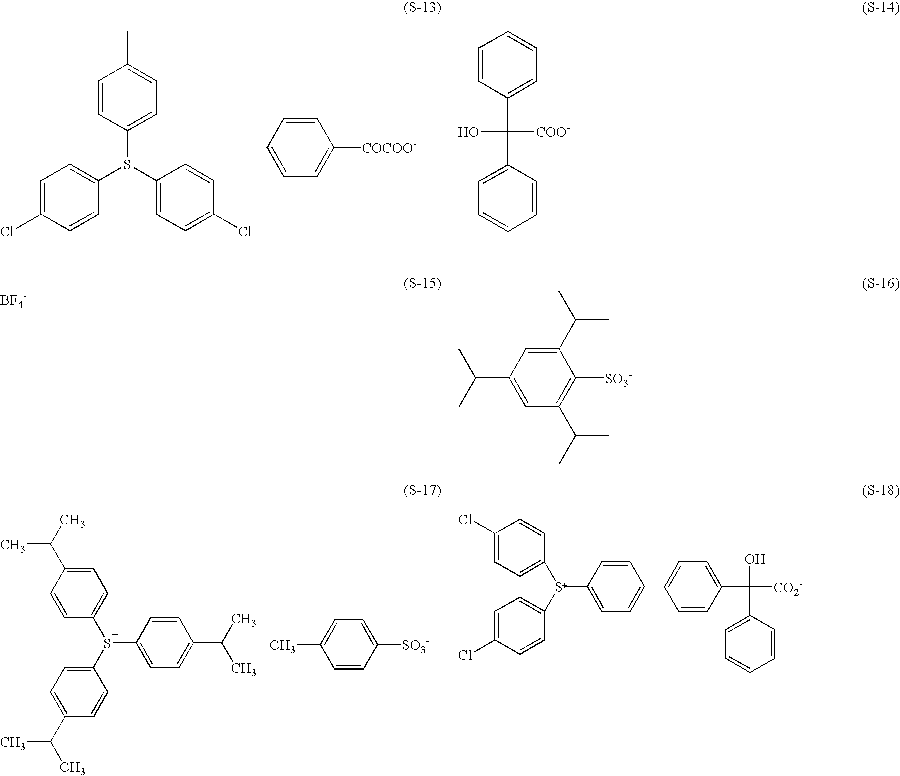

These polymerization initiators may be added in a proportion, based on all the solid ingredients making up the image recording layer, of 0.1 to 50 wt %, preferably 0.5 to 30 wt %, and more preferably 1 to 20 wt %.

An excellent sensitivity and a high resistance to scumming in non-image areas during printing are achieved at a polymerization initiator content within the above-defined range. These polymerization initiators may be used singly or in combination of two or more thereof. These polymerization initiators may be added to the layer that includes the other ingredients or may be added to a separately provided layer.

(Polymerizable Compound)

Polymerizable compounds are addition polymerizable compounds having at least one ethylenically unsaturated double bond, and are selected from compounds having at least one, and preferably two or more, terminal ethylenically unsaturated bonds.

In the invention, use can be made of any addition polymerizable compound known in the prior art, without particular limitation. Such compounds have a variety of chemical forms, including monomers, prepolymers such as dimers, trimers and oligomers, mixtures of any of the above, and copolymers of any of the above.

The monomers and copolymers are exemplified by unsaturated carboxylic acids (e.g., acrylic acid, methacrylic acid, itaconic acid, crotonic acid, isocrotonic acid, maleic acid) and esters and amides thereof. Of these, it is preferable to use an ester of an unsaturated carboxylic acid with an aliphatic polyol or an amide of an unsaturated carboxylic acid with an aliphatic polyamine compound.

Preferred use can also be made of the addition reaction product of an unsaturated carboxylic acid ester or amide having a nucleophilic substituent such as a hydroxy, amino or mercapto group with a monofunctional or polyfunctional isocyanate or epoxy compound; the dehydration condensation reaction product of the foregoing ester or amide with a monofunctional or polyfunctional carboxylic acid; the addition reaction product of an unsaturated carboxylic acid ester or amide having an electrophilic substituent such as an isocyanate or epoxy group with a monofunctional or polyfunctional alcohol, amine or thiol; or the substitution reaction product of an unsaturated carboxylic acid ester or amide having a removable substituent such as a halogen atom or a tosyloxy group with a monofunctional or polyfunctional alcohol, amine or thiol.

Moreover, use can also be made of compound groups in which a suitable compound such as unsaturated phosphonic acid, styrene or vinyl ether is substituted for the above-mentioned unsaturated carboxylic acid.

Illustrative examples of monomers which are esters of unsaturated carboxylic acids and aliphatic polyol compounds include acrylic acid esters, methacrylic acid esters, itaconic acid esters, crotonic acid esters, isocrotonic acid esters and maleic acid esters. Specific examples of acrylic acid esters include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, polyester acrylate oligomer and isocyanuric acid ethylene oxide-modified triacrylate.

Specific examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane and bis[p-(methacryloxyethoxy)phenyl]dimethylmethane.

Itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate and sorbitol tetraitaconate.

Crotonic acid esters include ethylene glycol dicrotonate, tetramethylene glycol dicrotonate, pentaerythritol dicrotonate and sorbitol tetradicrotonate.

Isocrotonic acid esters include ethylene glycol diisocrotonate, pentaerythritol diisocrotonate and sorbitol tetraisocrotonate.

Maleic acid esters include ethylene glycol dimaleate, triethylene glycol dimaleate, pentaerythritol dimaleate and sorbitol tetramaleate.

Preferred examples of other esters include the aliphatic alcohol esters mentioned in JP 51-47334 B and JP 57-196231 A; esters having aromatic skeletons such as those mentioned in JP 59-5240 A, JP 59-5241 A and JP 2-226149 A; and the amino group-bearing esters mentioned in JP 1-165613 A. In addition, the above-described ester monomers may be used in the form of a mixture.

Specific examples of amides of unsaturated carboxylic acids with aliphatic polyamines that may be used as monomers include methylenebis(acrylamide), methylenebis(methacrylamide), 1,6-hexamethylenebis(acrylamide), 1,6-hexamethylenebis(methacrylamide), diethylenetriaminetris(acrylamide), xylylenebis(acrylamide) and xylylenebis(methacrylamide).

Other suitable amide-type monomers include those having a cyclohexylene structure which are mentioned in JP 54-21726 B.

Urethane-type addition polymerizable compounds prepared using an addition reaction between an isocyanate group and a hydroxy group are also suitable. Specific examples include the vinylurethane compounds having two or more polymerizable vinyl groups per molecule that are obtained by adding a hydroxy group-bearing vinyl monomer of the general formula (A) below to the polyisocyanate compounds having two or more isocyanate groups per molecule mentioned in JP 48-41708 B.

CH₂═C(R⁴)COOCH₂CH(R⁵)OH (A)

In the formula (A), R⁴ and R⁵ each independently represent H or CH₃.

Urethane acrylates such as those mentioned in JP 51-37193 A, JP 2-32293 B and JP 2-16765 B, and the urethane compounds having an ethylene oxide-type skeleton mentioned in JP 58-49860 B, JP 56-17654 B, JP 62-39417 B and JP 62-39418 B are also suitable.

Other polymerizable compounds that may be used in the invention include the addition polymerizable compounds having in the molecule an amino structure or a sulfide structure that are mentioned in JP 63-277653 A, JP 63-260909 A and JP 1-105238 A. By using such addition polymerizable compounds, photopolymerizable compositions of exceptional sensitivity (speed) can be obtained.

Other polymerizable compounds that can be used in the invention include polyfunctional acrylates and methacrylates, such as the polyester acrylates mentioned in JP 48-64183 A, JP 49-43191 B and JP 52-30490 B, and epoxy acrylates obtained by reacting an epoxy resin with (meth)acrylic acid.

Further examples include the specific unsaturated compounds mentioned in JP 46-43946 B, JP 1-40337 B and JP 1-40336 B, and the vinylphosphonic acid compounds mentioned in JP 2-25493 A.

In some cases, it will be desirable to use the perfluoroalkyl group-containing structures mentioned in JP 61-22048 A.

Use can also be made of the photocurable monomers and oligomers mentioned in Nippon Setchaku Kyokaishi, Vol. 20, No. 7, 300-308 (1984).

Details concerning use of the addition polymerizable compound, for example, what type of structure it should have, whether to use one such compound alone or a combination of two or more thereof, and the amount of addition can be selected as desired in accordance with the performance characteristics ultimately intended for the presensitized plate. For example, selection may be based on the following criteria.

For good sensitivity, a structure having a high unsaturated group content per molecule is preferred. In most cases, a functionality of at least two is desirable. To increase the strength of image areas (i.e., the cured film), a functionally of three or more is preferred. Also effective are methods in which both the sensitivity and strength are adjusted by using in combination compounds having differing numbers of functional groups or differing polymerizable groups (e.g., acrylic acid esters, methacrylic acid esters, styrene compounds, vinyl ether compounds).

Selection of the addition polymerizable compound and how it is used are also important factors affecting both the compatibility and dispersibility of the compound with respect to other ingredients in the image recording layer (e.g., binder polymers, initiators, colorants). For instance, sometimes the compatibility can be enhanced by using a low-purity compound or by using together two or more addition polymerizable compounds.

The addition polymerizable compound is added in a proportion, with respect to the nonvolatile ingredients in the image recording layer, of preferably 5 to 80 wt %, and more preferably 25 to 75 wt %. These addition polymerizable compounds may be used singly or in combination of two or more thereof. In addition, as for how the addition polymerizable-compound is used, suitable structure, formulation and amount of addition may be arbitrarily selected from the viewpoints of the degree of polymerization inhibited by oxygen, resolution, fogging, changes in refractive index, and surface adhesiveness, and the arrangement of layers such as undercoat and topcoat and their coating method may optionally be carried out.

(Finely Divided Polymer Particles Having Polymerizable Reactive Group)

In the practice of the invention, the image recording layer preferably contains finely divided polymer particles having a polymerizable reactive group in addition to the above-described infrared absorber, polymerization initiator and polymerizable compound.

Exemplary finely divided polymer particles having a polymerizable reactive group include ones obtained by introducing a monomer having acryloyl group, methacryloyl group, vinyl group or allyl group into the polymer chain. These functional groups may be introduced into the finely divided polymer particles during polymerization or following polymerization by the use of a polymer reaction.

In the case of introduction during polymerization, a monomer having any of these polymerizable reactive groups is preferably subjected to emulsion polymerization, suspension polymerization, urethanization or other polycondensation reaction. A monomer having no polymerizable reactive group may optionally be added as a copolymerization ingredient.

Illustrative examples of monomers having such functional groups include, but are not limited to, allyl methacrylate, allyl acrylate, vinyl methacrylate, vinyl acrylate, glycidyl methacrylate, glycidyl acrylate, 2-isocyanate ethyl methacrylate, 2-isocyanate ethyl acrylate, 2-aminoethyl methacrylate, 2-aminoethyl acrylate, 2-hydroxyethyl methacrylate, 2-hydroxyethyl acrylate, acrylic acid, methacrylic acid, maleic anhydride, bifunctional acrylate and bifunctional methacrylate.

An exemplary polymer reaction that may be used in cases where the polymerizable reactive functional groups are introduced following polymerization includes one described in WO 96-034316.

The polymerizable reactive group-containing finely divided polymer particles may coalesce together by the influence of heat.

It is particularly preferable for the finely divided polymer particles to have each a hydrophilic surface and disperse in water. In order to make the surfaces of the finely divided polymer particles hydrophilic, polyvinyl alcohol, polyethylene glycol or other hydrophilic polymer or oligomer, or a hydrophilic low molecular weight compound is adsorbed on the surfaces of the finely divided polymer particles, but this is not the sole method of the invention.

The finely divided polymer particles preferably have an average particle size of 0.01 to 10 μm, more preferably 0.05 to 2 μm, and most preferably 0.1 to 1 μm. The resolution is lowered at a too large average particle size whereas the stability is impaired over time at a too small average particle size.

The finely divided polymer particles having a polymerizable reactive group may be used in the form of microcapsules or microgels that include a polymerizable reactive group-bearing compound with which no covalent bond is formed.

In other words, the invention is capable of using several embodiments depending on the methods of incorporating the constituents of the image recording layer into the image recording layer.

One is a molecular dispersion type image recording layer formed by a method as described in JP 2002-287334 A which involves dissolving the constituents in a suitable solvent and applying the resulting solution onto the support.

Another embodiment is a microcapsule type image recording layer formed by a method as described in JP 2001-27740 A or JP 2001-277742 A which involves including all or some of the constituents in microcapsules and incorporating the microcapsules into the image recording layer. The microcapsule type image recording layer may also contain the constituents outside the microcapsules. In a preferred embodiment, the microcapsule type image recording layer contains hydrophobic constituents in the microcapsules and hydrophilic constituents outside the microcapsules. In order to achieve better machine-on developability, the image recording layer is preferably a microcapsule type image recording layer.

The finely divided polymer particles having a polymerizable reactive group that may be used in the invention are in the form of microcapsules or microgels which include a polymerizable reactive group-bearing compound. The above-described polymerizable compounds may be used without any limitation for the polymerizable reactive group-bearing compound.

Known methods may be used for microencapsulating the constituents of the image recording layer. Illustrative examples include the methods involving the use of coacervation described in U.S. Pat. No. 2,800,457 and U.S. Pat. No. 2,800,458; the methods that rely on interfacial polymerization described in U.S. Pat. No. 3,287,154, JP 38-19574 B and JP 42-446 B; the methods involving polymer precipitation described in U.S. Pat. No. 3,418,250 and U.S. Pat. No. 3,660,304; the method that uses an isocyanate polyol wall material described in U.S. Pat. No. 3,796,669; the method that uses an isocyanate wall material described in U.S. Pat. No. 3,914,511; the methods that use a urea-formaldehyde or urea formaldehyde-resorcinol wall-forming material which are described in U.S. Pat. Nos. 4,001,140, 4,087,376 and 4,089,802; the method which uses wall materials such as melamine-formaldehyde resins and hydroxycellulose that is described in U.S. Pat. No. 4,025,445; the in situ methods involving monomer polymerization that are taught in JP 36-9163 B and JP 51-9079 B; the spray drying processes described in GB 930,422 B and U.S. Pat. No. 3,111,407; and the electrolytic dispersion cooling processes described in GB 952,807 B and GB 967,074 B.

Microcapsule walls preferred for use in this invention are those which have three-dimensional crosslinkages and are solvent-swellable. Accordingly, it is preferable for the microcapsule wall material to be selected from the group consisting of polyurea, polyurethane, polyester, polycarbonate, polyamide and a mixture thereof. Polyurea and polyurethane are especially preferred. The microcapsule wall may include therein the polymerizable reactive group-bearing compound.

The microcapsule is preferably one having an average particle size of 0.01 to 10 μm, more preferably 0.05 to 2 μm, and most preferably 0.1 to 1 μm. The resolution is lowered at a too large average particle size whereas the stability is impaired over time at a too small average particle size.

Such microcapsules may or may not coalesce together by the influence of heat.

(Binder Polymer)

In the practice of the invention, use may be made of a binder polymer in the image recording layer in order to improve the film forming properties of the image recording layer.

Conventionally known binder polymers may be used without any particular limitation and polymers having film forming properties are preferred. Examples of such binder polymers include acrylic resins, polyvinyl acetal resins, polyurethane resins, polyurea resins, polyimide resins, polyamide resins, epoxy resins, methacrylic resins, polystyrene resins, novolac phenolic resins, polyester resins, synthetic rubbers and natural rubbers.

Crosslinkability may be imparted to the binder polymer to enhance the film strength in image areas. To impart crosslinkability to the binder polymer, a crosslinkable functional group such as an ethylenically unsaturated bond may be introduced into the polymer main chain or side chain. The crosslinkable functional groups may be introduced by copolymerization.

Exemplary polymers having an ethylenically unsaturated bond in the main chain of the molecule include poly-1,4-butadiene and poly-1,4-isoprene.

Exemplary polymers having an ethylenically unsaturated bond in the side chain of the molecule include polymers of esters or amides of acrylic acid or methacrylic acid, in which polymers the ester or amide residue (R in —COOR or —CONHR) has an ethylenically unsaturated bond.

Exemplary residues (the above-mentioned R) having an ethylenically unsaturated bond include —(CH₂)ₙCR¹═CR²R³, —(CH₂O)ₙCH₂CR¹═CR²R³, —(CH₂CH₂O)ₙCH₂CR¹═CR²R³, —(CH₂)ₙNH—CO—O—CH₂CR¹═CR²R³, —(CH₂)ₙ—O—CO—CR¹═CR²R³ and —(CH₂CH₂O)₂—X (wherein each of R¹ to R³ represents a hydrogen atom, a halogen atom, or an alkyl, aryl, alkoxy or aryloxy group of 1 to 20 carbon atoms, and R¹ and R² or R³ may be bonded together to form a ring; the letter n is an integer from 1 to 10; and X is a dicyclopentadienyl residue).

Specific examples of suitable ester residues include —CH₂CH═CH₂ (mentioned in JP 7-21633 B), —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X is a dicyclopentadienyl residue).

Specific examples of suitable amide residues include —CH₂CH═CH₂, —CH₂CH₂O—Y (wherein Y is a cyclohexene residue) and —CH₂CH₂—OCO—CH═CH₂.

The binder polymer having crosslinkability is cured by, for example, the addition of free radicals (polymerization initiating radicals, or propagation radicals during polymerization of the polymerizable compound) to the crosslinkable functional groups on the polymer to effect addition polymerization, either directly between polymers or via chain polymerization of the polymerizable compounds, so as to form crosslinks between the polymer molecules. Alternatively, the binder polymer having crosslinkability is cured when atoms in the polymer (e.g., hydrogen atoms on carbon atoms adjacent to the crosslinkable functional groups) are pulled off by free radicals, thereby forming polymer radicals which bond together, resulting in the formation of crosslinks between the polymer molecules.

The crosslinkable group content in the binder polymer (content of radical-polymerizable unsaturated double bonds, as determined by iodometry) is preferably 0.1 to 10.0 mmol, more preferably 1.0 to 7.0 mmol, and most preferably 2.0 to 5.5 mmol, per gram of the binder polymer. Good sensitivity and storage stability are achieved at a crosslinkable group content within the above-defined range.

In terms of improving the on-machine developability in unexposed portions of the image recording layer, the binder polymer preferably has a high solubility or dispersibility in ink and/or fountain solution. Lipophilic binder polymers are preferred in order to improve the solubility or dispersibility in ink, but hydrophilic binder polymers are preferred in order to improve the solubility or dispersibility in fountain solution. To this end, it is also effective in the invention to use a lipophilic binder polymer and a hydrophilic binder polymer in combination.

Suitable examples of hydrophilic binder polymers include those having hydrophilic groups, such as hydroxy, carboxy, carboxylate, hydroxyethyl, polyoxyethyl, hydroxypropyl, polyoxypropyl, amino, aminoethyl, aminopropyl, ammonium, amide, carboxymethyl, sulfonate and phosphate groups.

Specific examples include gum arabic, casein, gelatin, starch derivatives, carboxymethyl cellulose and its sodium salt, cellulose acetate, sodium alginate, vinyl acetate-maleic acid copolymers, styrene-maleic acid copolymers, polyacrylic acids and their salts, polymethacrylic acids and their salts, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetates having a degree of hydrolysis of at least 60 mol %, and preferably at least 80 mol %, polyvinyl formal, polyvinyl butyral, polyvinyl pyrrolidone, acrylamide homopolymers and copolymers, methacrylamide homopolymers and copolymers, N-methylolacrylamide homopolymers and copolymers, polyvinylpyrrolidones, alcohol-soluble nylons, and polyethers of 2,2-bis(4-hydroxyphenyl)propane with epichlorohydrin.

The binder polymer has a weight-average molecular weight of preferably at least 5,000, and more preferably from 10,000 to 300,000, and has a number-average molecular weight of preferably at least 1,000, and more preferably from 2,000 to 250,000. The polydispersity (weight-average molecular weight/number-average molecular weight) is preferably from 1.1 to 10.

The binder polymer may be synthesized by any method known in the art. Examples of the solvent that may be used in the synthesis include tetrahydrofuran, ethylene dichloride, cyclohexanone, methyl ethyl ketone, acetone, methanol, ethanol, ethylene glycol monomethyl ether, ethylene glycol monoethyl ether, 2-methoxyethyl acetate, diethylene glycol dimethyl ether, 1-methoxy-2-propanol, 1-methoxy-2-propyl acetate, N,N-dimethylformamide, N,N-dimethylacetamide, toluene, ethyl acetate, methyl lactate, ethyl lactate, dimethylsulfoxide, and water. These may be used alone or as mixtures of two or more thereof.

Known compounds such as azo initiators and peroxide initiators may be used for the radical polymerization initiator employed in synthesizing the binder polymer.

The content of the binder polymer is from 5 to 90 wt %, preferably from 5 to 80 wt % and more preferably from 10 to 70 wt % based on all the solid ingredients of the image recording layer. A high strength in image areas and good image forming properties are achieved at a binder polymer content within the above-defined range.

The polymerizable compound and the binder polymer are preferably used in a weight ratio of 0.5/1 to 4/1.

(Surfactant)

In the practice of the invention, a surfactant is preferably used in the image recording layer in order to promote the on-machine developability at the start of printing and improve the coating surface shape.

Exemplary surfactants include nonionic surfactants, anionic surfactants, cationic surfactants, amphoteric surfactants and fluorochemical surfactants. Use may be made of a single surfactant or of a combination of two or more surfactants.

Any known nonionic surfactant may be used without particular limitation. Specific examples include polyoxyethylene alkyl ethers, polyoxyethylene alkyl phenyl ethers, polyoxyethylene polystyrylphenyl ethers, polyoxyethylene polyoxypropylene alkyl ethers, partial fatty acid esters of glycerol, partial fatty acid esters of sorbitan, partial fatty acid esters of pentaerythritol, fatty acid monoesters of propylene glycol, partial fatty acid esters of sucrose, partial fatty acid esters of polyoxyethylene sorbitan, partial fatty acid esters of polyoxyethylene sorbitol, fatty acid esters of polyethylene glycol, partial fatty acid esters of polyglycerol, polyoxyethylenated castor oils, partial fatty acid esters of polyoxyethylene glycerol, fatty acid diethanolamides, N,N-bis-2-hydroxyalkylamines, polyoxyethylene alkyl amines, fatty acid esters of triethanolamine, trialkylamine oxides, polyethylene glycol, and copolymers of polyethylene glycol and polypropylene glycol.

Any known anionic surfactant may be used without particular limitation. Specific examples include fatty acid salts, abietic acid salts, hydroxyalkanesulfonates, alkanesulfonates, dialkylsulfosuccinates, linear alkylbenzenesulfonates, branched alkylbenzenesulfonates, alkylnaphthalenesulfonates, alkylphenoxypolyoxyethylene propylsulfonates, polyoxyethylene alkylsulfophenyl ether salts, sodium N-methyl-N-oleyltaurate, the disodium salts of N-alkylsulfosuccinic acid monoamides, petroleum sulfonates, sulfated tallow oil, sulfates of fatty acid alkyl esters, alkyl sulfates, polyoxyethylene alkyl ether sulfates, fatty acid monoglyceride sulfates, polyoxyethylene alkylphenyl ether sulfates, polyoxyethylene styrylphenyl ether sulfates, alkyl phosphates, polyoxyethylene alkyl ether phosphates, polyoxyethylene alkylphenyl ether phosphates, partially saponified styrene-maleic anhydride copolymers, partially saponified olefin-maleic anhydride copolymers and naphthalenesulfonate-formalin condensates.

Any known cationic surfactant may be used without particular limitation. Examples include alkylamine salts, quaternary ammonium salts, polyoxyethylene alkylamine salts and polyethylene polyamine derivatives.

Any known amphoteric surfactant may be used without particular limitation. Examples include carboxybetaines, aminocarboxylic acids, sulfobetaines, aminosulfates and imidazolines.

In the surfactants mentioned above, the term “polyoxyethylene” may be substituted with the more general term “polyoxyalkylene,” additional examples of which include polyoxymethylene, polyoxypropylene and polyoxybutylene. Surfactants containing these latter polyoxyalkylene groups can likewise be used in the present invention.

Fluorochemical surfactants having perfluoroalkyl groups in the molecule are also suitable as the surfactant.

Examples of such fluorochemical surfactants include anionic surfactants such as perfluoroalkylcarboxylates, perfluoroalkylsulfonates and perfluoroalkylphosphates; amphoteric surfactants such as perfluoroalkylbetaine; cationic surfactants such as perfluoroalkyltrimethylammonium salts; and nonionic surfactants such as perfluoroalkylamine oxides, perfluoroalkyl-ethylene oxide adducts, oligomers containing perfluoroalkyl groups and hydrophilic groups, oligomers containing perfluoroalkyl groups and lipophilic groups, oligomers containing perfluoroalkyl groups, hydrophilic groups and lipophilic groups, and urethanes containing perfluoroalkyl groups and lipophilic groups. Preferred examples include the fluorochemical surfactants mentioned in JP 62-170950 A, JP 62-226143 A and JP 60-168144 A.

Use may be made of a single surfactant or of a combination of two or more surfactants.

The content of the surfactant is preferably from 0.001 to 10 wt % and more preferably from 0.01 to 5 wt % based on the total solids in the image recording layer.

(Colorant)

In the practice of the invention, various other compounds than those mentioned above may optionally be added to the image recording layer. For example, dyes having a large absorption in the visible light range can be used as image colorants. Specific examples include Oil Yellow #101, Oil Yellow #103, Oil Pink #312, Oil Green BG, Oil Blue BOS, Oil Blue #603, Oil Black BY, Oil Black BS and Oil Black T-505 (all of which are produced by Orient Chemical Industries, Ltd.); and also Victoria Pure Blue, Crystal Violet (CI 42555), Methyl Violet (CI 42535), Ethyl Violet, Rhodamine B (CI 145170B), Malachite Green (CI 42000), Methylene Blue (CI 52015), and the dyes mentioned in JP 62-293247 A. Preferred use can also be made of pigments such as phthalocyanine pigments, azo pigments, carbon black and titanium oxide.

The addition of these colorants is desirable because they enable image areas and non-image areas to be easily distinguished from each other following image formation. The amount of colorant added to the image recording layer is 0.01 to 10 wt %, based on the total solids in the image recording layer.

(Printing-Out Agent)

In the practice of the invention, an acid or radical-responsive chromogenic compound may be added to the image recording layer in order to form a print-out image.

Examples of compounds that may be effectively used include diphenylmethane, triphenylmethane, thiazine, oxazine, xanthene, anthraquinone, iminoquinone, azo and azomethine dyes.

Specific examples include dyes such as Brilliant Green, Ethyl Violet, Methyl Green, Crystal Violet, Basic Fuchsin, Methyl Violet 2B, Quinaldine Red, Rose Bengal, Metanil Yellow, Thymolsulfophthalein, Xylenol Blue, Methyl Orange, Paramethyl Red, Congo Red, Benzopurpurin 4B, α-Naphthyl Red, Nile Blue 2B, Nile Blue A, Methyl Violet, Malachite Green, Parafuchsin, Victoria Pure Blue BOH (produced by Hodogaya Chemical Co., Ltd.), Oil Blue #603 (Orient Chemical Industries, Ltd.), Oil Pink #312 (Orient Chemical Industries, Ltd.), Oil Red 5B (Orient Chemical Industries, Ltd.), Oil Scarlet #308 (Orient Chemical Industries, Ltd.), Oil Red OG (Orient Chemical Industries, Ltd.), Oil Red RR (Orient Chemical Industries, Ltd.), Oil Green #502 (Orient Chemical Industries, Ltd.), Spiron Red BEH Special (Hodogaya Chemical Co., Ltd.), m-Cresol Purple, Cresol Red, Rhodamine B, Rhodamine 6G, Sulforhodamine B, Auramine, 4-p-diethylaminophenyliminonaphthoquinone, 2-carboxyanilino-4-p-diethylaminophenyliminonaphthoquinone, 2-carboxystearylamino-4-p-N,N-bis(hydroxyethyl)aminophenyliminonaphthoquinone, 1-phenyl-3-methyl-4-p-diethylaminophenylimino-5-pyrazolone and 1-β-naphthyl-4-p-diethylaminophenylimino-5-pyrazolone; and leuco dyes such as p,p′,p″-hexamethyltriaminotriphenylmethane (Leuco Crystal Violet) and Pergascript Blue SRB (Ciba Geigy).

In addition to the above, leuco dyes known to be used in heat-sensitive or pressure-sensitive paper may also be advantageously used as a printing-out agent. Specific examples include Crystal Violet Lactone, Malachite Green Lactone, Benzoyl Leucomethylene Blue, 2-(N-phenyl-N-methylamino)-6-(N-p-tolyl-N-ethyl)aminofluoran, 2-anilino-3-methyl-6-(N-ethyl-p-toluidino)fluoran, 3,6-dimethoxyfluoran, 3-(N,N-diethylamino)-5-methyl-7-(N,N-dibenzylamino)fluoran, 3-(N-cyclohexyl-N-methylamino)-6-methyl-7-anilinofluoran, 3-(N,N-diethylamino)-6-methyl-7-anilinofluoran, 3-(N,N-diethylamino)-6-methyl-7-xylidinofluoran, 3-(N,N-diethylamino)-6-methyl-7-chlorofluoran, 3-(N,N-diethylamino)-6-methoxy-7-aminofluoran, 3-(N,N-diethylamino)-7-(4-chloroanilino)fluoran, 3-(N,N-diethylamino)-7-chlorofluoran, 3-(N,N-diethylamino)-7-benzylaminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-piperidino-6-methyl-7-anilinofluoran, 3-pyrrolidino-6-methyl-7-anilinofluoran, 3,3-bis(1-ethyl-2-methylindol-3-yl)phthalide, 3,3-bis(l-n-butyl-2-methylindol-3-yl)phthalide, 3,3-bis(p-dimethylaminophenyl)-6-dimethylaminophthalide, 3-(4-diethylamino-2-ethoxyphenyl)-3-(1-ethyl-2-methylindol-3-yl)-4-azaphthalide and 3-(4-diethylaminophenyl)-3-(1-ethyl-2-methylindol-3-yl)phthalide.

The acid or radical-responsive chromogenic dye is preferably added in an amount of 0.01 to 10 wt % based on the solids in the image recording layer.

(Polymerization Inhibitor)

In the practice of the invention, to prevent unwanted thermal polymerization of the radical polymerizable compound during production or storage of the image recording layer, it is desirable to add a small amount of a thermal polymerization inhibitor to the image recording layer.

Preferred examples of the thermal polymerization inhibitor include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol) and aluminum N-nitroso-N-phenylhydroxylamine. The amount of thermal polymerization inhibitor added to the image recording layer is preferably from about 0.01 wt % to about 5 wt %, based on the total solids in the image recording layer.

(Higher Fatty Acid Derivative)

In the practice of the invention, to prevent oxygen from inhibiting polymerization, a higher fatty acid derivative such as behenic acid or behenamide may be added to the image recording layer and induced to concentrate primarily at the surface of the image recording layer as the layer dries after coating. The higher fatty acid derivative is preferably added to the image recording layer in an amount of about 0.1 wt % to about 10 wt %, based on the total solids in the image recording layer.

(Plasticizer)

In the invention, the image recording layer may contain a plasticizer in order to improve the on-machine developability.

Preferred examples of the plasticizer include phthalic acid esters such as dimethyl phthalate, diethyl phthalate, dibutyl phthalate, diisobutyl phthalate, dioctyl phthalate, octylcapryl phthalate, dicyclohexyl phthalate, ditridecyl phthalate, butylbenzyl phthalate, diisodecyl phthalate and diallyl phthalate; glycol esters such as dimethyl glycol phthalate, ethyl phthalyl ethyl glycolate, methyl phthalyl ethyl glycolate, butyl phthalyl butyl glycolate, and triethylene glycol dicaprylate; phosphoric acid esters such as tricresyl phosphate and triphenyl phosphate; dibasic fatty acid esters such as diisobutyl adipate, dioctyl adipate, dimethyl sebacate, dibutyl sebacate, dioctyl azelate and dibutyl maleate; and polyglycidyl methacrylate, triethyl citrate, triacetyl glycerine and butyl laurate.

The plasticizer content is preferably not more than about 30 wt %, based on the total solids in the image recording layer.

(Fine Inorganic Particles)

In the invention, the image recording layer may contain fine inorganic particles to improve the strength of the cured film in image areas and the on-machine developability in non-image areas.

Preferred examples of fine inorganic particles include silica, alumina, magnesium oxide, titanium oxide, magnesium carbonate, calcium alginate, and mixtures thereof. Even if such particles do not convert light to heat, they can be used for such purposes as strengthening the film and strengthening interfacial adhesion due to surface roughening.

The fine inorganic particles have an average size of preferably 5 nm to 10 μm, and more preferably 0.5 μm to 3 μm. Within this range, they disperse stably in the image recording layer, enabling the image recording layer to maintain a sufficient degree of film strength and enabling the formation of non-image areas having excellent hydrophilic properties that are not prone to scumming during printing.

Fine inorganic particles of this type are readily available as commercial products, such as in the form of colloidal silica dispersions.

The content of these fine inorganic particles is preferably not more than 40 wt % and more preferably not more than 30 wt % based on the total solids in the image recording layer.

(Low-Molecular-Weight Hydrophilic Compound)

In the invention, to improve the on-machine developability, the image recording layer may contain a low-molecular-weight hydrophilic compound.

Illustrative examples of suitable low-molecular-weight hydrophilic compounds include the following water-soluble organic compounds: glycols such as ethylene glycol, diethylene glycol, triethylene glycol, propylene glycol, dipropylene glycol and tripropylene glycol, as well as ether or ester derivatives thereof; polyhydroxy compounds such as glycerol and pentaerythritol; organic amines such as triethanolamine, diethanolamine and monoethanolamine, as well as salts thereof; organic sulfonic acids such as toluenesulfonic acid and benzenesulfonic acid, as well as salts thereof; organic phosphonic acids such as phenylphosphonic acid, as well as salts thereof; and organic carboxylic acids such as tartaric acid, oxalic acid, citric acid, malic acid, lactic acid, gluconic acid and amino acids, as well as salts thereof.

### [Formation of Image Recording Layer]

The image recording layer is formed by dispersing or dissolving the necessary ingredients described above in a solvent to prepare a coating fluid and applying the thus prepared coating fluid to the support. Specific examples of the solvent that may be used include, but are not limited to, ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone, toluene and water.

These solvents may be used alone or as mixtures of two or more thereof. The coating fluid has a solids concentration of preferably 1 to 50 wt %.

The image recording layer can also be formed by dispersing or dissolving the same or different ingredients as or from those described above in the same or different solvents to prepare a plurality of coating fluids, applying the prepared coating fluids a plurality of times, and repeatedly drying.

The image recording layer coating weight (solids content) on the support obtained after coating and drying varies depending on the intended application, although an amount of 0.3 to 3.0 g/m² is generally preferred. At an image recording layer coating weight within this range, a good sensitivity and good image recording layer film properties are obtained.

Any of various coating methods may be used. Examples of suitable methods of coating include bar coating, spin coating, spray coating, curtain coating, dip coating, air knife coating, blade coating and roll coating.

### [Undercoat]

In the presensitized plate of the invention, it is desirable to provide an undercoat between the image recording layer and the lithographic printing plate support.

(Polymer Having Substrate Adsorbable Group, Polymerizable Group and Hydrophilic Group)

In the practice of the invention, the undercoat preferably contains a polymer having a substrate adsorbable group, a polymerizable group and a hydrophilic group.

An example of the polymer having a substrate adsorbable group, a polymerizable group and a hydrophilic group includes an undercoating polymer resin obtained by copolymerizing a adsorbable group-bearing monomer, a hydrophilic group-bearing monomer and a polymerizable reactive group (crosslinkable group)-bearing monomer.

One of the essential ingredients of the polymer resin is an adsorbable group on the substrate (the hydrophilic support surface). Whether or not a group is adsorbable on the hydrophilic support surface can be determined by, for example, the method as described below.

A test compound is dissolved in a readily-soluble solvent to prepare a coating solution, which is applied onto a support, then dried so as to obtain a coating weight after drying of 30 mg/m². Next, the support onto which the test compound has been applied is thoroughly cleaned with a readily-soluble solvent, after which the amount of the test compound which is not removed by cleaning but remains on the support is measured and the amount of adsorption on the support is calculated. The amount of remaining compound may be directly measured or calculated from the measured amount of the test compound dissolved in the cleaning solution. The amount of the compound may be determined by, for example, fluorescent X-ray spectroscopy, absorbance measurement using reflectance spectroscopy or liquid chromatography. The compound which is adsorbable on the support is a compound remaining in an amount of at least 1 mg/m² even after the above-described cleaning treatment has been carried out.

The group which is adsorbable on the surface of the hydrophilic support is a functional group that may form a chemical bond (e.g., an ionic bond, a hydrogen bond, a coordinate bond, or an intermolecular force bond) with a substance (e.g., a metal or a metal oxide) or a functional group (e.g., a hydroxy group) present on the surface of the hydrophilic surface. The adsorbable group is preferably an acid radical or a cationic group.

Particularly preferred examples of the monomer having an adsorbable group include compounds represented by the following formulas (III) and (IV):

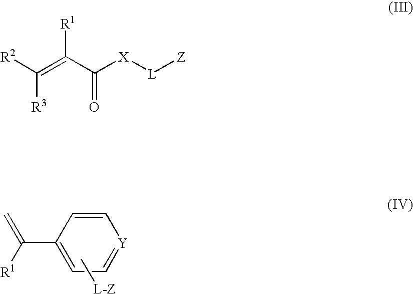

wherein R¹, R² and R³ are each independently a hydrogen atom, a halogen atom or an alkyl group of 1 to 6 carbon atoms. R¹, R² and R³ are preferably each independently a hydrogen atom or an alkyl group of 1 to 6 carbon atoms, more preferably a hydrogen atom or an alkyl group of 1 to 3 carbon atoms, and most preferably a hydrogen atom or methyl. It is particularly preferred that R² and R³ each represent a hydrogen atom. Z is a functional group adsorbing on the surface of the hydrophilic support.

In the formula (III), X is an oxygen atom (—O—) or an imino group (—NH—). X is more preferably an oxygen atom.

In the formula (III), L is a divalent linking group. L is preferably a divalent aliphatic group (alkylene group, substituted alkylene group, alkenylene group, substituted alkenylene group, alkynylene group, or substituted alkynylene group), a divalent aromatic group (allylene group or substituted allylene group), or a divalent heterocyclic group, or a combination of any of them with an oxygen atom (—O—), a sulfur atom (—S—), an imino group (—NH—), a substituted imino group (—NR— where R represents an aliphatic group, an aromatic group or a heterocyclic group) or a carbonyl group (—CO—).

The aliphatic group may have a cyclic structure or a branched structure. The aliphatic group preferably has 1 to 20 carbon atoms, more preferably 1 to 15 carbon atoms, and most preferably 1 to 10 carbon atoms. The aliphatic group is preferably a saturated aliphatic group rather than an unsaturated aliphatic group. The aliphatic group may have a substituent. Examples of the substituent include halogen atoms, hydroxy group, aromatic groups and heterocyclic groups.

The aromatic group preferably has 6 to 20 carbon atoms, more preferably 6 to 15 carbon atoms, and most preferably 6 to 10 carbon atoms. The aromatic group may have a substituent. Examples of the substituent include halogen atoms, hydroxy group, aliphatic groups, aromatic groups and heterocyclic groups.

The heterocyclic group preferably has a 5-membered or 6-membered ring as the heterocyclic ring. The heterocyclic ring may be condensed with other heterocyclic ring, an aliphatic ring or an aromatic ring. The heterocyclic group may have a substituent. Examples of the substituent include halogen groups, hydroxyl group, oxo group (═O), thio group (═S), imino group (═NH), substituted imino groups (═N—R where R represents an aliphatic group, an aromatic group or a heterocyclic group), aliphatic groups, aromatic groups and heterocyclic groups.

L is preferably a divalent linking group which includes a plurality of polyoxyalkylene structures and more preferably polyoxyethylene structures. In other words, L preferably contains —(OCH₂CH₂)ₙ— (n is an integer of 2 or more).

In the formula (IV), Y is a carbon atom or a nitrogen atom. In cases where Y is a nitrogen atom and L is connected to Y to form a quaternary pyridinium group, the quaternary pyridinium group itself exhibits the adsorptive properties and therefore Z may not be a functional group adsorbing on the surface of the hydrophilic support but a hydrogen atom. L represents a divalent linking group as defined in the formula (III) or a single bond.

The adsorbable functional group has been described above.

Typical examples of the compounds represented by the formulas (III) and (IV) are shown below.

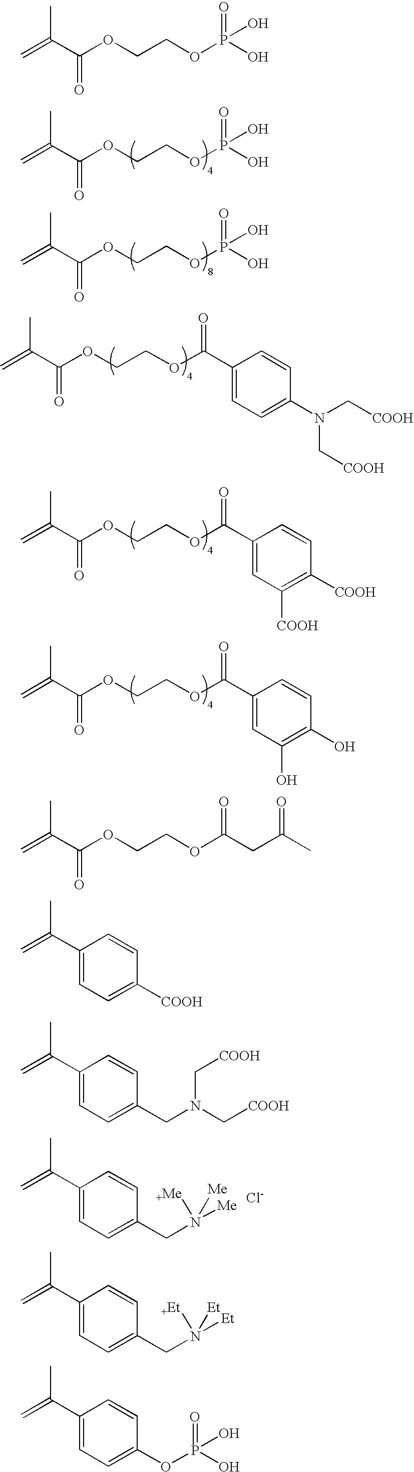

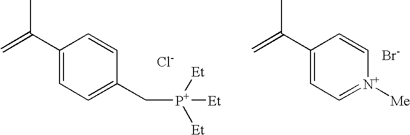

Illustrative examples of the hydrophilic group of the undercoating polymer resin that may be preferably used include hydroxy, carboxy, carboxylate, hydroxyethyl, polyoxyethyl, hydroxypropyl, polyoxypropyl, amino, aminoethyl, aminopropyl, ammonium, amide, carboxymethyl, sulfonate and phosphate groups. Of these, a sulfonate group exhibiting high hydrophilicity is preferred.

Illustrative examples of the sulfonate group-containing monomer include sodium salts and amine salts of methallyloxybenzenesulfonic acid, allyloxybenzenesulfonic acid, arylsulfonic acid, vinylsulfonic acid, p-styrenesulfonic acid, methallylsulfonic acid, acrylamide t-butylsulfonic acid, 2-acrylamide-2-methylpropanesulfonic acid, and (3-acryloyloxypropyl)butylsulfonic acid. Of these, a sodium salt of 2-acrylamide-2-methylpropanesulfonic acid is preferred in terms of hydrophilicity and handling in the synthesis.

The undercoating polymer resin preferably has a polymerizable reactive group. The polymerizable reactive group serves to improve the adhesion to image areas. It is possible to introduce a crosslinkable functional group such as an ethylenically unsaturated bond in the polymer side chain or to form a salt structure with a compound that has an ethylenically unsaturated bond with a substituent which is opposite in charge to a polar substituent of the polymer resin so that the undercoating polymer resin may have crosslinking properties.

Examples of the monomer for introducing an ethylenically unsaturated bond in the side chain of the molecule include monomers of esters or amides of acrylic acid or methacrylic acid, in which the ester or amide residue (R in —COOR or —CONHR) has an ethylenically unsaturated bond.

Exemplary residues (the above-mentioned R) having an ethylenically unsaturated bond include —(CH₂)ₙCR¹═CR²R³, —(CH₂O)ₙCH₂CR¹═CR²R³, —(CH₂CH₂O)ₙCH₂CR¹═CR²R³, —(CH₂)ₙNH—CO—O—CH₂CR¹═CR²R³, —(CH₂)ₙ—O—CO—CR¹═CR²R³ and —(CH₂CH₂O)₂—X (wherein each of R¹ to R³ represents a hydrogen atom, a halogen atom, or an alkyl, aryl, alkoxy or aryloxy group of 1 to 20 carbon atoms, and R¹ and R² or R³ may be bonded together to form a ring; the letter n is an integer from 1 to 10; and X is a dicyclopentadienyl residue).

Specific examples of suitable ester residues include —CH₂CH═CH₂ (mentioned in JP 7-21633 B), —CH₂CH₂O—CH₂CH═CH₂, —CH₂C (CH₃)═CH₂, —CH₂CH═CH—C₆H₅, —CH₂CH₂OCOCH═CH—C₆H₅, —CH₂CH₂NHCOO—CH₂CH═CH₂ and —CH₂CH₂O—X (wherein X is a dicyclopentadienyl residue).

Specific examples of suitable amide residues include —CH₂CH═CH₂, —CH₂CH₂O—Y (wherein Y is a cyclohexene residue) and —CH₂CH₂OCO—CH═CH₂—.

The polymerizable reactive group content in the undercoating polymer resin (content of radical-polymerizable unsaturated double bonds, as determined by iodometry) is preferably 0.1 to 10.0 mmol, more preferably 1.0 to 7.0 mmol, and most preferably 2.0 to 5.5 mmol, per gram of the polymer resin. Within the above-defined range, a good storage stability is achieved while striking a good balance between the sensitivity and scumming resistance.

The undercoating polymer resin has a weight-average molecular weight of preferably at least 5,000, and more preferably from 10,000 to 300,000, and has a number-average molecular weight of preferably at least 1,000, and more preferably from 2,000 to 250,000. The polydispersity (weight-average molecular weight/number-average molecular weight) is preferably from 1.1 to 10.

The undercoating polymer resin may be a random polymer, a block polymer or a graft polymer, but a random polymer is preferred.

The undercoating polymer resins may be used singly or as a mixture of two or more thereof. The chelating agents may also be used singly or as a mixture of two or more thereof. The undercoat-forming coating solution is obtained by dissolving the undercoating polymer resin and the chelating agent in an organic solvent (e.g., methanol, ethanol, acetone, or methyl ethyl ketone) and/or water. The undercoat-forming coating solution may contain an infrared absorber.

Various known methods may be used to apply the undercoat-forming coating solution to the support. Examples of suitable methods of coating include bar coating, spin coating, spray coating, curtain coating, dip coating, air knife coating, blade coating and roll coating.

The coating weight (solids content) of the undercoat is preferably from 0.1 to 100 mg/m² and more preferably from 1 to 50 mg/m².

### [Protective Layer]

In the presensitized plate of the invention, the image recording layer may optionally have a protective layer formed thereon to prevent scuffing and other damage to the image recording layer, to serve as an oxygen barrier, and to prevent ablation during exposure to a high-intensity laser.

In the practice of the invention, exposure is ordinarily carried out under conditions open to the atmosphere. A protective layer prevents oxygen and low-molecular-weight compounds such as basic substances which are present in the atmosphere and would interfere with the image-forming reactions triggered by light exposure in the image recording layer from entering the image recording layer, thus keeping the image-forming reactions triggered by exposure under open-air conditions from being hindered. Therefore, the properties desired of the protective layer preferably include a low permeability of low-molecular-weight compounds such as oxygen, good transmittance of the light used for exposure, excellent adhesion to the image recording layer, and ready removal in the on-machine development step following exposure.

Various protective layers endowed with such properties have been investigated and are closely described in, for example, U.S. Pat. No. 3,458,311 and JP 55-49729 B.

Materials that may be used in the protective layer include water-soluble polymeric compounds having a relatively good crystallinity. Illustrative examples include water-soluble polymers such as polyvinyl alcohol (PVA), polyvinyl pyrrolidone, acidic celluloses, gelatin, gum arabic and polyacrylic acid. Of these, the use of polyvinyl alcohol as the primary component provides the best results with respect to basic properties such as the oxygen barrier properties and removability of the protective layer during development. So long as the polyvinyl alcohol includes unsubstituted vinyl alcohol units which provide the protective layer with the required oxygen barrier properties and water solubility, some of the vinyl alcohol units may be substituted with esters, ethers or acetals, and the layer may include also other copolymerizable components.

It is preferable for the polyvinyl alcohol to be 71 to 100 mol % hydrolyzed and to have a degree of polymerization in a range of 300 to 2,400. Specific examples of such polyvinyl alcohols include the following, all produced by Kuraray Co., Ltd.: PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613 and L-8.

Conditions such as the protective layer ingredients (choice of PVA, use of additives, etc.) and coating weight may be suitably selected after taking into consideration not only the oxygen barrier properties and the removability during development, but also other characteristics, including the antifogging properties, adhesion, and scratch resistance of the protective layer. In general, a higher percent hydrolysis of the PVA (i.e., a higher content of unsubstituted vinyl alcohol units in the protective layer) and a greater film thickness provide higher oxygen barrier properties, resulting in better sensitivity. Moreover, to prevent undesirable polymerization reactions from occurring during production and storage, to prevent undesirable fogging during imagewise exposure, and to prevent thick image lines and other unwanted effects, it is preferable for the oxygen barrier properties to be not too high. Specifically, an oxygen permeability A at 25° C. and a pressure of not more than one atmosphere preferably satisfies 0.2≦A≦20 ml/m²·day.

In a preferred embodiment, the protective layer contains an inorganic layered compound as described in JP 11-38633 A. A combination of the inorganic layered compound and the water-soluble polymeric compound enables high oxygen barrier properties to be achieved. The inorganic layered compound that may be used in the invention is in the form of thin planar particles, and examples thereof include a mica group including a natural mica and a synthetic mica represented by the general formula:

A (B, C)₂₋₅D₄O₁₀ (OH, F, O)₂

(wherein A is potassium, sodium or calcium, B and C are each iron (II), iron (III), manganese, aluminum, magnesium or vanadium, D is silicon or aluminum), talc represented by the formula: 3MgO.4SiO.H₂O, tainiolite, montmorillonite, saponite, hectorite, and zirconium phosphate.

Illustrative examples of the natural mica include muscovite, paragonite, phlogopite, biotite, and lepidolite.

Illustrative examples of the synthesic mica include non-swelling micas such as fluorophlogopite KMg₃(AlSi₃O₁₀)F₂, potassium tetrasilisic mica (KMg_{2.5}Si₄O₁₀)F₂; and swelling micas such as sodium tetrasilisic mica NaMg_{2.5}(Si₄O₁₀)F₂, sodium or lithium tainiolite (Na,Li)Mg₂Li(Si₄O₁₀)F₂, and montmorillonite type sodium or lithium hectorite (Na,Li)_{1/8}Mg_{2/5}Li_{1/8}(Si₄O₁₀)F₂. Synthetic smectite is also useful.

Of the above-described inorganic layered compounds, a fluorine-containing swelling mica which is a synthetic inorganic layered compound is particularly useful in the invention.

The inorganic layered compound that may be used in the invention desirably has such a shape that the thickness is as small as possible from the viewpoint of diffusion control and that the plane size is as large as possible so long as the smoothness of the coated surface and transmission of active rays are not impaired. Therefore, the aspect ratio is at least 20, preferably at least 100 and more preferably at least 200. The aspect ratio is a ratio of the thickness to the major axis length of particles and can be measured from, for example, a projected image of a particle micrograph. A larger aspect ratio brings about a higher effect.

The inorganic layered compound that may be used in the invention has a particle size in terms of the average major axis length of 0.3 to 20 μm, preferably 0.5 to 10 μm, and more preferably 1 to 5 μm. The particles have an average thickness of up to 0.1 μm, preferably up to 0.05 μm, and more preferably up to 0.01 μm. For example, a swelling synthetic mica which is a typical one of the inorganic layered compounds has a thickness of about 1 to about 50 nm and a plane size of about 1 to about 20 μm.

Incorporation of such inorganic layered compound particles having a high aspect ratio in the protective layer improves the coating strength and prevents permeation of oxygen and moisture with high efficiency and hence deterioration of the protective layer due to deformation.

The content of the inorganic layered compound in the protective layer is preferably from 5 wt % to 55 wt %, and more preferably from 10 wt % to 40 wt % based on the total solids in the protective layer. A high resistance to adhesion is achieved at a content of 5 wt % or more and a good coatability and a high sensitivity are achieved at a content of 55 wt % or less. Even in the case of using a plurality of inorganic layered compounds in combination, the total content of the inorganic layered compounds used preferably falls within the above-defined wt % range.

The inorganic layered compound that may be used in the protective layer is dispersed, for example, by the following procedure. From 5 to 10 parts by weight of a swelling layered compound which is illustrated as a preferable inorganic layered compound is first added to 100 parts by weight of water, then fully blended with water and swelled, after which the resulting mixture is dispersed using a dispersing machine.

The dispersing machine used include, for example, a variety of mills in which mechanical power is directly applied to carry out dispersion, a high-speed agitation type dispersing machine having a large shear force and a dispersing machine providing high-intensity ultrasonic energy. Specific examples thereof include a ball mill, a sand grinder mill, a visco mill, a colloid mill, a homogenizer, a dissolver, a polytron, a homomixer, a homoblender, a keddy mill, a jet agitor, a capillary emulsifier, a liquid siren, an electromagnetic strain type ultrasonic generator and an emulsifier having a Polman whistle. The dispersion containing 5 to 10 wt % of the inorganic layered compound thus prepared is highly viscous or in the form of a gel and exhibits extremely good storage stability. In preparing a coating fluid for the protective layer using the dispersion, it is preferred that the dispersion be diluted with water, thoroughly stirred and then blended with a binder solution to prepare the coating fluid.

Flexibility may be imparted to the protective layer by adding, for example, glycerin or dipropylene glycol to the composition making up the protective layer in an amount of several wt % with respect to the water-soluble polymeric compound. In addition, anionic surfactants such as sodium alkylsulfate and sodium alkylsulfonate; amphoteric surfactants such as alkylaminocarboxylate and alkylaminodicarboxylate; and nonionic surfactants such as polyoxyethylene alkyl phenyl ether may be added in an amount of several wt % with respect to the (co)polymer. The protective layer has a thickness of preferably 0.1 to 5 μm, and more preferably 0.2 to 2 μm.

Properties such as adhesion of the protective layer to image areas and scratch resistance, are also very important in the handling of the presensitized plate. More specifically, when such a protective layer, which is hydrophilic because it contains a water-soluble polymeric compound, is laminated onto the oleophilic image recording layer, the protective layer has a tendency to delaminate owing to out-of-contact defects. In areas of delamination, defects such as poor curing of the film may arise due to the inhibition of polymerization caused by oxygen.

Various proposals have been made for improving adhesion between the image recording layer and the protective layer. For example, JP 49-70702 A mentions that sufficient adhesion can be achieved by mixing 20 to 60 wt % of an acrylic emulsion or a water-insoluble vinyl pyrrolidone-vinyl acetate copolymer into a hydrophilic polymer composed primarily of polyvinyl alcohol, and laminating the resulting mixture onto the image recording layer.

The thus prepared protective layer-forming coating fluid is applied onto the image recording layer provided on the support and dried to form the protective layer. The coating solvent may be selected as appropriate in connection with the binder, but distilled water and purified water are preferably used in cases where a water-soluble polymer is employed. No particular limitation is imposed on the method of forming the protective layer but any known methods such as those described in U.S. Pat. No. 3,458,311 and JP 55-49729 B may be applied. Examples of suitable methods of coating include blade coating, air knife coating, gravure coating, roll coating, spray coating, dip coating and bar coating.

The protective layer preferably has a coating weight after drying of 0.01 to 10 g/m², more preferably 0.02 to 3 g/m² and even more preferably 0.02 to 1 g/m².

Other functions may also be imparted to the protective layer. For example, by adding a colorant (e.g., a water-soluble dye) which has an excellent transmittance of the infrared light used for exposure and can efficiently absorb light of other wavelengths, the amenability of the presensitized plate to handling under a safelight can be improved without lowering the sensitivity.

The presensitized plate of the invention provided with such an image recording layer uses the aluminum alloy plate and the lithographic printing plate support of the invention as well as the lithographic printing plate support obtained by the lithographic printing plate support manufacturing method of the invention and is therefore rendered into a lithographic printing plate having an excellent resistance to spotting by carrying out a development process.

### EXAMPLES

### Examples 1-1 to 1-8 and Comparative Examples 1-1 to 1-5

The invention is described below in detail by way of examples. However, the invention should not be construed as being limited to the following examples.

### 1. Manufacture of Aluminum Alloy Plate

Aluminum alloys each having a composition shown in Table 1 were subjected to semicontinuous casting (DC) or continuous casting (CC).

In semicontinuous casting, the ingots formed were scalped, then sequentially subjected to heating treatment, soaking treatment, hot rolling, cold rolling, intermediate annealing, cold rolling and correction to obtain aluminum alloy plates. The soaking treatment temperature is shown in Table 1.

On the other hand, in continuous casting, hot rolling, cold rolling, intermediate annealing, cold rolling and correction were sequentially carried out to obtain aluminum alloy plates. The intermediate annealing temperature is shown in Table 1.

The iron content in solid solution (wt %) and the contents of intermetallic compounds and aluminum-iron intermetallic compounds in the resulting aluminum alloy plates were measured by the methods described below. The results are shown in Table 1.

<Iron Content in Solid Solution>

The iron content in solid solution is obtained by the following procedure: The resulting aluminum alloy plate is dissolved in hot phenol, and the dissolved matrix and the intermetallic compounds as the dissolution residues are filtered off; the fine intermetallic compounds in the filtrate are further separated by extraction using a 10% citric acid solution; and the iron content in the filtrate following the separation is measured by an inductively coupled plasma emission spectrometer (ICP-ES).

<Contents of Intermetallic Compounds and Aluminum-Iron Intermetallic Compounds>

The intermetallic compounds in the aluminum alloy were measured by XRD.

More specifically, an X-ray diffractometer RAD-rR (manufactured by Rigaku Corporation) was used to calculate the integral diffraction intensity values (unit: Kcounts) for the iron intermetallic compound phases (Al₃Fe, Al₆Fe, α-AlFeSi) detected under the following measurement conditions.
Set tube voltage: 50 kV;
Set tube current: 200 mA;
Sampling interval: 0.01°;
Scanning rate: 1°/min;
2θ Scan range: 10° to 70°;
A graphite monochromator was used.

The integral diffraction intensity values of Al₃Fe:24.0°, Al₆Fe:18.0°, and α-AlFeSi:42.0° were used from the X-ray chart obtained by the measurement.

Subsequently, the content of the aluminum-iron intermetallic compounds was calculated by the following expression:

Content of aluminum-iron intermetallic compounds (wt %)={iron content (wt %)−iron content in solid solution (wt %)}×{(sum of integral diffraction intensities in aluminum-iron intermetallic compound phase peaks as detected by XRD)/(sum of integral diffraction intensities in iron phase peaks as detected by XRD)}

The aluminum-iron intermetallic compounds include Al₃Fe and Al₆Fe, and the iron phases include Al₃Fe, Al₆Fe and α-AlFeSi phases. In cases where no peak appeared, the integral diffraction intensity was calculated as 0.1.

TABLE 1

| | | | | | | | | | | | | Soaking | Intermediate |
|---|---|---|---|---|---|---|---|---|---|---|---|---|---|
| | Chemical composition (wt %) | | | | | | | | | | Casting | temperature | annealing |
| | Si | Fe | Cu | Mg | Zn | Mn | Cr | Ti | Bal. | Fe/Si | method | (° C.) | temperature (° C.) |
| EX 1-1 | 0.13 | 0.26 | 0.012 | 0.003 | 0.001 | 0.001 | 0.001 | 0.014 | Al | 2.0 | CC | — | 350 |
| EX 1-2 | 0.12 | 0.12 | 0.012 | 0.170 | 0.003 | 0.003 | 0.001 | 0.012 | Al | 1.0 | DC | 520 | — |
| EX 1-3 | 0.08 | 0.11 | 0.012 | 0.145 | 0.003 | 0.003 | 0.001 | 0.012 | Al | 1.4 | DC | 520 | — |
| EX 1-4 | 0.20 | 0.11 | 0.012 | 0.000 | 0.003 | 0.003 | 0.001 | 0.012 | Al | 0.6 | DC | 550 | — |
| EX 1-5 | 0.14 | 0.24 | 0.014 | 0.002 | 0.003 | 0.003 | 0.001 | 0.018 | Al | 1.7 | DC | 500 | — |
| EX 1-6 | 0.20 | 0.38 | 0.015 | 0.002 | 0.002 | 0.002 | 0.001 | 0.012 | Al | 1.9 | DC | 500 | — |
| EX 1-7 | 0.13 | 0.26 | 0.012 | 0.003 | 0.001 | 0.001 | 0.001 | 0.014 | Al | 2.0 | CC | — | — |
| EX 1-8 | 0.13 | 0.26 | 0.012 | 0.003 | 0.001 | 0.001 | 0.001 | 0.014 | Al | 2.0 | CC | — | — |
| CE 1-1 | 0.10 | 0.10 | 0.012 | 0.002 | 0.003 | 0.003 | 0.001 | 0.006 | Al | 1.0 | DC | 600 | — |
| CE 1-2 | 0.06 | 0.30 | 0.014 | 0.012 | 0.002 | 0.002 | 0.001 | 0.029 | Al | 5.0 | DC | 600 | — |
| CE 1-3 | 0.08 | 0.28 | 0.001 | 0.002 | 0.003 | 0.003 | 0.001 | 0.018 | Al | 3.5 | DC | 600 | — |
| CE 1-4 | 0.10 | 0.25 | 0.036 | 0.000 | 0.003 | 0.003 | 0.001 | 0.015 | Al | 2.5 | DC | 600 | — |
| CE 1-5 | 0.08 | 0.36 | <0.001 | 0.002 | 0.009 | 0.004 | 0.001 | 0.006 | Al | 4.5 | DC | 600 | — |

| | | XRD (integral | | | |
|---|---|---|---|---|---|
| | Iron content in | diffraction | | | |
| | solid solution | intensity) | | | Content of Al—Fe |
| | (wt %) | Al₃Fe | Al₆Fe | α-AlFeSi | compounds (wt %) |
| EX 1-1 | 0.0010 | <0.1 | <0.1 | 5.4 | 0.009 |
| EX 1-2 | 0.0029 | <0.1 | <0.1 | 2.4 | 0.009 |
| EX 1-3 | 0.0038 | <0.1 | <0.1 | 2.2 | 0.009 |
| EX 1-4 | 0.0010 | <0.1 | <0.1 | 2.4 | 0.009 |
| EX 1-5 | 0.0010 | <0.1 | 1.2 | 5.8 | 0.044 |
| EX 1-6 | 0.0040 | 0.2 | 1.3 | 10.3 | 0.048 |
| EX 1-7 | 0.0010 | <0.1 | <0.1 | 5.4 | 0.009 |
| EX 1-8 | 0.0010 | <0.1 | <0.1 | 5.4 | 0.009 |
| CE 1-1 | 0.0028 | 2.2 | <0.1 | <0.1 | 0.093 |
| CE 1-2 | 0.0025 | 13.7 | 1.0 | <0.1 | 0.281 |
| CE 1-3 | 0.0024 | 13.1 | <0.1 | <0.1 | 0.276 |
| CE 1-4 | 0.0031 | 11.1 | <0.1 | <0.1 | 0.244 |
| CE 1-5 | 0.0025 | 10.1 | <0.1 | <0.1 | 0.368 |

### 2. Manufacture of Lithographic Printing Plate Support

The respective aluminum alloy plates manufactured as described above were subjected to the treatments under one of the following conditions (A) to (C) as shown in Table 2 to thereby manufacture lithographic printing plate supports. Rinsing treatment was carried out among all the treatment steps and the water following rinsing treatment was removed with nip rollers.

### <Treatment (A)>

(A-a) Mechanical Graining Treatment (Brush Graining)

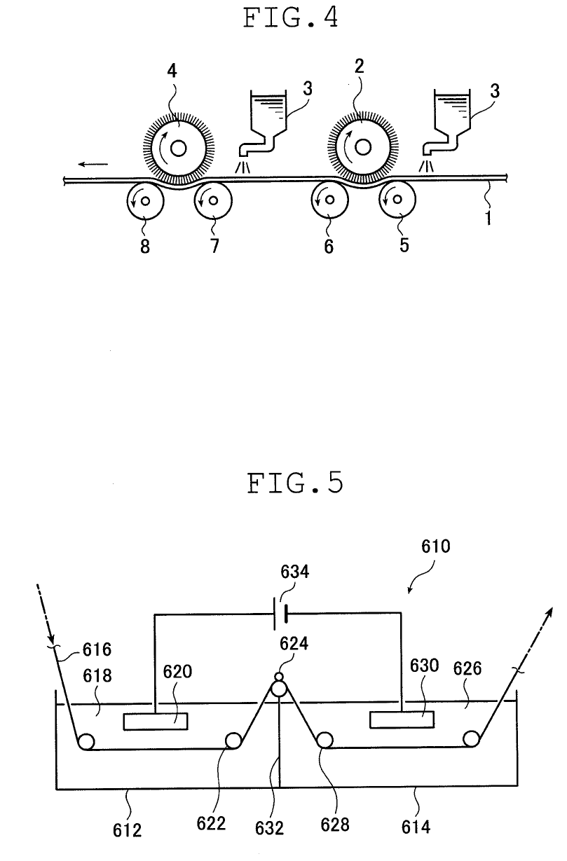

Mechanical graining treatment was carried out with rotating bristle bundle brushes of an apparatus as shown in FIG. 4 while feeding an abrasive slurry in the form of a suspension of pumice having a specific gravity of 1.1 g/cm³ to the surface of the aluminum alloy plate. FIG. 4 shows an aluminum alloy plate 1, roller-type brushes (bristle bundle brushes in Examples) 2 and 4, an abrasive-containing slurry 3, and support rollers 5, 6, 7 and 8.

Mechanical graining treatment was carried out using an abrasive having a median diameter of 30 μm while rotating four brushes at 250 rpm. The bristle bundle brushes were made of nylon 6/10 and had a bristle diameter of 0.3 mm and a bristle length of 50 mm. Each brush was constructed of a 300 mm diameter stainless steel cylinder in which holes had been formed and bristles densely set. Two support rollers (200 mm diameter) were provided below each bristle bundle brush and spaced 300 mm apart. The bundle bristle brushes were pressed against the aluminum alloy plate until the load on the driving motor that rotates the brushes was 10 kW greater than before the bundle bristle brushes were pressed against the plate. The direction in which the brushes were rotated was the same as the direction in which the aluminum alloy plate was moved.

(A-b) Alkali Etching Treatment

Etching treatment was carried out by using a spray line to spray the aluminum alloy plate obtained as described above with an aqueous solution having a sodium hydroxide concentration of 26 wt %, an aluminum ion concentration of 6.5 wt %, and a temperature of 70° C. The plate was subsequently rinsed by spraying with water. The amount of dissolved aluminum was 10 g/m².

(A-c) Desmutting Treatment in Aqueous Acid Solution

Next, desmutting treatment was carried out in an aqueous nitric acid solution. The nitric acid wastewater from the subsequent electrochemical graining treatment step was used for the aqueous nitric acid solution in desmutting treatment. The solution temperature was 35° C. Desmutting treatment was carried out by spraying the plate with the desmutting solution for 3 seconds.

(A-d) Electrochemical Graining Treatment

Electrochemical graining treatment was consecutively carried out by nitric acid electrolysis using a 60 Hz AC voltage. Aluminum nitrate was added to an aqueous solution containing 10.4 g/L of nitric acid at a temperature of 35° C. to prepare an electrolytic solution having an adjusted aluminum ion concentration of 4.5 g/L, and the electrolytic solution was used in electrochemical graining treatment. Electrochemical graining treatment was carried out for a period of time TP until the current reached a peak from zero of 0.8 ms, at a duty ratio of 1:1, using an alternating current having a trapezoidal waveform shown in FIG. 2, with a carbon electrode as the counter electrode. A ferrite was used for the auxiliary anodes. An electrolytic cell of the type shown in FIG. 3 was used. The current density at the current peak was 30 A/dm². Of the current that flows from the power supply, 5% was diverted to the auxiliary anodes. The amount of electricity (C/dm²), which is the total amount of electricity when the aluminum alloy plate serves as an anode, was 185 C/dm². The plate was then rinsed by spraying with water.

(A-e) Alkali Etching Treatment

Etching treatment was carried out by using a spray line to spray the aluminum alloy plate obtained as described above with an aqueous solution having a sodium hydroxide concentration of 5 wt %, an aluminum ion concentration of 0.5 wt %, and a temperature of 50° C. The plate was then rinsed by spraying with water. The amount of dissolved aluminum was 0.5 g/m².

(A-f) Desmutting Treatment in Aqueous Acid Solution

Next, desmutting treatment was carried out in an aqueous sulfuric acid solution. The aqueous sulfuric acid solution used in desmutting treatment was a solution having a sulfuric acid concentration of 300 g/L and an aluminum ion concentration of 5 g/L. The solution temperature was 60° C. Desmutting treatment was carried out by spraying the plate with the desmutting solution for 3 seconds.

(A-g) Electrochemical Graining Treatment

Electrochemical graining treatment was consecutively carried out by hydrochloric acid electrolysis using a 60 Hz AC voltage. Aluminum chloride was added to an aqueous solution containing 6.2 g/L of hydrochloric acid at a temperature of 35° C. to prepare an electrolytic solution having an adjusted aluminum ion concentration of 4.5 g/L, and the electrolytic solution was used in electrochemical graining treatment. Electrochemical graining treatment was carried out for a period of time TP until the current reached a peak from zero of 0.8 ms, at a duty ratio of 1:1, using an alternating current having a trapezoidal waveform shown in FIG. 2, with a carbon electrode as the counter electrode. A ferrite was used for the auxiliary anodes. An electrolytic cell of the type shown in FIG. 3 was used.

The current density at the current peak was 25 A/dm². The amount of electricity (C/dm²) in hydrochloric acid electrolysis, which is the total amount of electricity when the aluminum alloy plate serves as an anode, was 63 C/dm². The plate was then rinsed by spraying with water.

(A-h) Alkali Etching Treatment

Etching treatment was carried out by using a spray line to spray the aluminum alloy plate obtained as described above with an aqueous solution having a sodium hydroxide concentration of 5 wt %, an aluminum ion concentration of 0.5 wt %, and a temperature of 50° C. The plate was then rinsed by spraying with water. The amount of dissolved aluminum was 0.1 g/m².

(A-i) Desmutting Treatment in Aqueous Acid Solution

Next, wastewater generated in the anodizing treatment step (aqueous solution containing 170 g/L of sulfuric acid and 5 g/L of aluminum ions dissolved therein) was used to carry out desmutting treatment at a solution temperature of 35° C. for 4 seconds.

(A-j) Anodizing Treatment

Anodizing treatment was carried out by DC electrolysis using an anodizing apparatus of the structure as shown in FIG. 5 to obtain a lithographic printing plate support. Sulfuric acid was used for the electrolytic solution for supplying to a first and a second electrolysis portion. Each electrolytic solution contained 170 g/L of sulfuric acid and 5 g/L of aluminum ions. Anodizing treatment was carried out by DC electrolysis at an average current density of 20 A/dm² so that an anodized film having a coating weight of 2.7 g/m² could be formed. The solution temperature was 40° C., the voltage was 5 to 30 V and the time was 10 seconds.

(A-k) Silicate Treatment

In order to ensure the hydrophilicity in non-image areas, silicate treatment was carried out by dipping the plate into an aqueous solution containing 2.5 wt % of No. 3 sodium silicate at 70° C. for 7 seconds. The amount of deposited silicon was 10 mg/m². The plate was then rinsed by spraying with water.

### <Treatment (B)>

(B-a) Etching Treatment in Aqueous Alkali Solution (First Etching Treatment)

Etching treatment was carried out by immersing the aluminum alloy plate in an aqueous solution having a sodium hydroxide concentration of 27 wt %, an aluminum ion concentration of 6.5 wt %, and a temperature of 70° C. Sodium aluminate was used to adjust the aluminum ion concentration. The amount of aluminum dissolved from the surface to be subjected to electrochemical graining treatment was 1 g/m².

The plate was then rinsed by spraying with water.

(B-b) Desmutting Treatment in Aqueous Acid Solution (First Desmutting Treatment)

Next, desmutting treatment was carried out in an aqueous acid solution. The aqueous acid solution used in desmutting treatment was an aqueous solution containing 150 g/L of sulfuric acid at a temperature of 35° C., and desmutting treatment was carried out by immersion for 5 seconds.

Then, rinsing treatment was carried out.

(B-c) Electrochemical Graining Treatment in Aqueous Hydrochloric Acid Solution

Next, electrolytic graining treatment was carried out using an alternating current in an electrolytic solution having a hydrochloric acid concentration of 14 g/L, an aluminum ion concentration of 13 g/L and a sulfuric acid concentration of 3 g/L. The electrolytic solution has a temperature of 30° C. Aluminum chloride was added to adjust the aluminum ion concentration.

The alternating current had a sinusoidal waveform whose positive and negative sides were symmetric; the frequency was 50 Hz; the ratio of the anodic reaction time to the cathodic reaction time in one cycle of alternating current was 1/1; and the current density at the current peak in the AC waveform was 75 A/dm². The total amount of electricity furnished for the anodic reaction on the aluminum alloy plate was 450 C/dm² and the aluminum alloy plate was electrolyzed four times by respectively applying 125 C/dm² of electricity at intervals of 4 seconds. A carbon electrode was used as the counter electrode of the aluminum alloy plate.

Then, rinsing treatment was carried out.

(B-d) Etching Treatment in Aqueous Alkali Solution (Second Etching Treatment)

Etching treatment was carried out by immersing the aluminum alloy plate following electrochemical graining treatment in an aqueous solution having a sodium hydroxide concentration of 5 wt %, an aluminum ion concentration of 0.5 wt % and a temperature of 35° C. so that the amount of aluminum dissolved from the surface having undergone electrochemical graining treatment was 0.1 g/m². Sodium aluminate was used to adjust the aluminum ion concentration.

Then, rinsing treatment was carried out.

(B-e) Desmutting Treatment in Aqueous Acid Solution (Second Desmutting Treatment)

Next, desmutting treatment was carried out in an aqueous acid solution. The aqueous acid solution used in desmutting treatment was wastewater generated in the anodizing treatment step (aqueous solution containing 170 g/L of sulfuric acid and 5.0 g/L of aluminum ions dissolved therein), and desmutting treatment was carried out by immersing the plate in the wastewater having a temperature of 30° C. for 5 seconds.

(B-f) Anodizing Treatment

Next, an anodizing apparatus was used to carry out anodizing treatment.

Use was made of an electrolytic solution at a temperature of 45° C. having an aluminum ion concentration adjusted to 5 g/L by dissolving aluminum sulfate in 170 g/L of aqueous sulfuric acid solution. Anodizing treatment was carried out at a current density of 30 A/dm² so that the anodized film had a coating weight of 2.7 g/m². A carbon electrode was used as the counter electrode of the aluminum alloy plate.

Then, rinsing treatment was carried out.

(B-g) Hydrophilizing Treatment

The aluminum alloy plate following anodizing treatment was immersed in an aqueous solution containing 1.0 wt % of No. 3 sodium silicate (solution temperature: 22° C.) for 8 seconds. The amount of silicon deposited on the aluminum alloy plate surface as measured by a fluorescent X-ray spectrometer was 3.5 mg/m².

Following rinsing with water and removal of the remaining water with nip rollers, air at a temperature of 90° C. was further blown for 10 seconds to dry the plate to obtain a lithographic printing plate support.

### <Treatment (C)>

The treatment process (A) was carried out except that mechanical graining treatment (A-a) was not carried out and that the total amount of electricity in electrochemical graining treatment (A-d) was changed to 220 C/dm² thereby obtaining a lithographic printing plate.

### 3. Manufacture of Presensitized Plate

An undercoat-forming coating solution of the composition indicated below was applied onto each lithographic printing plate support manufactured as described above to a coating weight after drying of 28 mg/m² to thereby form an undercoat.

<Composition of Undercoat-Forming Coating Solution>

| | | |
|---|---|---|
| * Undercoating compound (1) of the structure | 0.18 | g |
| shown below | | |
| 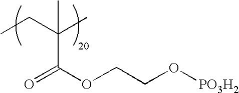 | | |
| 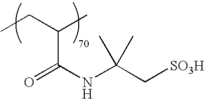 | | |
| 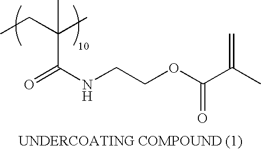 | | |
| * Hydroxyethylimino diacetic acid | 0.10 | g |
| * Methanol | 55.24 | g |
| * Water | 6.15 | g |

Then, an image recording layer-forming coating fluid was applied onto the thus formed undercoat by bar coating and dried in an oven at 100° C. for 60 seconds to form an image recording layer having a coating weight after drying of 1.3 g/m².

The image recording layer-forming coating fluid was obtained by mixing with stirring the photosensitive solution and microgel fluid shown below just before use in application.

<Photosensitive Solution>

| | |
|---|---|
| Binder polymer (1) | 0.24 g |
| Infrared absorber (1) | 0.030 g |
| Radical polymerization initiator (1) | 0.162 g |
| Polymerizable compound, tris (acryloyloxyethyl) | 0.192 g |
| isocyanurate (NK ester A-9300 available from | |
| Shin-nakamura Chemical Corporation) | |
| Low-molecular-weight hydrophilic compound, | 0.062 g |
| tris (2-hydroxyethyl) isocyanurate | |
| Low-molecular-weight hydrophilic compound (1) | 0.052 g |
| [structure shown below] | |
| Sensitizer | 0.055 g |
| Phosphonium compound (1) | |
| [structure shown below] | |
| Sensitizer | 0.018 g |
| Benzyl-dimethyl-octyl ammonium•PF₆ salt | |
| Betaine derivative | 0.010 g |
| Fluorochemical surfactant (1) | 0.008 g |
| [structure shown below] | |
| Methyl ethyl ketone | 1.091 g |
| 1-Methoxy-2-propanol | 8.609 g |
| <Microgel Fluid> | |
| Micogel (1) | 2.640 g |
| Distilled water | 2.425 g |

The binder polymer (1), the infrared absorber (1), the radical polymerization initiator (1), the phosphonium compound (1), the low-molecular-weight hydrophilic compound (1) and the fluorochemical surfactant (1) have the structures represented by the following formulas:

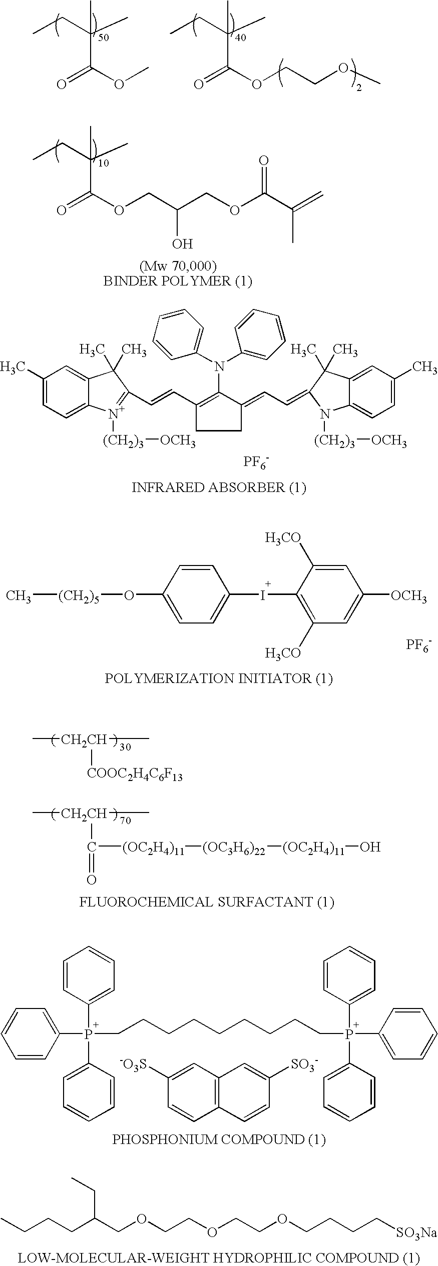

The microgel (1) was synthesized by the following procedure.

<Synthesis of Microgel (1)>

For the oil phase component, 10 g of an adduct of trimethylolpropane with xylene diisocyanate (Takenate D-110N available from Mitsui Takeda Chemical Industries, Ltd.), 3.15 g of pentaerythritol triacrylate (SR444 available from Nippon Kayaku Co., Ltd.) and 0.1 g of Pionin A-41C (available from Takemoto Oil & Fat Co., Ltd.) were dissolved in 17 g of ethyl acetate. For the aqueous phase component, 40 g of a 4 wt % aqueous solution of PVA-205 was prepared. The oil phase component and the aqueous phase component were mixed and emulsified in a homogenizer at 12,000 rpm for 10 minutes. The resulting emulsion was added to 25 g of distilled water and the mixture was stirred at room temperature for 30 minutes, then at 50° C. for 3 hours. The thus obtained microgel fluid was diluted with distilled water so as to have a solids concentration of 15 wt % and used as the microgel (1). The average particle size of the microgel as measured by a light scattering method was 0.2 μm.

Then, a protective layer-forming coating fluid of the composition indicated below was applied onto the thus formed image recording layer by bar coating and dried in an oven at 120° C. for 60 seconds to form a protective layer having a coating weight after drying of 0.15 g/m², thereby obtaining a presensitized plate.

<Protective Layer-Forming Coating Fluid>

| | |
|---|---|
| Dispersion of an inorganic layered compound (1) | 1.5 g |
| 6 wt % Aqueous solution of polyvinyl alcohol | 0.55 g |
| (CKS50; modified with sulfonic acid; degree | |
| of saponification: at least 99 mol %; degree | |
| of polymerization: 300; available from | |
| Nippon Synthetic Chemical Industry Co., Ltd.) | |
| 6 wt % Aqueous solution of polyvinyl alcohol | 0.03 g |
| (PVA-405; degree of saponification: 81.5 mol %; | |
| degree of polymerization: 500; available from | |
| Kuraray Co., Ltd.) | |
| 1 wt % Aqeuous solution of the surfactant | 8.60 g |
| (EMALEX 710 available from Nihon | |
| Emulsion Co., Ltd.) | |
| Ion exchanged water | 6.0 g |

The dispersion of the inorganic layered compound (1) was prepared by the following procedure.

### (Preparation of Dispersion of Inorganic Layered Compound (1))

To 193.6 g of ion exchanged water was added 6.4 g of synthetic mica Somasif ME-100 (available from Co-Op chemical Co., Ltd.) and the mixture was dispersed in a homogenizer to an average particle size as measured by a laser scattering method of 3 μm. The resulting dispersed particles had an aspect ratio of at least 100.

### 4. Evaluation of Resistance to Spotting

The resulting presensitized plate was conditioned with a slip sheet at 25° C. and 70% RH for 1 hour, wrapped with aluminum kraft paper and heated in an oven set at 60° C. for 5 days.

Then, the temperature was lowered to room temperature and the plate was mounted onto a plate cylinder of a printing press (LITHRONE 26 manufactured by Komori Corporation) without development process.

Use was made of fountain solution of Ecolity-2 (available from FUJIFILM Corporation)/tap water (volume ratio: 2/98) and black ink Values-G(N) (available from Dainippon Ink and Chemicals, Inc.). The fountain solution and ink were supplied according to the standard automatic print starting method of LITHRONE 26 and on-machine development was carried out, after which printing was made on 500 sheets of Tokubishi Art Paper (76.5kg).

The 500th print was visually checked and the number of print stains having a size of at least 20 μm per 100 cm² was counted. The results are shown in Table 2.

At a number of stains of up to 200 per 100 cm², the presensitized plate can be evaluated as having a good resistance to severe scumming.

TABLE 2

| | | Content of Al- | | Number of printing stains |
|---|---|---|---|---|
| | | Fe compounds | Treatment | with a size of at least |
| | Fe/Si | (wt %) | condition | 20 μm per 100 cm² |
| EX 1-1 | 2.0 | 0.009 | A | 60 |
| EX 1-2 | 1.0 | 0.009 | A | 25 |
| EX 1-3 | 1.4 | 0.009 | A | 40 |
| EX 1-4 | 0.6 | 0.009 | A | 80 |
| EX 1-5 | 1.7 | 0.044 | A | 150 |
| EX 1-6 | 1.9 | 0.048 | A | 170 |
| EX 1-7 | 2.0 | 0.009 | B | 60 |
| EX 1-8 | 2.0 | 0.009 | C | 60 |
| CE 1-1 | 1.0 | 0.093 | A | 250 |
| CE 1-2 | 5.0 | 0.281 | A | 600 |
| CE 1-3 | 3.5 | 0.276 | A | 500 |
| CE 1-4 | 2.5 | 0.244 | A | 300 |
| CE 1-5 | 4.5 | 0.368 | A | 550 |

As is seen from Tables 1 and 2, the resistance to spotting is improved with the decrease of the content of the aluminum-iron intermetallic compounds. As described above, this supports the novel finding that the aluminum-iron intermetallic compounds become starting points for corrosion of the aluminum alloy plate.

### Examples 2-1 to 2-9 and Comparative Examples 2-1 to 2-7

The invention is described below in detail by way of examples. However, the invention should not be construed as being limited to the following examples.

### 1. Manufacture of Aluminum Alloy Plate

Aluminum alloy melts of the compositions shown in Table 3 were subjected to semicontinuous casting to prepare ingots.

Then, the resulting ingots were scalped, then sequentially subjected to heating treatment, soaking treatment, hot rolling, cold rolling, intermediate annealing, cold rolling and correction to obtain aluminum alloy plates each having a thickness of 0.3 to 0.4 mm.

The thickness of the ingot following semicontinuous casting (thickness of the cast plate), the amount of material removed by scalping, the soaking treatment temperature and the plate thickness following the second cold rolling (thickness of the rolled plate) are shown in Table 3.

TABLE 3

| | | | | | | | | | | | Amount of | | |
|---|---|---|---|---|---|---|---|---|---|---|---|---|---|
| | | | | | | | | | | | material | | |
| | | | | | | | | | | Cast plate | removed by | Soaking | Rolled plate |
| | Chemical composition (wt %) | | | | | | | | | thickness | scalping | temperature | thickness |
| | Si | Fe | Cu | Mg | Zn | Mn | Cr | Ti | Bal. | (mm) | (mm) | (° C.) | (mm) |
| EX 2-1 | 0.08 | 0.30 | 0.012 | 0.003 | 0.001 | 0.001 | 0.001 | 0.014 | Al | 500 | 3.0 | 500 | 0.3 |
| EX 2-2 | 0.08 | 0.30 | 0.012 | 0.003 | 0.001 | 0.001 | 0.001 | 0.014 | Al | 500 | 5.0 | 500 | 0.3 |
| EX 2-3 | 0.08 | 0.30 | 0.012 | 0.003 | 0.001 | 0.001 | 0.001 | 0.014 | Al | 500 | 7.5 | 500 | 0.3 |
| EX 2-4 | 0.08 | 0.30 | 0.012 | 0.003 | 0.001 | 0.001 | 0.001 | 0.014 | Al | 500 | 7.5 | 500 | 0.3 |
| EX 2-5 | 0.08 | 0.30 | 0.012 | 0.003 | 0.001 | 0.001 | 0.001 | 0.014 | Al | 300 | 3.0 | 500 | 0.4 |
| EX 2-6 | 0.08 | 0.30 | 0.012 | 0.003 | 0.001 | 0.001 | 0.001 | 0.014 | Al | 300 | 1.0 | 500 | 0.4 |
| EX 2-7 | 0.08 | 0.12 | 0.012 | 0.003 | 0.001 | 0.001 | 0.001 | 0.014 | Al | 500 | 3.0 | 500 | 0.3 |
| EX 2-8 | 0.08 | 0.30 | 0.012 | 0.003 | 0.001 | 0.001 | 0.001 | 0.014 | Al | 500 | 10.0 | 500 | 0.3 |
| EX 2-9 | 0.08 | 0.30 | 0.012 | 0.003 | 0.001 | 0.001 | 0.001 | 0.014 | Al | 500 | 10.0 | 500 | 0.3 |
| CE 2-1 | 0.08 | 0.06 | 0.012 | 0.003 | 0.001 | 0.001 | 0.001 | 0.014 | Al | 500 | 5.0 | 500 | 0.3 |
| CE 2-2 | 0.08 | 0.48 | 0.012 | 0.003 | 0.001 | 0.001 | 0.001 | 0.014 | Al | 500 | 5.0 | 500 | 0.3 |
| CE 2-3 | 0.04 | 0.30 | 0.012 | 0.003 | 0.001 | 0.001 | 0.001 | 0.014 | Al | 500 | 5.0 | 500 | 0.3 |
| CE 2-4 | 0.22 | 0.30 | 0.012 | 0.003 | 0.001 | 0.001 | 0.001 | 0.014 | Al | 500 | 5.0 | 500 | 0.3 |
| CE 2-5 | 0.08 | 0.30 | 0.012 | 0.003 | 0.001 | 0.001 | 0.001 | 0.014 | Al | 500 | 15.0 | 500 | 0.3 |
| CE 2-6 | 0.08 | 0.30 | 0.012 | 0.003 | 0.001 | 0.001 | 0.001 | 0.014 | Al | 500 | 5.0 | 500 | 0.3 |
| CE 2-7 | 0.08 | 0.30 | 0.012 | 0.003 | 0.001 | 0.001 | 0.001 | 0.014 | Al | 500 | 10.0 | 500 | 0.3 |

The strength and flatness of the resulting aluminum alloy plates were determined by the methods described below and the ion content in solid solution (wt %) and the contents of the intermetallic compounds and the aluminum-iron intermetallic compounds were measured by the methods described above. The results are shown in Table 4.

<Strength (Tensile Stress)>

A specimen having a width of 25 mm and a length of 100 mm was used to make a tensile test according to JIS Z 2241 (method of tensile test for metallic materials) on the resulting aluminum alloy plate using an autograph (AGS-H manufactured by Shimadzu Corporation) at a tensile rate of 2 mm/min.

Then, the maximum stress was read from the resulting stress-distortion curve and the average (average between two points) was divided by the cross-sectional area to calculate the tensile stress. The cross-sectional area was obtained by multiplying the measured thickness of the specimen by 25 mm.

Consequently, at a tensile stress of 145 to 180 MPa, the lithographic printing plate may fit well on the plate cylinder of a printing press when mounted thereon, and the edges thereof may be prevented from being broken during printing.

<Flatness>

The flatness of the resulting aluminum alloy plates was visually checked. The plate on which no scalping chips remained was rated “good” as having a good flatness, and the plate on which scalping chips remained was rated “fair” as having a sufficient flatness to pose no practical problem.

TABLE 4

| | | | | XRD (integral diffraction | | | |
|---|---|---|---|---|---|---|---|
| | Strength | | Iron content in | intensity) | | | Content of Al—Fe |
| | (MPa) | Flatness | solid solution (wt %) | Al₃Fe | Al₆Fe | α-AlFeSi | compounds (wt %) |
| EX 2-1 | 165 | Good | 0.0025 | 0.2 | <0.1 | 5.8 | 0.015 |
| EX 2-2 | 165 | Good | 0.0024 | 0.3 | <0.1 | 6.2 | 0.018 |
| EX 2-3 | 165 | Good | 0.0025 | 0.3 | <0.1 | 4.8 | 0.023 |
| EX 2-4 | 165 | Good | 0.0025 | 0.2 | <0.1 | 5.3 | 0.016 |
| EX 2-5 | 148 | Good | 0.0023 | 0.2 | <0.1 | 7.2 | 0.012 |
| EX 2-6 | 148 | Fair | 0.0023 | <0.1 | <0.1 | 3.5 | 0.016 |
| EX 2-7 | 150 | Good | 0.0021 | <0.1 | <0.1 | 6.2 | 0.004 |
| EX 2-8 | 165 | Good | 0.0025 | 0.3 | <0.1 | 4.8 | 0.023 |
| EX 2-9 | 165 | Good | 0.0024 | 0.2 | <0.1 | 4.2 | 0.020 |
| CE 2-1 | 140 | Good | 0.0020 | 0.2 | <0.1 | 6.2 | 0.003 |
| CE 2-2 | 200 | Good | 0.0028 | 5.2 | <0.1 | 3.2 | 0.298 |
| CE 2-3 | 158 | Good | 0.0025 | 4.8 | <0.1 | 2 | 0.211 |
| CE 2-4 | 165 | Good | 0.0026 | <0.1 | <0.1 | 11.2 | 0.005 |
| CE 2-5 | 165 | Good | 0.0025 | 0.3 | <0.1 | 6.2 | 0.018 |
| CE 2-6 | 165 | Good | 0.0024 | 0.3 | <0.1 | 6.2 | 0.018 |
| CE 2-7 | 165 | Good | 0.0025 | 0.3 | <0.1 | 4.3 | 0.025 |

### 2. Manufacture of Lithographic Printing Plate Support

The respective aluminum alloy plates manufactured as described above were subjected to the same treatments as described in (A-a) to (A-j) except that the content of aluminum dissolved in alkali etching treatment (A-e) and the amount (thickness) of anodized film obtained by anodizing treatment (A-j) were as shown in Table 5, thereby manufacturing lithographic printing plate supports. Rinsing treatment was carried out among all the treatment steps and the water following rinsing treatment was removed with nip rollers.

Table 5 shows the thickness (X; mm) of the ingot following the semicontinuous casting step, the plate thickness (Y; mm) following the cold rolling step, the amount (A; mm) of material removed by scalping, the amount (B; μm) of material removed by the surface roughening treatment, the thickness (C; μm) of the anodized film, and the distance (Z; mm) from the interface between the anodized film and the aluminum alloy plate to the surface of the ingot following the semicontinuous casting step as included in the formula (i).

The resulting lithographic printing plate supports were evaluated for the scratch resistance by the method described below. The results are shown in Table 5.

<Scratch Resistance>

The surface of the resulting lithographic printing plate support was subjected to a scratch test to evaluate the scratch resistance of the lithographic printing plate support.

The scratch test was carried out using a continuous loading scratching intensity tester (SB-53 manufactured by Shinto Scientific Co., Ltd.) while moving a sapphire needle with a diameter of 0.4 mm at a moving velocity of 10 cm/s at a load of 100 g.

As a result, the support in which scratches due to the needle did not reach the surface of the aluminum alloy plate (base) was rate “good” as having an excellent scratch resistance and the support in which scratches reached the plate surface was rated “fair” as having no practical problem although the scratch resistance was more or less low. The lithographic printing plate support exhibiting an excellent scratch resistance at a load of 100 g can suppress the scratches from transferring to the image recording layer when the presensitized plate prepared therefrom is mounted on the plate cylinder or superposed on another, thus reducing scumming in non-image areas.

TABLE 5

| | | | | | Thickness of | | | |
|---|---|---|---|---|---|---|---|---|
| | Amount of material | | | Amount of | material | | | |
| | removed by alkali | Thickness | Thickness | material | removed by | | | |
| | etching after | of cast | of rolled | removed by | surface | Thickness of | | |
| | nitric acid | plate | plate | scalping | roughening | anodized film | | |
| | electrolysis | X | Y | A | B | C | Z | Scratch |
| | (g/m²) | (mm) | (mm) | (mm) | (μm) | (μm) | (mm) | Resistance |
| EX 2-1 | 10 | 500 | 0.3 | 3.0 | 5.0 | 1.0 | 13 | Good |
| EX 2-2 | 10 | 500 | 0.3 | 5.0 | 5.0 | 1.0 | 15 | Good |
| EX 2-3 | 10.0 | 500 | 0.3 | 7.5 | 5.0 | 1.0 | 17 | Good |
| EX 2-4 | 5.0 | 500 | 0.3 | 7.5 | 3.0 | 1.0 | 14 | Good |
| EX 2-5 | 5 | 300 | 0.4 | 3.0 | 3.0 | 1.0 | 6 | Good |
| EX 2-6 | 5.0 | 300 | 0.4 | 1.0 | 3.0 | 1.0 | 4 | Good |
| EX 2-7 | 10.0 | 500 | 0.3 | 3.0 | 5.0 | 1.0 | 13 | Good |
| EX 2-8 | 10.0 | 500 | 0.3 | 10.0 | 5.0 | 1.0 | 20 | Good |
| EX 2-9 | 10.0 | 500 | 0.3 | 10.0 | 5.0 | 0.2 | 19 | Fair |
| CE 2-1 | 10.0 | 500 | 0.3 | 5.0 | 5.0 | 1.0 | 15 | Good |
| CE 2-2 | 10.0 | 500 | 0.3 | 5.0 | 5.0 | 1.0 | 15 | Good |
| CE 2-3 | 10.0 | 500 | 0.3 | 5.0 | 5.0 | 1.0 | 15 | Good |
| CE 2-4 | 10.0 | 500 | 0.3 | 5.0 | 5.0 | 1.0 | 15 | Good |
| CE 2-5 | 10.0 | 500 | 0.3 | 15.0 | 5.0 | 1.0 | 25 | Good |
| CE 2-6 | 24 | 500 | 0.3 | 5.0 | 10.0 | 1.0 | 23 | Good |
| CE 2-7 | 10.0 | 500 | 0.3 | 10.0 | 5.0 | 2.0 | 21 | Good |

### 3. Manufacture of Presensitized Plate

Un undercoat was formed on each of the lithographic printing plate supports manufactured as described above in the same manner as in Example 1-1.

### 4. Evaluation of Resistance to Spotting

The resulting presensitized plate was evaluated for the resistance to spotting in the same manner as in Example 1-1. The results are shown in Table 6.

TABLE 6

| | Z | Number of printing stains with a |
|---|---|---|
| | (mm) | size of at least 20 μm per 100 cm² |
| EX 2-1 | 13 | 100 |
| EX 2-2 | 15 | 150 |
| EX 2-3 | 17 | 180 |
| EX 2-4 | 14 | 125 |
| EX 2-5 | 6 | 70 |
| EX 2-6 | 4 | 50 |
| EX 2-7 | 13 | 25 |
| EX 2-8 | 20 | 195 |
| EX 2-9 | 19 | 190 |
| CE 2-1 | 15 | 5 |
| CE 2-2 | 15 | 500 |
| CE 2-3 | 15 | 250 |
| CE 2-4 | 15 | 400 |
| CE 2-5 | 25 | 500 |
| CE 2-6 | 23 | 480 |
| CE 2-7 | 21 | 210 |

As is seen from Tables 3 to 6, the resistance to spotting is improved when the silicon and iron contents are within specific ranges and the distance Z from the interface between the anodized film and the aluminum alloy plate to the surface of the ingot following the semicontinuous casting step as represented by the formula (i) is within a specific range.

What is claimed is:

1. An aluminum alloy plate for a lithographic printing plate comprising 0.08 to 0.45 wt % of iron and 0.05 to 0.20 wt % of silicon, with the balance being inadvertent impurities and aluminum,
wherein aluminum-iron intermetallic compounds are contained in an amount of not more than 0.05 wt %.

2. The aluminum alloy plate for a lithographic printing plate according to claim 1, wherein a main component of intermetallic compounds present in the aluminum alloy plate is α-AlFeSi.

3. The aluminum alloy plate for a lithographic printing plate according to claim 1, wherein a ratio of iron content to silicon content (Fe/Si) in the aluminum alloy plate is from 0.5 to 2.2.

4. The aluminum alloy plate for a lithographic printing plate according to claim 1, wherein zinc is contained in an amount of not more than 0.01 wt %.

5. The aluminum alloy plate for a lithographic printing plate according to claim 1, wherein magnesium is contained in an amount of not more than 0.20 wt %.

6. A method of manufacturing the aluminum alloy plate for a lithographic printing plate according to claim 1, the method comprising:
a semicontinuous casting step for forming an ingot from an aluminum alloy melt;
a scalping step for scalping the ingot obtained in the semicontinuous casting step; and
a soaking step for carrying out a soaking treatment after the scalping step in a temperature range of 500 to 550° C.

7. A method of manufacturing the aluminum alloy plate for a lithographic printing plate according to claim 1, the method comprising:
a continuous casting step for rolling an aluminum alloy melt as it is solidified, to thereby form an aluminum alloy plate;
a cold rolling step for reducing a thickness of the aluminum alloy plate obtained in the continuous casting step;
an intermediate annealing step for heating at a temperature of not more than 500° C. following the cold rolling step; and
a finish cold rolling step for reducing a thickness of the aluminum alloy plate following the intermediate annealing step.

8. A lithographic printing plate support obtained by subjecting a surface of the aluminum alloy plate for a lithographic printing plate according to claim 1 to a surface roughening treatment including an electrochemical graining treatment and an anodizing treatment in this order.

9. The lithographic printing plate support according to claim 8, wherein the lithographic printing plate support is obtained by further subjecting the aluminum alloy plate following the anodizing treatment to a hydrophilizing treatment which is a treatment using an alkali metal silicate so that silicon is adsorbed in an amount of 1.0 to 30 mg/m².

10. A method of manufacturing a lithographic printing plate support, the method comprising the steps of:
a semicontinuous casting step for forming an ingot from an aluminum alloy melt containing 0.08 to 0.45 wt % of iron and 0.05 to 0.20 wt % of silicon with the balance being inadvertent impurities and aluminum;
a scalping step for scalping the ingot formed in the semicontinuous casting step;
a hot rolling step for rolling the scalped ingot to obtain a rolled plate;
a cold rolling step for reducing a thickness of the rolled plate following the hot rolling step to obtain an aluminum alloy plate; and
a surface treatment step in which a surface of the aluminum alloy plate following the cold rolling step is subjected to a surface roughening treatment including an electrochemical graining treatment and an anodizing treatment in this order to obtain the lithographic printing plate support,
wherein a thickness (X) of the ingot following the semicontinuous casting step, a plate thickness (Y) following the cold rolling step, an amount (A) of material removed by the scalping step, an amount (B) of material removed by the surface roughening treatment and a thickness (C) of an anodized film satisfy the following expression (i):
$$4 ≦ Z = \frac{X - A}{Y} \times ( B + C ) \times {10}^{- 3} + A ≦ 20. \qquad ( i )$$

11. The method according to claim 10, wherein the thickness (X) of the ingot following the semicontinuous casting step is from 300 to 800 mm, the plate thickness (Y) following the cold rolling step is from 0.1 to 0.5 mm, the amount (A) of material removed by the scalping step is from 1 to 15 mm, the amount (B) of material removed by the surface roughening treatment is from 1 to 10 am, and the thickness (C) of the anodized film is from 0.1 to 2.5 μm.

12. A lithographic printing plate support obtained by the method according to claim 10.

13. A presensitized plate having an image recording layer formed on the lithographic printing plate support according to claim 8 or 12.

14. The presensitized plate according to claim 13, wherein the image recording layer contains anions comprising halide ions and/or PF₆⁻.

15. The presensitized plate according to claim 13, wherein the image recording layer is one in which an image is formed by light exposure and unexposed portions are removable with printing ink and/or fountain solution.
